(19) United States
(12) Patent Application Publication
(10) Pub. No.: US 2026/0336841 A1
(43) Pub. Date: Oct. 29, 2026

(54) MULTIMODE AERIAL VEHICLES AND THEIR UTILIZATION

(71) Applicant: Angel Aerial Systems, Inc., Cincinnati, OH (US)

(72) Inventors: William HASTING, Cincinnati, OH (US); Shyam RAUNIYAR, Cincinnati, OH (US); Jonathan CREASY, Cincinnati, OH (US); Hugh RIES, Lewis Center, OH (US)

(21) Appl. No.: 19/541,180

(22) Filed: Feb. 16, 2026

Related U.S. Application Data
(63) Continuation of application No. PCT/US24/44447, filed on Aug. 29, 2024.
Application No. PCT/US24/44447 is a continuation-in-part of application No. 18/642,472, filed on Apr. 22, 2024, now Pat. No. 12,397,936.
Application No. 18/642,472 is a continuation-in-part of application No. PCT/US24/25715, filed on Apr. 22, 2024.
(60) Provisional application No. 63/498,586, filed on Apr. 27, 2023.
(60) Provisional application No. 63/498,586, filed on Apr. 27, 2023.
(60) Provisional application No. 63/536,252, filed on Sep. 1, 2023.
(60) Provisional application No. 63/536,252, filed on Sep. 1, 2023.
(60) Provisional application No. 63/536,252, filed on Sep. 1, 2023.

(51) Int. Cl. B64U 30/12; B64U 10/20; B64U 50/30; B64U 80/70

(52) U.S. Cl. CPC B64U 30/12; B64U 10/20; B64U 50/30; B64U 80/70

(57) ABSTRACT

Device, methods, apparatuses (e.g., controllers), program instructions, and designs associated with an (e.g., unmanned) aerial vehicle (AV), the AV configured to fly in different flight modes such as a hovering mode in which the AV may be a substantially stationary.

### PRIORITY APPLICATIONS

This application claims the priority of International Patent Application Ser. No. PCT/US24/44447 filed Aug. 29, 2024 that claims priority from U.S. Provisional Patent Application Ser. No. 63/536,252, filed Sep. 1, 2023; that claims priority from International Patent Application Ser. No. PCT/US24/25715 filed Apr. 22, 2024; and that claims priority from priority U.S. patent application Ser. No. 18/642,472 filed Apr. 22, 2024 patented as U.S. Ser. No. 12/397,936, issued Aug. 26, 2025; the International Patent Application PCT/US24/25715 filed Apr. 22, 2024, claiming priority of U.S. Provisional Patent Application Ser. No. 63/536,252, filed Sep. 1, 2023, and claiming priority of U.S. Provisional Patent Application Ser. No. 63/498,586, filed Apr. 27, 2023; the U.S. patent application Ser. No. 18/642,472 filed Apr. 22, 2024 patented as U.S. Ser. No. 12/397,936 , issued Aug. 26, 2025, claiming priority of U.S. Provisional Patent Application Ser. No. 63/536,252, filed Sep. 1, 2023, and claiming priority of U.S. Provisional Patent Application No. 63/498,586, filed Apr. 27, 2023; each of which is incorporated herein by reference in its entirety.

### TECHNICAL FIELD

Aerial Vehicles (AV), such as an unmanned aerial vehicle (UAV), that may be (e.g., easily) reconfigurable for a variety of missions and payloads.

### BACKGROUND

Various tasks may preferably be performed by an aerial vehicle (AV) that can execute stable, interchangeable, and maneuverable flight modes, including substantially stationary flight mode, which AV can controllably and reliably travel long (and short) distances, sense its environment reliably over time, and deliver data. For some tasks, unmanned AV (e.g., UAV), or a fleet (e.g., swarm) of AVs, may be applicable. Modularity and ease of assembly of the AV may be beneficial at various settings. Ease of access to various internal components may be beneficial as well, e.g., for assembly, maintenance, and/or repair purposes. Low cost and/or low energy consumption may also be beneficial, e.g., as compared to currently available respective options.

Swarm drone technology is rapidly advancing and has a wide range of potential applications, including search and rescue missions, surveillance, and delivery services. Today, swarm drones are being used for mapping and surveying, construction inspections, and agricultural monitoring. They are also being used in the entertainment industry for creating stunning aerial displays. Swarm drones can be controlled by a single operator (or by several operators), and the drones can communicate with each other in real-time, allowing for coordinated movement and collective decision-making. The current state of swarm drone technology is characterized by significant advancements in hardware, software, and communication systems.

In terms of hardware, swarm drones are becoming more lightweight, agile, and energy efficient. Newer models are equipped with multiple sensors, cameras, and global positioning systems (GPS), allowing for precise positioning and obstacle avoidance. Some of the latest swarm drone designs also incorporate 3D-printed materials and biomimetic structures, enabling them to fly in complex environments and carry out intricate maneuvers.

The software used to control swarm drones is becoming more sophisticated, allowing for more precise control and autonomous decision-making. Swarm drones can now be programmed to perform complex tasks, such as aerial mapping or search and rescue missions, without human intervention. Some of the latest software solutions also enable real-time monitoring and control of multiple drones simultaneously. Communication systems are also advancing, allowing swarm drones to communicate with each other over long distances and to coordinate their movements in real-time. Overall, the current state of swarm drone technology is promising, and we can expect to see continued innovation and advancements in the coming years.

However, there are still a myriad of issues with current swarm drone technology. Specifically, they face an airframe paradox in that rotorcraft designs are needed for maneuverability (e.g., that may require dynamic wings), but the flight times required for many of the missions are only achievable with fixed-wing aircraft. Furthermore, the majority of UAVs are designed to be reusable many times and survive harsh conditions including crashes. They typically must provide capacity and power for a number of high-performance payloads. Meeting these design objectives results in high-cost platforms that are too expensive for attributable missions and may need to be recovered. It is currently not economically feasible to employ thousands to tens of thousands of UAVs meeting the requested (e.g., desired) performance required at the price points of current drones. The cost of each platform would have to (e.g., must) be drastically reduced to employ swarming concepts. This requires a different (e.g., unique) design approach where drones are engineered for attributable missions, carry a limited number of expendable low-cost sensors or other payloads, while still being able to collaborate with each other (both in strategy and communications as well as mechanically) and provide the resources required for the mission.

Therefore (and for other reasons) there is a need in the art for an attributable AV to have a modular design, have the maneuverability required, while also being able to meet the flight time (and flight distance) requirements of various (e.g., most) missions.

### SUMMARY

In some aspects, the present disclosure resolves one or more of the aforementioned hardships.

In some aspects, the present inventions include method(s) (e.g., technique), device(s), apparatus(es), system(s), controller(s), software(s), and design(s), relating to an AV having a plurality (e.g., three) of flight modes, including a substantially stationary flight mode. The AV can be configured to switch between the flight modes interchangeably, reversibly, and/or seamlessly. The flight modes are possible at least in part due to using (A) dynamic wings that are adjustable, rotatable, and modular, with each wing comprising a distal propeller, (B) dynamic hub (a.k.a., fuselage) comprising portions that can rotate with respect to each other during flight, and (C) sensor(s) (e.g., camera) configured to consistently and reliably provide input during flight. The AV can be modular, transportable and/or readily assembled. Plurality of such AV can be assembled into a fleet such as a swarm.

In another aspect, a device for (e.g., unmanned) aerial flight, the device comprises: a hub having a central axis and a hub actuator, the hub being configured to selectively rotate about the central axis during use of an aerial vehicle (AV); a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base; and a propeller system disposed at, or adjacent to, the tip of the wing, the propeller system being configured to operatively couple to the wing, where: (A) the hub comprises a first hub portion configured to rotate relative to a second hub portion during the use of the AV, the first hub portion operatively coupled with the second hub portion during the use of the AV, (B) the device comprises an inertial measurement unit (IMU) configured to measure (e.g., accurately and reliably) a second angular velocity up to a threshold, and where the wing is configured to rotate about the central axis at a first angular velocity higher than the threshold, the IMU being disposed in the hub, (C) the device comprises a rotary encoder configured to measure (e.g., accurately and reliably) an angular velocity of the wing as it rotates about the central axis, (D) the device comprising a rotary connector configured to transmission of electrical power between its stationary portion and its rotating portion, the rotation portion of the rotary connector configured to continuously fully rotate (e.g., 360° rotation) during operation, (E) the device comprising a controller configured to control (I) relative rotation, (II) relative altered positions, or (III) relative rotation and relative altered positions, of portions of the hub during the use of the AV, (F) the wing comprises (i) a first wing portion comprising the base and a first side of a coupling system disposed on a side of the first wing portion opposing the base and (ii) a second wing portion comprising the tip and a second side of the coupling system disposed on a side of the second wing portion opposing the tip, the first side of the coupling system configured to mate (e.g., couple) with the second side of the coupling system as part of the wing, (G) the hub comprising a battery holder having a cross section in a plane perpendicular to the central axis, the cross section having a first side comprising a first arch and a second side comprising a second arch, the first arch being concentric with the second arch, the first arch being longer than the second arch, (H) the hub comprising a temperature conditioning system configured to condition a temperature within the hub during the use of the AV, (I) the hub comprising an internal support system, the internal support system comprising a first set of support and a second set of support, (i) the first set of supports extending from a first side of a first stage centered in at least one plane relative to the central axis, the central axis running through the first stage, each first support of the first set of supports having a first distal side with respect to the central axis, the first distal side forming a first acute angle with the first stage such that the distal side is slanted in a direction of the central axis, the first set of supports being coupled by a first geometric shape having a first central hole concentric with the central axis, (ii) the second set of supports extending from a second side of a second stage centered in at least one plane relative to the central axis, the central axis running through the second stage, each second support of the second set of supports having a second distal side with respect to the central axis, the second distal side forming a second acute angle with the second stage such that the second distal side is slanted in the direction of the central axis, the second set of supports being coupled by a second geometric shape having a second central hole concentric with the central axis, the second geometric shape contacting the first geometric shape, or (J) any combination of (A), (B), (C), (D), (E), (F), (G), (H), and (I). In some embodiments, the use of the AV comprises flight, testing, or maintenance. In some embodiments, the device is configured to adopt one of at least three modes during the use of the AV. In some embodiments, the three modes comprise (a) a cruise mode in which the device translates laterally having the central axis disposed in the lateral direction, (b) a vertical mode in which the device translates vertically having the central axis disposed vertically, and a (c) a hover mode in which the central axis is disposed vertically while the device is substantially stationary with respect to the vertical axis. In some embodiments, the device is configured to maintain the wing in a (e.g., substantially) stationary position while in cruise mode. In some embodiments, the device is configured to rotate the wing about the central axis while in vertical mode and/or in hover mode. In some embodiments, a chord of an airfoil of the wing forms an acute angle with a plane perpendicular to the central axis during hover mode. In some embodiments, a chord of an airfoil of the wing is (e.g., substantially) parallel to the central axis during vertical mode. In some embodiments, the device comprises wings comprising the wing. In some embodiments, the device comprises at least three wings comprising the wing. In some embodiments, the hub comprises a skin, and wherein a spherical shape comprises the skin; and optionally wherein the spherical shape is a ball. In some embodiments, the device comprises a circuit board, each of the circuit boards having a unique identity identified by a control system of the device. In some embodiments, the wing comprises lighting that are controllable. In some embodiments, the lighting comprises at least two colors, each of the two colors being of a different visible wavelength to an average human. In some embodiments, the device being configured for visibility discerning the direction of the flight at least in part by observing an intersection of the two colors aligned with the direction of the flight. In some embodiments, a communication protocol is utilized by a control system to change the color of the lighting depending at least in part on rotation of the wings about the central axis. In some embodiments, the hub comprises a first hub portion and a second hub portion. In some embodiments, the hub comprises the first hub portion configured to rotate relative to the second hub portion during the use of the AV, the first hub portion operatively coupled with the second hub portion during the use of the AV. In some embodiments, the rotation is about the central axis of the hub. In some embodiments, the device further comprises a camera directed to an external environment external to the hub, the camera being of the second hub portion. In some embodiments, the hub comprises a casing having an aperture, and where the camera is disposed externally to the casing, the camera being held through an aperture of the casing by a holder, the holder being of the second hub portion. In some embodiments, the hub comprises an encoder and an inertial measuring unit (IMU). In some embodiments, the encoder is a rotary encoder. In some embodiments, the IMU comprises nine degrees of freedom input. In some embodiments, the IMU comprises at least two types of sensors comprising (i) an accelerometer, (ii) a gyroscope, or (iii) a magnetometer. In some embodiments, (i) the accelerometer is a three-axis accelerometer, (ii) the gyroscope is a three-axis gyroscope, and (iii) the magnetometer is a three-axis magnetometer. In some embodiments, the IMU provides motion data comprising linear acceleration, angular velocity, or magnetic field orientation. In some embodiments, the IMU is configured to facilitate three-dimensional orientation tracing of the device during the use of the AV. In some embodiments, the IMU comprises three types of sensors comprising an accelerometer, a gyroscope and a magnetometer. In some embodiments, a control system is operatively coupled with the hub comprising a first hub portion and a second hub portion, the first hub portion being configured to rotate relative to the second hub portion during the use of the AV, the control system being configured to utilize inputs from the encoder and from the IMU to estimate an angular position and an angular velocity of a first hub portion relative to a second hub portion. In some embodiments, the device comprises an inertial measurement unit (IMU) configured to measure the second angular velocity up to the threshold, and where the wing is configured to rotate about the central axis at the first angular velocity higher than the threshold, the IMU being disposed in the hub. In some embodiments, the IMU is operatively coupled with a control system of the device. In some embodiments, the IMU measures the second angular velocity with at least an accuracy of a respective IMU of a cellular phone or of a guided missile. In some embodiments, the wing is coupled with a first hub portion that rotates at the first angular velocity higher than the threshold, and where the IMU is disposed in a second hub portion, the first hub portion rotating with respect to the second hub portion. In some embodiments, the IMU is configured to provide inputs utilized to estimate (e.g., by calculating) an angular position and an angular velocity of a first hub portion relative to a second hub portion. In some embodiments, during the use of the AV, the second hub portion comprises a camera having a field of view aligned with a target external to the device. In some embodiments, the second angular velocity being with respect to the second hub portion. In some embodiments, the second angular velocity being with absolute. In some embodiments, the first hub portion rotates at a rate of at least about 250, or 300 revolutions per minute (RPM) about the central axis. In some embodiments, the rate of rotation of the first hub portion is relative to that of the second hub portion. In some embodiments, the second hub portion rotates (a) at an opposite rotational direction of the first hub portion, (b) at a rate of at most about 350 RPM about the central axis, (c) substantially does not rotate, (d) does not rotate, or (e) any combination of (a) (b) and (c). In some embodiments, the second hub portion rotates (a) in an opposite direction to the first hub portion, and (b) at a rate (e.g., substantially) equal to that of the first hub portion. In some embodiments, the rate of rotation of the first hub portion is relative to a rate of rotation of the second hub portion. In some embodiments, the device comprises the rotary encoder configured to measure an angular velocity of the wing as it rotates about the central axis. In some embodiments, the wing is coupled with a first hub portion that rotates with respect to the second hub portion, and where the rotary encoder is disposed in the first hub portion. In some embodiments, during the use of the AV, the second hub portion comprises a camera having a field of view aligned with a target external to the device. In some embodiments, the rotary encoder is coupled with a portion of a rotary connector having a first coupling member coupled with first hub portion and a second coupling member coupled with the second hub portion, the first coupling member rotating with respect to the second coupling member, an angular rotation of rotation is measured by the rotary encoder. In some embodiments, the rotary connector is a slipring. In some embodiments, the rotary encoder is configured to transmit electricity and/or data during rotation of its first coupling member with respect to its second coupling member. In some embodiments, portions of the rotary connector are configured to rotate one with respect to another using an actuator disposed in the first hub portion. In some embodiments, the actuator is coupled with a portion of the rotary connector using a torque coupler comprising an axial float. In some embodiments, the device comprises the rotary connector configured to transmission of electrical power between its stationary portion and its rotating portion, the rotation portion of the rotary connector configured to continuously fully-rotate during operation. In some embodiments, the rotary connector is configured to transmit data between its stationary portion and its rotary portion during its operation. In some embodiments, the data includes sensor data, control data and/or navigational data. In some embodiments, the rotary connector comprises a slipring mechanism. In some embodiments, the rotary connector is configured to, during the use of the AV, transmit the electrical power between a first hub portion that rotates with respect to a second hub portion. In some embodiments, the rotary connector is configured to, during the use of the AV, electrically connect a camera of the second hub portion with a power source disposed in the first hub portion. In some embodiments, the rotary connector is configured to, during the use of the AV, communicate data between the first hub portion and the second hub portion during the use of the AV. In some embodiments, the device comprises a hub actuator disposed in the hub, the hub actuator being configured to rotate the wing about the central axis during the use of the AV. In some embodiments, the wing is configured to alter an angle of attack of the wing during rotation of the wing about the central axis during the use of the AV, when a velocity of a hub actuator is configured to remain (e.g., substantially) constant. In some embodiments, the device is configured to adopt different flight modes, and where the configuration is during a hover flight mode of the different flight modes. In some embodiments, the wing is configured to maintain an angle of attack of the wing at a (e.g., substantially) constant value during rotation of the wing about the central axis during the use of the AV, when a velocity of a hub actuator is configured to vary. In some embodiments, the device is configured to adopt different flight modes, and where the configuration is during a hover flight mode of the different flight modes. In some embodiments, the wing is configured to alter an angle of attack of the wing during rotation of the wing about the central axis during the use of the AV, when a velocity of a hub actuator is configured to vary. In some embodiments, the device is configured to adopt different flight modes, and where the configuration is during a hover flight mode of the different flight modes. In some embodiments, the device comprises the controller configured to control (I) relative rotation, (II) relative altered positions, or (III) relative rotation and relative altered positions, of portions of the hub during the use of the AV. In some embodiments, the controller is operatively coupled with an encoder and to an IMU to receive inputs utilized for the control, the encoder and the IMU being disposed in the hub. In some embodiments, the device comprises a hub actuator disposed in the hub, the hub actuator being configured to rotate the wing about the central axis during the use of the AV. In some embodiments, the wing is configured to alter an angle of attack of the wing during rotation of the wing about the central axis during the use of the AV, when a velocity of a hub actuator is configured to remain (e.g., substantially) constant. In some embodiments, the device is configured to adopt different flight modes, and where the configuration is during a hover flight mode of the different flight modes. In some embodiments, the wing is configured to maintain an angle of attack of the wing at a (e.g., substantially) constant value during rotation of the wing about the central axis during the use of the AV, when a velocity of a hub actuator is configured to vary. In some embodiments, the device is configured to adopt different flight modes, and where the configuration is during a hover flight mode of the different flight modes. In some embodiments, the wing is configured to alter an angle of attack of the wing during rotation of the wing about the central axis during the use of the AV, when a velocity of a hub actuator is configured to vary. In some embodiments, the device is configured to adopt different flight modes, and where the configuration is during a hover flight mode of the different flight modes. In some embodiments, the wing comprises (i) the first wing portion comprising the base and the first side of the coupling system disposed on the side of the first wing portion opposing the base and (ii) the second wing portion comprising the tip and the second side of the coupling system disposed on the side of the second wing portion opposing the tip the second mating side, the first side of the coupling system configured to mate with the second side of the coupling system as part of assembling the wing. In some embodiments, the coupling system is distributed along a mating border. In some embodiments, the mating border comprises at least two contacting lines that form an angle that facilitates discerning each of the two contacting lines. In some embodiments, the mating border comprises at least three contacting lines with two connecting points, with every two of the contacting lines connecting at a point of the points to form an angle that facilitates discerning each of the two contacting lines. In some embodiments, the coupling system comprises different types of coupling mechanisms. In some embodiments, the different types of the coupling mechanisms comprise electrical connection or mechanical connection. In some embodiments, the different types of the coupling mechanisms comprise a dovetail connector and a fastener. In some embodiments, the fastener comprises a latch. In some embodiments, the coupling system comprises two coupling mechanisms of the same type. In some embodiments, the two same type of coupling mechanisms are disposed in (e.g., substantially) same direction. In some embodiments, the same type of the coupling mechanisms comprises dovetail type coupling mechanism. In some embodiments, the same type of coupling mechanism comprises a female member and a male member configured to mate upon coupling, and where the coupling system comprising (a) a first coupling mechanism comprising a first female member and a first male member, and (b) a second coupling mechanism comprising a second female member and a second male member, where the first side comprises one sex type of the first coupling mechanism and the other sex type of the second coupling mechanism, when the second side comprises other sex type of the first coupling mechanism and the one sex type of the second coupling mechanism, and when the one sex type is male the other sex type is female, and when the one sex type is female the other sex type is male. In some embodiments, the first coupling mechanism and the second coupling mechanism are of the same type. In some embodiments, at least one different type of coupling mechanism disposed between the first coupling mechanism and the second coupling mechanism, the at least one different type of coupling mechanism disposed along a mating border. In some embodiments, the two same type of coupling mechanisms are disposed in (e.g., substantially) same direction different from the direction in which the at least one different type of coupling mechanism is disposed. In some embodiments, the coupling system comprises at least two coupling mechanism of different types. In some embodiments, the at least two coupling mechanism of different types are disposed in (e.g., substantially) same direction. In some embodiments, the different types of the coupling mechanisms comprise electrical connection or mechanical connection. In some embodiments, the hub comprising the battery holder having the cross section in a plane perpendicular to the central axis, the cross section having the first side comprising the first arch and a second side comprising the second arch, the first arch being concentric with the second arch, the first arch being longer than the second arch. In some embodiments, a side of the battery holder is flush with the skin of the hub to form a shape comprised in a sphere, wherein the side forming an angle with the cross section perpendicular to the plane of the central axis, and optionally wherein the sphere is a ball. In some embodiments, the battery holder is generated by a body of a hub, a vertical internal wall disposed in the hub, and a second stage disposed in the hub. In some embodiments, the second stage comprises at least one aeration hole that is part of the battery holder, the aeration hole configured to adjust pressure of gas in the battery holder during insertion, retraction, and placement of the battery pack in the battery holder. In some embodiments, an electrical connector member is disposed at the second stage as part of the battery holder. In some embodiments, the battery holder comprises a depression configured to engage a tab of a battery pack to secure the battery pack to the battery holder during the use of the AV, the battery pack configured to enclose one or more batteries. In some embodiments, the battery holder is configured for reversible, repetitive, and accurate insertion and retraction of the battery pack when the device is not in the use of the AV. In some embodiments, the battery pack comprises the tab, an electrical connector member configured to mate with the electrical connector member of the battery holder, and a respective shape to the battery holder to snugly fit the battery pack in the battery holder during the use of the AV. In some embodiments, the device further comprises a camera configured to sense an external environment to the hub during the use of the AV. In some embodiments, the camera is configured to capture images comprising stills and video. In some embodiments, the camera is configured to capture electromagnetic wavelengths comprising in a visible range or in an infrared range. In some embodiments, the camera is configured to remain fixed in a direction and/or target during rotation of the wing about the central axis during the use of the AV. In some embodiments, the hub comprises a first hub portion configured to rotate about the central axis relative to a second hub portion during the use of the AV, the camera being operatively coupled with the second hub portion and the wing being coupled with the first hub portion. In some embodiments, the hub comprising a structural balancing aid operatively coupled with the hub, the structural balancing aid configured to balance the device on a resting area. In some embodiments, the structural balancing aid comprises elements symmetrically disposed with respect to the central axis, the elements providing the balancing aid, the camera being disposed within the elements. In some embodiments, the camera is disposed within the elements vertically. In some embodiments, the camera is disposed within the elements horizontally. In some embodiments, the structural balancing aid comprises legs being the elements. In some embodiments, the structural balancing aid comprises three elements. In some embodiments, the elements are configured to alter their spatial occupancy. In some embodiments, the elements are configured to alter their spatial occupancy by retracting into the hub. In some embodiments, the elements are configured to alter their spatial occupancy externally to the hub. In some embodiments, the hub comprises a casing, where the elements are configured to alter their spatial occupancy with respect to the casing. In some embodiments, the hub comprises a casing, where the elements are operatively coupled with the casing and are disposed outside of the casing with respect to an interior of the hub. In some embodiments, the elements are configured to alter their spatial occupancy at least in part by folding, telescoping, and/or retracting. In some embodiments, the elements are foldable or retractable during the use of the AV. In some embodiments, the device is configured for modes of flight, where the elements are foldable or retractable during at least one of the modes. In some embodiments, the hub comprises the temperature conditioning system configured to condition the temperature within the hub during the use of the AV at least in part by allowing gas to flow from one side of the hub to its opposing side. In some embodiments, the one side and the opposing side being in the direction of the central axis. In some embodiments, the hub comprises at least two hub casings, where the one side is of a one casing different, and where the opposing side is of an opposing casing. In some embodiments, an intermediate casing is disposed between the one casing and the opposing casing, and where the wing being coupled with the intermediate casing. In some embodiments, during the use of the AV, the intermediate casing rotates relative to the one casing. In some embodiments, at least one component is operatively coupled with a hub portion enclosed by the one casing, the at least one component comprising a camera, an IMU, or a flight management unit (FMU). In some embodiments, during the use of the AV, the opposing casing rotates with the intermediate casing. In some embodiments, a navigation system component (e.g., GPS) is operatively coupled with a hub portion enclosed by the other casing. In some embodiments, the device comprises a camera operatively coupled with the hub, and where the one side is the side at which the camera is disposed. In some embodiments, the hub is enclosed by a casing having an aperture through which the camera protrudes, and where the one side comprises the aperture. In some embodiments, the hub is enclosed by a casing having at least one aeration hole, and where the opposing side comprises the at least one aeration hole. In some embodiments, the hub comprises one or more internal walls disposed about the central axis, and therein the gas is configured to flow within a space encircled by the one or more internal walls. In some embodiments, the one or more internal walls form an open cylinder (e.g., a closed channel such as a tube), and where the gas is configured to flow within an interior space of the open cylinder. In some embodiments, the one or more internal walls form an open cylinder, and where the gas is configured to flow within an interior space of the hub and outside of the one or more internal walls that are of the open cylinder. In some embodiments, the hub comprises one or more battery holders disposed about the central axis, and therein the gas is configured to flow within a space encircled by the one or more battery holders. In some embodiments, the hub comprises one or more battery holders disposed about the central axis, and therein the gas is configured to flow within the one or more battery holders. In some embodiments, the hub comprises the internal support system comprising the first set of support and the second set of support, (i) the first set of supports extending from the first side of the first stage centered in at least one plane relative to the central axis, the central axis running through the first stage, each first support of the first set of supports having the first distal side with respect to the central axis, the first distal side forming the first acute angle with the first stage such that the distal side is slanted in the direction of the central axis, the first set of supports being coupled by the first geometric shape having the first central hole concentric with the central axis, (ii) the second set of supports extending from the second side of the second stage centered in at least one plane relative to the central axis, the central axis running through the second stage, each second support of the second set of supports having the second distal side with respect to the central axis, the second distal side forming the second acute angle with the second stage such that the second distal side is slanted in the direction of the central axis, the second set of supports being coupled by the second geometric shape having the second central hole concentric with the central axis, the second geometric shape contacting the first geometric shape. In some embodiments, the first stage is operatively coupled with electrical devices from both its opposing sides. In some embodiments, the first stage is planar. In some embodiments, the first stage is coupled with a body of the hub by fasteners. In some embodiments, the second stage is planar. In some embodiments, the second stage is coupled with a body of the hub by fasteners. In some embodiments, the first stage is operatively coupled with first devices comprising a navigation system, an actuator of the hub, an encoder, or a rotary connector; and where the second stage is operatively coupled with second device comprising the rotary connector, or a connector configured to transmit electricity and optionally data. In some embodiments, the second stage comprises a central hole concentric with the central axis. In some embodiments, at least one first fundamental length scale (FLS) of the first stage is smaller than at least one second FLS of the second stage. In some embodiments, the first circumference of the first stage is smaller than the second circumference of the second stage. In some embodiments, one stage comprises connector member, while the other stage is devoid of the connector member; where when the one stage is the first stage, the other stage is the second stage; and where when the one stage is the second stage, the other stage is the first stage. In some embodiments, the hub comprises a second hub portion and a first hub portion configured to rotate with respect to the second hub portion, and where the second stage is closer to the second hub portion than the first stage. In some embodiments, the central axis is concentric with the first hub portion and with the second hub portion. In some embodiments, a rotary connector at least in part couples the first hub portion with the second hub portion. In some embodiments, a rotating shaft of the rotary connector is disposed within the central hole of the second stage. In some embodiments, rotating shaft penetrates from the second hub portion into the first hub portion through the central hole of the second stage. In some embodiments, the second hub portion comprises an IMU or a communication interface. In some embodiments, the hub comprises a flight controller as part of a control system, e., comprising one or more controllers such as the controller. In some embodiments, the control system comprises at least three hierarchical control levels. In some embodiments, the second hub portion comprises a camera. In some embodiments, the first hub portion is devoid of a camera. In some embodiments, the device is configured for assembly and disassembly by an average user in a manner comprising repeatedly, securely, or reliably. In some embodiments, the disassembly comprises disassembling the wing into at least two portions. In some embodiments, the disassembly comprises keeping the hub assembled. In some embodiments, the disassembly comprises keeping the hub coupled with at least one portion of the wing. In some embodiments, the disassembly comprises keeping the propeller system coupled with at least one portion of the wing. In some embodiments, the device is configured to be stored in container such as a standard container, e.g., a suitcase. In some embodiments, the standard suitcase is a standard carryon luggage size. In some embodiments, the device comprises a transparent material. In some embodiments, the device comprises an opaque material. In some embodiments, the device material comprises a composite material.

In another aspect, a method of using the device, the method comprises: providing any of the above devices and using the device for flying, testing, and/or for maintenance. For example, a method of using an (e.g., unmanned) aerial vehicle, the method comprising providing the (e.g., unmanned) aerial vehicle (AV) comprising (i) a hub having a central axis and a hub actuator, the hub being configured to selectively rotate about the central axis during use of the AV; (ii) a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base; and (iii) a propeller system disposed at, or adjacent to, the tip of the wing, the propeller system coupled with the wing, the one or more operations comprise: (A) directing relative rotation of a first hub portion relative to a second hub portion during the use of the AV, the first hub portion being operatively coupled during the use of the AV with the second hub portion as part of the hub, (B) receiving measurements from an inertial measurement unit (IMU) of the AV, the IMU configured to measure (e.g., accurately and reliably) a second angular velocity up to a threshold, and where the at least one controller is configured to direct rotation of the wing about the central axis at a first angular velocity higher than the threshold, (C) receiving measurements from a rotary encoder configured, the measurements comprising an angular velocity of the wing as it rotates about the central axis, the rotary encoder being of the AV, the at least one controller utilizing the measurements to control the AV, (D) directing a rotary connector configured to transmit electrical power between its stationary portion and its rotating portion, the rotation portion of the rotary connector configured to continuously fully rotate during operation, the rotary connector disposed in the AV, (E) controlling (I) relative rotation, (II) relative altered positions, or (III) relative rotation and relative altered positions, of portions of the hub during the use of the AV, (F) directing use of electrical power provided through a battery holder having a cross section in a plane perpendicular to the central axis, the cross section having a first side comprising a first arch and a second side comprising a second arch, the first arch being concentric with the second arch, the first arch being longer than the second arch, or (G) optionally measuring a temperature during use of the AV and alters conditioning of the temperature during the use, the hub comprising a temperature conditioning system configured to condition the temperature within the hub during the use of the AV comprising flying or maintaining.

In another aspect, an apparatus for control, the apparatus comprises: at least one controller configured to direct execution of one or more operations associated with any of the above devices. For example, an apparatus for use of an (e.g., unmanned) aerial vehicle (AV), the apparatus comprises: at least one controller configured to operatively couple with a power source and/or to a communication system, the at least one controller configured to operatively couple with the AV comprising (i) a hub having a central axis and a hub actuator, the hub being configured to selectively rotate about the central axis during the use; (ii) a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base; and (iii) a propeller system disposed at, or adjacent to, the tip of the wing, the propeller system coupled with the wing, where the at least one controller configured to: (A) direct relative rotation of a first hub portion relative to a second hub portion during the use, the first hub portion being operatively coupled during the use with the second hub portion as part of the hub, (B) receive measurements from an inertial measurement unit (IMU) of the AV, the IMU configured to measure (e.g., accurately and reliably) a second angular velocity up to a threshold, and where the at least one controller is configured to direct rotation of the wing about the central axis at a first angular velocity higher than the threshold, (C) receive measurements from a rotary encoder configured, the measurements comprising an angular velocity of the wing as it rotates about the central axis, the rotary encoder being of the AV, the at least one controller utilizing the measurements to control the AV, (D) direct a rotary connector configured to transmit electrical power between its stationary portion and its rotating portion, the rotation portion of the rotary connector configured to continuously fully rotate during operation, the rotary connector disposed in the AV, (E) control (I) relative rotation, (II) relative altered positions, or (III) relative rotation and relative altered positions, of portions of the hub during the user, (F) direct use of electrical power provided through a battery holder having a cross section in a plane perpendicular to the central axis, the cross section having a first side comprising a first arch and a second side comprising a second arch, the first arch being concentric with the second arch, the first arch being longer than the second arch, (G) optionally measure the temperature during use of the AV and alters conditioning of the temperature during the use, where the hub comprises a temperature conditioning system configured to condition a temperature within the hub during the use, (H) any combination of (A), (B), (C), (D), (E), (F), and (G), wherein the use comprises flight, testing, or maintenance. In some embodiments, (a) the at least one controller is configured to connect with a power supply, (b) the at least one controller is configured to connect with a communication system, (c) where the at least one controller comprises the controller, (d) where the at least one controller comprises the control system, or (e) any combination of (a), (b), (c), and (d). In some embodiments, the communication system comprises cloud communication.

In another aspect, non-transitory computer readable program instructions, the program instructions, when read by one or more processors coupled with the device, the one or more processors being configured to direct execution of one or more operations associated with the device; where the device comprises any of the above devices. For example, In another aspect, non-transitory computer readable program instructions, the program instructions, when read by one or more processors coupled with an a (e.g., unmanned) aerial vehicle (AV), direct execution of one or more operations, the AV comprising (i) a hub having a central axis and a hub actuator, the hub being configured to selectively rotate about the central axis during the use of the AV; (ii) a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base; and (iii) a propeller system disposed at, or adjacent to, the tip of the wing, the propeller system coupled with the wing, the one or more operations comprise: (A) directing relative rotation of a first hub portion relative to a second hub portion during the use of the AV, the first hub portion being operatively coupled during the use of the AV, with the second hub portion as part of the hub, (B) receiving measurements from an inertial measurement unit (IMU) of the AV, the IMU configured to measure (e.g., accurately and reliably) a second angular velocity up to a threshold, and where the at least one controller is configured to direct rotation of the wing about the central axis at a first angular velocity higher than the threshold, (C) receiving measurements from a rotary encoder configured, the measurements comprising an angular velocity of the wing as it rotates about the central axis, the rotary encoder being of the AV, the at least one controller utilizing the measurements to control the AV, (D) directing a rotary connector configured to transmit electrical power between its stationary portion and its rotating portion, the rotation portion of the rotary connector configured to continuously fully rotate during operation, the rotary connector disposed in the AV, (E) controlling (I) relative rotation, (II) relative altered positions, or (III) relative rotation and relative altered positions, of portions of the hub during the use of the AV, (F) directing use of electrical power provided through a battery holder having a cross section in a plane perpendicular to the central axis, the cross section having a first side comprising a first arch and a second side comprising a second arch, the first arch being concentric with the second arch, the first arch being longer than the second arch, or (G) optionally measuring a temperature during use of the AV and alters conditioning of the temperature during the use, the hub comprising a temperature conditioning system configured to condition the temperature within the hub during the use of the AV; wherein the use of the AV comprises during flight, testing, or during maintenance. In some embodiments, the program instructions are inscribed on one or more media.

In another aspect, a device used in (e.g., unmanned) aerial flight, the device comprises: a wing having a long axis connecting (a) a base of the wing disposed at a first end of the wing, with (b) a tip of the wing disposed at a second end of the wing opposing the first end of the wing, the base and the tip being disposed along the long axis, the base configured to couple with a hub of an aerial vehicle (AV), and the tip is disposed further away from the hub relative to the base, the wing being configured to couple with a propeller system disposed at, or adjacent to, the tip of the wing, the propeller system coupled with the wing comprising (i) a first wing portion comprising the base and a first side of a coupling system disposed on a side of the first wing portion opposing the base and (ii) a second wing portion comprising the tip and a second side of the coupling system disposed on a side of the second wing portion opposing the tip, the first side of the coupling system configured to mate (e.g., couple) with the second side of the coupling system as part of the wing.

In another aspect, a device for use in (e.g., unmanned) aerial flight, the device comprises: a hub having a central axis and a hub actuator, the hub being configured to selectively rotate about the central axis during the use of the AV, the hub being configured to operatively couple to a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base, the hub comprising a first hub portion configured to rotate relative to a second hub portion during the use of the AV, the first hub portion operatively coupled with the second hub portion during the use of the AV. In some embodiments, the use of the AV comprises flight, testing, or maintenance.

In another aspect, a device for use in (e.g., unmanned) aerial flight, the apparatus comprises: an inertial measurement unit (IMU) configured to measure a second angular velocity up to a threshold, and where a wing of an aerial vehicle (AV) is configured to rotate about the central axis of the AV at a first angular velocity higher than the threshold, the IMU being configured for disposition in the AV. In some embodiments, measurements of the IMU are during use of the AV comprising flight, testing, or maintenance.

In another aspect, an apparatus for use in (e.g., unmanned) aerial flight, the apparatus comprises: at least one controller configured to operatively couple with a power source and/or to a communication system, the at least one controller configured to operatively couple with an inertial measurement unit (IMU) configured to measure a second angular velocity up to a threshold, and where a wing of an aerial vehicle is configured to rotate about the central axis of the AV at a first angular velocity higher than the threshold, the IMU being disposed in the aerial vehicle. In some embodiments, measurements of the IMU are during use of the AV comprising flight, testing, or maintenance.

In another aspect, a device for use in (e.g., unmanned) aerial flight, the apparatus comprises: a rotary encoder configured to measure an angular velocity of a wing of an aerial vehicle (AV) as the wing rotates about a central axis of the aerial vehicle different from a long axis of the wing during the use of the AV of the AV, the rotary encoder being disposed in a hub of the AV, the hub having a central axis and a hub actuator, the hub being configured to selectively rotate about the central axis during the use of the AV, the hub being configured to operatively couple to a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base, the AV being configured for various modes of flight, the device optionally comprising a propeller system disposed at, or adjacent to, the tip of the wing, the propeller system coupled with the wing. In some embodiments, measurements of the IMU are during use of the AV comprising flight, testing, or maintenance.

In another aspect, an apparatus for (e.g., unmanned) aerial flight, the apparatus comprises: at least one controller configured to operatively couple with a power source and/or to a communication system, the at least one controller configured to operatively couple with a rotary encoder configured to measure an angular velocity of a wing of an aerial vehicle (AV) as the wing rotates about a central axis of the aerial vehicle different from a long axis of the wing during the use of the AV of the AV. In some embodiments, during the use of the AV comprises flight, testing, or maintenance.

In another aspect, a device for use during (e.g., unmanned) aerial flight, the apparatus comprises: a rotary connector configured to, during the use of the AV, transmit electrical power between its stationary portion and its rotating portion, the rotation portion of the rotary connector configured to continuously fully rotate during use of the AV, the rotary connector disposed in the AV. In some embodiments, during the use of the AV comprises flight, testing, or maintenance.

In another aspect, an apparatus for (e.g., unmanned) aerial flight, the apparatus comprises: at least one controller configured to operatively couple with a power source and/or to a communication system, the at least one controller configured to operatively couple with a rotary connector configured to transmit electrical power between its stationary portion and its rotating portion, the rotation portion of the rotary connector configured to continuously fully rotate during operation, the rotary connector disposed in the AV.

In another aspect, a device for use in (e.g., unmanned) aerial flight, the device comprises: a battery casing (e.g., of the battery pack) having a cross section in a plane perpendicular to a height of the battery holder, the cross section having a first side comprising a first arch and a second side comprising a second arch, the first arch being concentric with the second arch, the first arch being longer than the second arch, the device being configured for use during use of the AV. In some embodiments, during the use of the AV comprises flight, testing, or maintenance.

In another aspect, a device for (e.g., unmanned) aerial flight, the device comprises: an internal support system of an aerial vehicle (AV), the internal support system comprising a first set of support and a second set of support, (i) the first set of supports extending from a first side of a first stage centered in at least one plane relative to a central axis of an aerial vehicle (AV), the central axis running through the first stage, each first support of the first set of supports having a first distal side with respect to the central axis, the first distal side forming a first acute angle with the first stage such that the distal side is slanted in a direction of the central axis, the first set of supports being coupled by a first geometric shape having a first central hole concentric with the central axis, (ii) the second set of supports extending from a second side of a second stage centered in at least one plane relative to the central axis, the central axis running through the second stage, each second support of the second set of supports having a second distal side with respect to the central axis, the second distal side forming a second acute angle with the second stage such that the second distal side is slanted in the direction of the central axis, the second set of supports being coupled by a second geometric shape having a second central hole concentric with the central axis, the second geometric shape contacting the first geometric shape, the device configured for disposition (e.g., arrangement) in the AV during the use of the AV. In some embodiments, during the use of the AV comprises flight, testing, or maintenance.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions are inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions are inscribed on at least one medium (e.g., on a medium or on media).

In another aspect, an apparatus comprises at least one controller that is configured (e.g., programmed) to direct a mechanism used a methodology disclosed herein to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or is operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions, when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a mechanism, outside of the mechanism, or in a location remote from the mechanism disclosed herein (e.g., in the cloud).

In another aspect, a system comprises an apparatus and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations (e.g., instructions) of the apparatus are directed by the same controller. In some embodiments, at least two of the operations (e.g., instructions) of the apparatus are directed by different controllers. In some embodiments, at least two of the operations (e.g., instructions) are carried out by the same processor and/or by the same sub-computer software product. In some embodiments, at least two of the operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method comprises executing one or more operations associated with at least one configuration of the mechanism(s) (e.g., device(s)) disclosed herein.

In another aspect, an apparatus comprises at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprises at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller comprises a non-volatile memory, e.g., a solid-state device (SSD) such as a FLASH memory. In some embodiments, the at least one controller is included in, or comprises, a hierarchical control system. In some embodiments, the hierarchical control system comprises at least three hierarchical control levels. In some embodiments, the at least one controller is included in a control system disclosed herein. In some embodiments, the at least one controller is configured to control at least one other component of a mechanism (e.g., system, device, or apparatus) disclosed herein. In some embodiments, the device disclosed herein is a component of a system, and wherein the at least one controller is configured to (i) operatively couple to another component of the system and (ii) direct operation of the other component. In some embodiments, the at least one controller is configured to direct operation of the other component at least in part for participation of the other component in a method disclosed herein.

In another aspect, non-transitory computer readable program instructions for a method disclosed herein, the non-transitory computer readable program instructions, when read by one or more processors operatively coupled with the device, cause the one or more processors to direct executing one or more operations associated with at least one configuration of the device(s) disclosed herein.

In some embodiments, the program instructions are of a computer product.

The various embodiments in any of the above aspects are combinable (e.g., within an aspect), as appropriate. Individual features (e.g., embodiments) disclosed herein are combinable in any manner requested (e.g., desired), as applicable.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

It should be appreciated that any patent, publication, or other disclosure material, in whole or in part, which is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

### BRIEF DESCRIPTION OF THE DRAWINGS

The novel features of the present disclosure are set forth with particularity in the appended claims. Various embodiments will become better understood with regard to the following description, appended claims, and accompanying drawings. A better understanding of the features and advantages of the present disclosure will be obtained by reference to the following detailed description that sets forth illustrative embodiments, in which the principles of the present disclosure are utilized, and the accompanying drawings or figures (also “FIG.” and “FIGS.” herein), of which:

FIG. 1A shows a perspective view of an embodiment of an AV (e.g., vortex drone of the present disclosure) operating in vortex mode, and an airfoil;

FIG. 1B shows a perspective view of an embodiment of an AV operating in a fixed-wing mode, and an airfoil;

FIG. 1C shows a perspective view of an embodiment of an AV operating in a V-MOD (e.g., tri-copter mode);

FIG. 1D shows an embodiment of an AV changing from V-MOD (tri-copter mode) to C-MOD (fixed-wing mode), to S-MOD (vortex mode), back to C-MOD (fixed-wing mode), and back again to V-MOD (tri-copter mode);

FIG. 2 shows a perspective mode of two AVs stacked on top of one another while operating in a counter-rotating manner;

FIG. 3 shows an example embodiment of how AVs of the present disclosure can be utilized to deliver a variety of different sized packages from a distribution center by attaching together in a counter rotating fashion;

FIG. 4A shows an example embodiment of how AVs of the present disclosure can be sent out and controlled as a swarm of AVs in a grid in the sky to monitor an area;

FIG. 4B shows an example embodiment of how AVs of the present disclosure can be utilized to detect, and subsequently isolate a small fire prevent the spread of a fire emergency;

FIG. 5 shows an example embodiment of how AVs of the present disclosure can be utilized to engage a target in a military setting;

FIG. 6 is a perspective view of AVs having various external components;

FIG. 7A is a partial cutaway perspective view of various internal components of a central hub of an embodiment of the AV of FIG. 6;

FIG. 7B is a partial cutaway perspective view of various internal components of a wing of an embodiment of the AV of FIG. 6;

FIG. 8 is a partial cutaway perspective view of a camera and gimbal assembly of an embodiment of the AV of FIG. 6;

FIG. 9 is a partial cutaway perspective view of a wing of an embodiment of the AV of FIG. 6 secured to the center hub with a quick exchange joint, and a portion of a drone depicted in perspective view;

FIG. 10 is a partial cutaway perspective view of an embodiment of the AV of FIG. 6 showing proximity sensors;

FIG. 11 is a perspective view of a plurality of AVs of the present disclosure being stacked together in a storage box/rapid deployment system;

FIG. 12 is a perspective view of various external components of AVs of the present disclosure;

FIG. 13 is a perspective view of a (center) hub of the AV, e.g., of FIG. 12;

FIG. 14 is a partial cutaway perspective view of various internal components of the center hub and a wing of the AV of FIG. 12;

FIG. 15 is a partially exploded view of a partial cutaway perspective view of various internal components of the center hub and the wing of an AV, e.g., of FIG. 12;

FIG. 16 is top perspective view of an AV without batteries installed and a cross section of an AV wing;

FIG. 17 is a cross section of a wing; and a partial cutaway perspective view of various internal components of a center hub and a wing, e.g., of the AV of FIG. 16;

FIG. 18 are perspective views of an AV wing; and a bottom perspective view of a main hub body of an AV, e.g., of the AV of FIG. 16;

FIG. 19 are perspective views of a platform portion of a center hub of the AV of FIG. 16;

FIG. 20 is a perspective view of an AV, and a perspective view of a proximal portion of a wing of an AV coupled with a cutoff of a hub, e.g., of FIG. 16;

FIG. 21 is a perspective view of cutoff (e.g., section) of an AV, and a portion of a wing of the AV, e.g., of FIG. 16;

FIG. 22 is a partially exploded view of a wing mount, e.g., depicting how a wing is secured to the center hub of the AV of FIG. 16;

FIG. 23 show portions of an AV;

FIG. 24 shows wings of an AV;

FIG. 25 shows portions of an AV in a partially exploded view;

FIG. 26 shows portions of an AV;

FIG. 27 shows portions of an AV;

FIG. 28 shows portions of an AV;

FIG. 29 shows portions of an AV hub;

FIG. 30 shows the second stage coupled with components;

FIG. 31 show portions of an AV and battery packs;

FIG. 32 show portions of an AV;

FIG. 33 show portions of an AV and battery packs;

FIG. 34 show portions of an AV disassembled and stored in a suitcase;

FIG. 35 show a plot depicting power draw as Watts as a function of time;

FIG. 36 schematically shows portion of a control system of an AV;

FIG. 37 schematically shows portion of a control system of an AV; and

FIG. 38 schematically shows a computer system.

### DETAILED DESCRIPTION

While various embodiments of the inventions have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings, wherein like numbers indicate the same or corresponding elements throughout the views. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Terms such as “a,” “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. When ranges are specified for an attribute, it is meant herein that the attribute may include the value specified at the end of the range. For example, when the attribute is of a value of at least about X, the attribute can be X, or any value greater than X. For example, when the attribute is of a value of at most about Y, the attribute can be Y, or any value smaller than Y. For example, when the attribute is of a value from V to Z, the attribute can be V, the attribute can be Z, or the attribute can be any value between V and Z. It should also be understood that any ranges of values referred to herein should be read to include the upper and lower boundaries of such ranges. For instance, a range expressed as ranging “between approximately 1.0 inches and approximately 1.5 inches” should be read to include approximately 1.0 inches and approximately 1.5 inches, in addition to including the values between those upper and lower boundaries. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims-is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled,” “operatively configured,” or “operatively connected” refers to a first mechanism that is coupled (or connected) with a second mechanism to allow the intended operation of the second and/or first mechanism. The coupling may comprise physical or non-physical coupling. The non-physical coupling may comprise signal induced coupling, e.g., wireless coupling.

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

Performing a reversible first operation is understood herein to mean performing the first operation and being capable of performing the opposite of that first operation (e.g., which is a second operation). For example, when a controller directs reversible opening a shutter, that shutter can also close, and the controller can optionally direct a closure of that shutter. For example, when a wing reversibly translates in a first direction, that wing can also translate in a second direction opposite to the first direction. For example, when a controller directs reversibly translating a wing in a first direction, that wing can translate in the first direction and can also translate in a second direction opposite to the first direction, e.g., when the controller directs the wing to translate in the second direction.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of operations (e.g., steps) performed in the execution of a method does not imply that those operations (e.g., steps) must be performed in the order presented but instead may be performed in a different order or in parallel.

In some embodiments, AVs may be used for various tasks. The AV may comprise a UAV. The tasks may comprise versatile missions. The tasks may comprise photogrammetry, commercial, defense, security, humanitarian, geospatial, agricultural, forestry, monitoring, energy utilities, oil and gas, mining, fire, external inspection, public safety, police, border patrol, defense, drone as first responder (DFR), patrol overwatch, surveillance, law enforcement, military, close air support (CAS), tactical, special weapon and tactics (SWAT), hazardous materials (HazMat), search and rescue, situational awareness, aerial photography, video, filmmaking, private, government, sensor(s) data such as for 3rd parties, or any combination thereof. The commercial tasks may comprise enterprise solutions for the enterprise sector. Photogrammetry may comprise mapping.

In some embodiments, the AV (e.g., UAV) comprises a hub, wings, and propellers. The hub may be referred to as the “fuselage,” or “central hub.” The hub may be coupled with a plurality of wings, e.g., at least 2, 3, or 4 wings. In some embodiments, the hub is coupled with three wings.

Each of the wings may comprise, or be operatively coupled with, a propeller disposed at the distal end of the wing opposing the hub. The AV may comprise one or more sensors and/or detectors.

The sensor(s) may be disposed in, or part of, the hub, the wing(s), the propeller(s), or in any combination thereof. The AV may comprise one or more actuators such as motors. The actuator(s) may be disposed in, or part of, the hub, the wing(s), the propeller(s), or in any combination thereof. The actuator may comprise, or may be operatively coupled with, an encoder, or a controller. In an example, the actuator is a servomotor, and the controller is a microcontroller. The AV may comprise one or more controllers, e.g., as part of a control system. The controller(s) may be disposed in, part of, or be operatively coupled with, the hub, the wing(s), the propeller(s), or in any combination thereof.

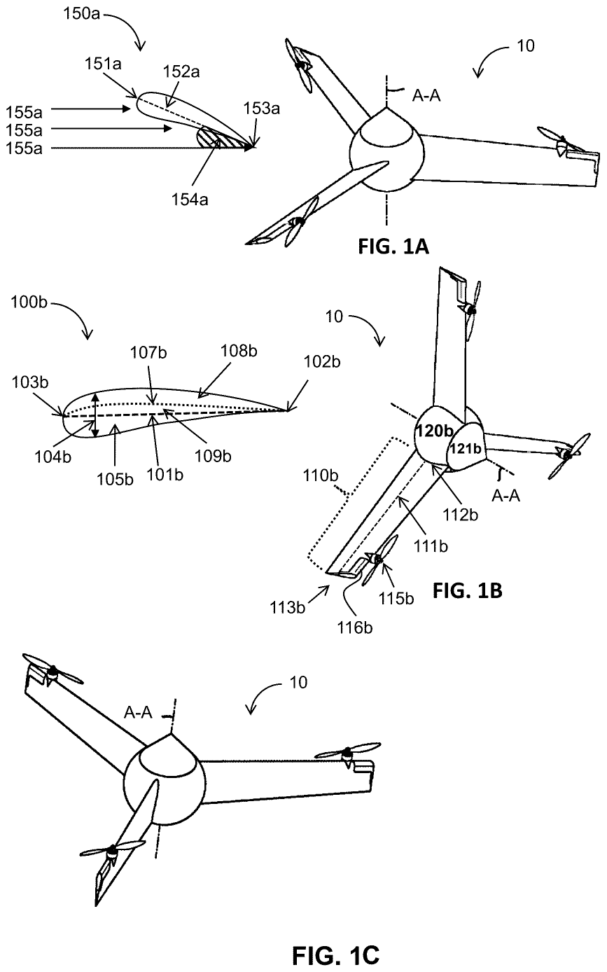

Unless otherwise indicated, the terms “proximal” and “distal” are defined herein relative to a central axis of the AV (e.g., UAV such as vortex drones) of the present disclosure. The central axis of the AV may be disposed in the hub. The term “proximal” refers to the position of an element closer to the central axis of the AV. The term “distal” refers to the position of an element further away from the central axis of the AV. In addition, the terms “upper,” “lower,” “top,” and “bottom,” are used with respect to the examples and associated figures and are not intended to unnecessarily limit the invention described herein. FIGS. 1A, 1B, and 1C show examples of AV 10 (e.g., UAV) having central axis AA.

In some embodiments, the central axis of the AV is disposed in the hub of the AV. In some embodiments, the AV flies in one of several flight modes, e.g., interchangeably. In some embodiments, the flight modes comprise (A) wings spinning about a central axis of the hub, referred to herein as “S-MOD” (B) Vertical flight mode referred to herein as “V-MOD,” or (C) Lateral (e.g., horizontal) flight mode referred to herein as “C-MOD.” The lateral flight mode (to/from location) may be referred to as cruising mode (C-MOD). S-MOD may be also referred to as “vortex mode” or “windmill mode.” The lateral flight C-MOD may be a “fixed wing mode.” In some embodiments, the AV flies in S-MOD. In S-MOD, the AV may be substantial stationary, e.g., with respect to the vertical axis (e.g., substantially) normal to the horizon. S-MOD may comprise hovering, e.g., about a location on the ground. In S-MOD, the AV translates laterally, e.g., to a limited extent. While in S-MOD, the AV may be substantially stationary with respect to the vertical axis. While in S-MOD, the AV may or may not be substantially stationary with respect to its horizontal position. While in S-MOD, the AV may rotate about a vertical axis disposed within its circumference normal to the central axis, which vertical axis may or may not coincide with the central axis in the hub. In S-MOD, (i) a plane comprising the long wing axes may be (e.g., substantially) perpendicular to the ambient gravitational vector and/or the (ii) central axis of the AV may be (e.g., substantially) perpendicular to the ground and/or parallel to the ambient gravitational vector.

In some embodiments, the AV flies in V-MOD. In an example, when in V-MOD, the main vector component of the direction of flight is the vertical component. The vertical flight (up/down) mode (V-MOD) may be also referred as “tri-copter mode.” In V-MOD, the thrust and control of the AV is being provided at least in part (e.g., mainly) by the actuators utilized for propulsion. In V-MOD, the long axis of the wings may be disposed in a lateral position, while the long axis of the hub is disposed perpendicular to the ground and/or parallel to the ambient gravitational vector. In V-MOD, (a) a plane of the long wing axes may be (e.g., substantially) parallel to the ground and/or (b) perpendicular to the ambient gravitational vector. In V-MOD, the central axis of the AV may be (e.g., substantially) perpendicular to the ground, parallel to the ambient gravitational vector, and/or parallel to the direction of flight. In V-MOD, the flight direction may be (e.g., substantially) along the central axis of the AV disposed in the hub. The chord of the wing may or may not be disposed in a plane parallel to the ground, e.g., during adverse environmental conditions such as heavy wind gusts the chord may be non-parallel to the ground. In V-MOD the AV may be horizontally substantially stationary relative to a position on the ground, e.g., terrain.

In some embodiments, the AV flies in C-MOD. In H-MOD the AV may travel from one location on the ground to another location that is laterally (e.g., horizontally) different. In an example, when in C-MOD, the main vector component of the direction of flight is the horizontal component. The lateral flight may or may not be (e.g., substantially) parallel to the ground. The lateral flight may be substantially stationary relative to the vertical axis or may vary in the vertical axis. In C-MOD, a plane with the long wing axes may be (e.g., substantially) perpendicular to the direction of flight. In C-MOD, the central AV axis may be (e.g., substantially) parallel to the direction of flight.

In some embodiments, the AV transitions between at least two of the flight modes, e.g., reversibly, interchangeably, seamlessly, and/or controllably. The actuator(s) (e.g., motor(s)) controlling the flight in a mode may actuate switching between at least two of the modes. In some embodiments, no additional (e.g., dedicated) actuator(s) is required for flight mode switching. In some embodiments, no additional (e.g., dedicated) actuator(s) is required to transition from one of the flight modes to another. The flight mode switching may comprise switching (A) from S-MOD to C-MOD, (B) from S-MOD to V-MOD, or (C) from C-MOD to V-MOD. FIG. 1D shows an example of AV 10 (e.g., UAV) transitioning between modes. In FIG. 1D, AV 10 takes off in V-MOD (tri-copter mode), transitions to C-MOD (as fixed wing mode) to get fast to a requested location, then transitions to S-MOD (e.g., windmill mode) for search/monitor task, then transitions to C-MOD (as fixed wing) to get back fast, and then to land in V-MOD (tri-copter). In this example, transition from V-MOD to S-MOD and vice versa is through C-MOD. In other embodiments (not shown in FIG. 1D), the AV transitions from V-MOD directly to S-MOD without going through C-MOD. An optimal spin rate in S-MOD may depend at least in part on one or more properties comprising (a) weight of the AC, (b) weather, (c) speed, (d) altitude, or (e) acceleration. The one or more properties may comprise an input, e.g., from a user such as a pilot. The one or more properties may comprise a change thereof. The weather may be any weather disclosed herein, e.g., wind. The weather may be disclosed herein in the context of an environmental event.

In some embodiments, a larger diameter propeller has higher efficiency than a smaller diameter propeller. Helicopter type drones may allow more flight time than quadcopters, e.g., because the helicopter type drone has one large propeller (e.g., rotor) instead of four small propellers. However, there are disadvantages and/or inefficiencies with a helicopter, such as due to the torque generated on (a) the airframe (b) the gearbox, or (b) the airframe and the gearbox.

Helicopters (e.g., and other traditional rotorcrafts) may have the (main) motor disposed in the main body, which turns a shaft that is connected to the main rotor. The torque should preferably (e.g., has to) be counteracted by the airframe. Without wishing to be bound to theory, this can be based at least in part on Newton's 3^{rd} law of equal and opposite torque. This torque should (e.g., must) be counteracted by another movement, which in single-rotor helicopters may be (e.g., is typically) a tail rotor. This extra tail rotor may cause a waste of energy, weight, cost, and/or complexity. The motor (e.g., electric or gas turbine) on traditional helicopters may be (e.g., are) efficient at high speeds with low torque. The main rotor on some traditional helicopters may requires the shaft to be turning at low speed/high torque, e.g., to overcome the significant aerodynamic drag loads as well as to (a) avoid the helicopter blades from turning too fast and/or (b) avoid the aerodynamic flow from reaching supersonic speed. A complex and/or multi-stage gearbox may be required to transition (e.g., take) the turbine/motor output from high speed/low torque—to low speed/high torque. Such (e.g., this) gearbox may have power transmission losses, and/or may add to the airframe significant (i) weight, (ii) cost, (iii) complexity, or (iv) any combination thereof. The propeller may be optimized based at least in part on one or more properties comprising propeller diameter, motor type, battery voltage, thrust, or torque. The performance of the propeller may depend at least in part on the torque required to be applied to the airframe of the AV to overcome aerodynamic drag forces, e.g., while spinning at the required RPM to generate the correct amount of lift the AV such as in H-MOD. The performance of the propeller and/or its actuator are configured (e.g., sized) to have enough thrust to effectuate flying in V-MOD mode. The wing may withstand high radial (centrifugal) loads and/or high transverse (bending) loads, e.g., to facilitate flight in standard and/or eventful flight such as the event(s) as disclosed herein including the adverse events. In an example, the wing may withstand at least about 7 lbs, 10 lb, or 15 lb radial loads.

In some embodiments, the AVs disclosed herein (e.g., the UAV such as the vortex drones of the present disclosure) reduce (e.g., avoid) the need for a tail rotor, e.g., because the AV is spun about its axis by a torque created by a series of propeller systems that generate thrust at the end of a long moment arm. When the AV is operating in an S-MOD (e.g., vortex mode as explained herein such as below), the (e.g., entire) airframe is converted (e.g., turns) into one (e.g., giant) propeller. A certain amount of torque may be (e.g., is) required to overcome the wing aerodynamic drag that is a byproduct of the lift from the wings, e.g., whenever lift is created, drag is created. By maximizing the moment arm, e.g., by putting the propeller systems at the end of each wing of the AV, the thrust required by each propeller system is reduced (e.g., minimized), which may reduce the overall power consumption of the AV of the present disclosure. There may still be a small amount of torque, e.g., generated from each propulsion motor at the end of each wing. Such an amount of torque may be small, e.g., as compared to the torque required for other types of AVs such as the helicopter disclosed above. Such an amount of torque may be handled by a control system logic found within the AV (e.g., vortex drone) of the present disclosure. The control system logic may comprise a control scheme.

In some embodiments, the AVs disclosed herein comprise a hub. In some embodiments, the hub comprises a central axis, e.g., (FIGS. 1A-1C, A-A). The hub may comprise portions that rotate one with respect to the other. The hub may comprise a first portion and a second portion. In an example, the first hub portion rotates with respect to the second hub portion. The first hub portion may have a casing (e.g., skin) having an exposed surface larger than the exposed surface of the second hub portion. The casing may be the body of the hub. The second hub portion may be referred to herein as the “turret.” The second hub portion may be, or be replaced by, a Gimble. In some embodiments, the hub is a single unit excluding portions that rotate one with respect to another. An external surface of the hub may adopt the shape of a truncated ball. The ball may be truncated to generate faces. The faces may comprise wing mounts, the faces may comprise camera, camera mount (also referred to herein as camera “holder”), gimble, and/or gimble mount. The faces may comprise access to electrical circuitry, data transmission, sensors, and/or batteries. In some embodiments, one of the faces may comprise a top hub cap, e.g., a nose. The top hub cap may house sensor(s) (e.g., as a camera) that are part of, or are operatively coupled with, the hub. The top hub cap may be configured to protect one or more internal components of the hub.

The circuitry is configured to withstand power spikes, e.g., using components comprising a capacitor or a transistor such as a metal oxide semiconductor field effect transistor (MOSFET).

In some embodiments, the AV is an unmanned AV (UAV). In some embodiments, the AV is a manned AV. The manned AV may be occupied by a pilot in a portion of the hub that is directed to a target such as when the AV is in S-MOD, as opposed to another portion of the hub that is rotating. The target may comprise a direction or a position. The AV may be directed by a user such as a pilot, on the ground and outside of the AV.

In some embodiments, the AV comprises wings. The wings may comprise at least 2, 3, or 4 wings. In some embodiments, the wings comprise three wings. The wing may comprise an external surface (e.g., skin or cladding). In some embodiments, the wing comprises a long axis, the wing having a first end along the log axis, and an opposing second end along the long axis, the first end opposing the second end. The first end may be configured to couple to the hub, e.g., and may be referred to as the “base” of the wing. The second end may be referred to as the wing “tip.” The wing may mount to the hub at the first end (e.g., base) of the wing. During operation of the AV, the wing may be (e.g., substantially) fixed in position with respect to the hub. During operation of the AV, the wing may be movable with respect to the hub, e.g., rotatable such as along its long axis. The rotation may be predetermined, pre-programed, or dynamically altered in real time during operation of the AV, e.g., during flight. The wing may have a cross section perpendicular to the long axis, the cross section being an airfoil section, having a thickness, a camber line (e.g., also referred to as a “mean camber line”), and a chord. The chord is the long axis of the airfoil connecting the leading edge of the airfoil to its tailing edge, the chord being the shortest distance between the leading edge and the tailing edge of the airfoil designated by the chord line. The leading edge is the section of the airfoil interacting with the fluid (e.g., airstream) first, and the tailing edge is the section of the airfoil interacting with the gas (e.g., airstream) last. The leading edge may have a curvature, e.g., having a radius. The camber line connects the leading and tailing edges of the airfoils such that it is equidistant from the top and bottom surfaces of the airfoil. The camber line is disposed midway between the upper and lower surfaces of the airfoil. The camber is the distance between the camber line and the chord line. The airfoil may comprise a symmetrical or an asymmetrical shape, e.g., about the chord line, about a normal to the chord line, and/or about the long axis of the wing. In some embodiments, the airfoil is symmetric along a normal to the chord line, where the tailing edge can be the leading edge, and vice versa. In some embodiments, the airfoil is symmetric along the chord line, where the camber line and the chord line coincide. The wing may be in a zero-camber configuration, e.g., when the camber line and chord line coincide. When there is a camber in the airfoil that does not coincide with the chord, the wing may be in a positive camber configuration, or in a negative camber configuration, e.g., depending on the mode of flight and/or the direction of flight. The airfoil may comprise a symmetrical biconvex, an asymmetrical biconvex, a flat bottom, an under cambered, a reflex camber (e.g., curve), or a supercritical airfoil shape. The airfoil may comprise a subsonic, supersonic, or transonic shape. The wing may comprise a spar, ribs, stiffeners, braces, stringers, flap, aileron, or struts. In some embodiments, the wing is devoid of a flap and/or an aileron. The airfoil may comprise an upper camber, a mean camber, or a lower camber. The chord (e.g., chord line) of the airfoil (a) may be disposed in the airfoil or (b) may be disposed at least in part outside of the airfoil. The airfoil comprises a camber line, an upper surface and a lower surface. The airfoil may comprise a camber. The lift force experienced by the wing depends at least in part on (a) the shape of the airfoil, (b) the velocity of the wing, (c) the density of gas (e.g., air) flowing, (d) the surface area, (e) angle of attack of the airfoil, or (f) any combination thereof. The airfoil has a maximum thickness, which is the distance between its top and bottom surfaces. The angle of attack being the angle between the fluid (e.g., air) flowing onto the wing, and the chord line of the wing.

In some embodiments, the wing is configured to alter its position relative to the central axis of the hub. The change of position may be before, during, and/or after a flight. The change in position may be during a flight in a mode, or during a transition between different modes, e.g., transition from one flight to another. The position of the wing relative to the central axis of the hub may be optimized for a mode of flight. The relative position of the wings may be defined by the wing's long axis and/or by the position of the chord of the airfoil. The position of the wing may be stationary (e.g., fixed) in a flight mode. The position of the wing may alter during transition from one flight mode to another. The position of the wing may be stationary in a flight mode and may alter during transition from one flight mode to another.

In some embodiments, the AV is configured to fly in S-MOD. In S-MOD (e.g., vortex mode or windmill mode), at least one chord of the wing (e.g., each chord of each wing) may disposed at an angle relative to a plane perpendicular the central axis of the hub, the angle being non-perpendicular, e.g., different from a right angle. The angle between the chord and a plane perpendicular to the central axis of the hub, may be at most about 50 degrees (°), 45°, 35 , 25°, 15°, 0.5°, or 0°. The angle between the chord and a plane perpendicular to the central axis of the hub may be between any of the aforementioned angles, e.g., from about 45° to about 25°, or from about 50° to about 15°. In an example, the AoA is (e.g., substantially) zero. The In S-MOD (e.g., vortex mode), at least one chord of the wing (e.g., each chord of each wing) may be non-perpendicular and/or non-parallel, relative to the central axis of the hub. The angle between the chord and a plane perpendicular to the central axis of the hub may be the AoA. between the chord and a plane perpendicular to the central axis may change dynamically during flight, e.g., in a controlled manner.

In some embodiments, the AV is configured to fly in C-MOD (e.g., cruise mode) and/or V-MOD (e.g., tri-copter mode). In the C-MOD and/or in the V-MOD, at least one chord of a wings (e.g., each chord of each wing) is disposed (e.g., substantially) parallel to the central axis of the hub. The substantial parallel disposition of the chord with respect to the central axis of the hub (e.g., in V-MOD and/or in C-MOD) may comprise forming an acute angle having an absolute value of at most about 15°, 10°, 5°, 2.5°, 1°, or 0.5°. The substantial parallel disposition of the chord with respect to the central axis of the hub, may comprise forming an angle having an absolute value between any of the aforementioned angles, e.g., from about 15° to about 0.5°, the angle being between the chord and the central axis of the hub. The substantial parallel disposition of the chord with respect to the central axis may be, or may be replaced by, the AoA. In an example, in the C-MOD and/or in the V-MOD, at least one chord of a wings (e.g., each chord of each wing) is disposed (e.g., substantially) perpendicular relative to a plane normal the central axis of the hub.

In one or more embodiments of the present disclosure, vortex drones 10 include a center hub 18 and a plurality of wings 16. The center hub 18 includes a central axis defined by the line A-A and each wing 16 of the plurality of wings includes a base 15 securable to the center hub 18.

Vortex drones 10 of the present disclosure may be operatively configured to operate in a variety of different flight modes. In one or more embodiments, some of the different flight modes include vortex mode as shown in FIG. 1A, a fixed-wing mode as shown in FIG. 1B, and in a tri-copter mode as shown in FIG. 1C. As shown in FIG. 1A, vortex mode is defined by the base 15 of each wing 16 being in a position offset from the central axis A-A of center hub 18. As shown in FIGS. 1B and 1C, both the fixed-wing mode and tri-copter mode are defined by the base 15 of each wing 16 being in a position parallel with the central axis A-A of the center hub 18. The mechanics of how each wing 16 is able to change its position relative to the central axis A-A of the center hub 18 will be discussed herein (e.g., below) in further detail. When vortex AV (e.g., drone 10) is in tri-copter mode, the wings 16 may be generally perpendicular to the ground, e.g., as the lift comes primarily from the propeller systems 12, and gravity should (e.g., must) be counteracted. In one or more embodiments, the wings 16 may be modulated slightly, e.g., to overcome the uneven motor torque of having an odd number of propeller systems 12, but the vase (e.g., far) majority of the thrust should (e.g., must) be opposite the gravitational force.

In some embodiments, the long axis of a wing is angled relative to the central axis of the hub. The smallest angle may at most about 90°, 75°, 60°, 55°, or 30°. The smallest angle may at least about 15°, 30°, 60°, 75°, or 85°. The smallest angle may be between any of the aforementioned angles, e.g., from about 90° to about 15°. In some embodiments, the long axes of the wings intersect in the hub, e.g., intersect with the central axis of the hub.

FIG. 1B shows an example of AV 10 having three wings including wing 110b. Wing 110b comprises base 112b that is its first end. Base 112b is proximal to hub 120b and is connected to hub 120b. Hub 120b comprises top hub cap (e.g., nose) 121b and main axis A-A running from the tip of top hub cap 121b and into hub 120b. Top hub cap 121b is shaped similar to a cone, and main axis A-A coincides with the height of that cone. The exterior (e.g., skin or casing) of hub 120b has an overall ball shape, the ball being truncated, e.g., at its top end, which is covered by top hub cap 121b. Wing 110b comprises long axis 111b and tip 113b opposing base 112b, which tip 113b is the second end of wing 110b. Base 112b and tip 113b are disposed along long axis 111b of wing 110b. Propeller 115b is disposed adjacent to tip 113b of wing 110b, and distal from hub 120b.

Light(s) can optionally be disposed at or beneath cover 116b of wing 110b. Cover 116b can be transparent or semi-transparent to the light to allow it to shine through the cover when active and when the light(s) are disposed in the interior of wing 110b beneath the cover. Wing 110b has a cross section of an airfoil, e.g., that can be seen in tip 113b. 100b is an example of an airfoil, which is the cross section of a wing along an axis perpendicular to the main wing axis such as 111b.

Airfoil 100b comprises chord line 101b running from one end of the airfoil that is its tailing edge 102b to its opposing end that is its leading edge 103b. The airfoil of wing 110b may or may not be similar to airfoil 100b. In the example of airfoil 100b, chord line 101b runs through the body of airfoil 100b. Airfoil 100b comprises camber line 107b, forming camber 109b between camber line 107b and chord line 101b. Upper camber space 108b is disposed above camber line 107b, and lower camber space 105b is disposed below camber line 107b. Airfoil 100b has maximum thickness 104b.

FIG. 1A shows an example of an airfoil 150a relative to inflowing fluid streams 155a (e.g., air streams), depicted as flowing onto the lower surface of airfoil 150a. Airfoil 150a comprises chord line 152a disposed between leading edge 151a and tailing edge 152a of airfoil 150a. The angle of attack 154a is formed between chord line 152a and the direction of flow 155a.

In some embodiments, during flight, at least one wing of the AV is at a different angle with respect to the central axis of the hub, as compared to at least one other wing of the AV. During flight, at least two wings of the AV may be at a different angle with respect to the central axis of the hub, as compared to at least one other wing of the AV. During flight, at least two wings of the AV be at a (e.g., substantially) similar angle with respect to the central axis of the hub. During flight, at least two wing chords of the AV may be at a different angle with respect to the central axis of the hub, as compared to at least one other wing chord of the AV. During flight, at least two wing chords of the AV may be at a (e.g., substantially) similar angle with respect to the central axis of the hub. Each of the at least two wing chords being of another wing of the AV. The angle being any of the angles disclosed herein between the chord and the central axis of the hub.

In some embodiments, each wing of the AV disclosed herein has wings having (e.g., with) an airfoil cross sectional shape. In such a case, each of the wings may be in a different position with respect to the other(s) when the AV is in fixed wing mode, e.g., so that the drone may be able to fly as requested. While in fixed wing mode, one of the wings 16 can be perpendicular to the ground with an angle of attack of about 0°, while the other two wings 16 can each be angled up at an angle of attack between 1° and 15°. The angle of attack (AoA) is defined as “the angle between the chord of an airfoil and the direction of the surrounding undisturbed flow of gas or liquid measured relative to direction of the airflow,” e.g., see FIG. 1A. The gas can be air, e.g., ambient air. Keeping in mind that these (e.g., wings) are control surfaces that are subject to be independently articulated (e.g., controlled) to maintain stability of the AV (e.g., vortex drone 10), as well as to maneuver the AV. The overall stability of the AV (e.g., vortex drone 10) can be a key concept, e.g., as its natural state can typically be unstable. During operation of the AV (e.g., drone), (I) continuous (e.g., constant) correction(s) to the angle of attack of each wing 16 may be required and/or (II) continuous (e.g., constant) correction(s) to the speed of each propeller system 12 may be required. The corrections may be executed through the use of a control system, e.g., comprising a Flight Computer. The correction may be executed at least about several times per second—at a frequency. The frequency may be at least about 100 Hertz (Hz), 200 Hz, 400 Hz, 800 Hz, or 1000 Hz. The frequency may be between any of the aforementioned values, e.g., from about 100 Hz to about 1000 Hz, or from about 200 Hz to about 800 Hz. The frequency may depend at least in part on the flight mode, and/or on operational limitation(s).

In some embodiments, the AV is in an S-MOD. When in S-MOD, at least one (e.g., each) of the AV wings is disposed at an angle of attack (AoA) of at least about 2°, 5°, 10°, 15°, 25°, 35°, 45°, 55°, or 60°. When in S-MOD, at least one (e.g., each) of the AV wings is disposed at an AoA of at most about 10°, 15°, 25°, 35°, 45°, 55°, 65°, or 70°. When in S-MOD, at least one (e.g., each) of the AV wings is disposed at an AoA having any of the aforementioned values, e.g., from about 5° to about 65°, or from about 2° to about 70°. In some embodiments, when the AV disclosed herein is in S-MOD, at least one (e.g., each) of the wings is at an AoA of about 25° during hover.

When any lateral movement is required in S-MOD, the angle of attack of at least one (e.g., each) wing may be changed. The alteration may be in real time, e.g., during a rotation of the wings relative to the central axis of the hub.

In some embodiments, the AV disclosed herein is in an S-MOD (e.g., vortex mode). In some embodiments, when in S-MOD, each of the wings is disposed at an angle of attack (AoA) of between about 5° and about 65°, inclusive. In some embodiments, when the AV disclosed herein is in vortex mode, each of the wings is at an angle of attack of about 25° during hover, e.g., during S-MOD. When lateral movement is required in S-MOD (e.g., vortex mode), the angle of attack of each wing may be changed, such as during each rotation, e.g., about the central axis of the hub.

In some embodiments, the AV meets long endurance missions. The long endurance missions may or may not be in swarm mode. Meeting the long endurance mission may be due at least in part to a reduced power consumption of the AV it at least one flight mode, e.g., as compared to currently available AVs (e.g., UAVs). The power consumption during S-MOD can be lower, as compared to the AV operating in one or more of the other modes, with each mode being compared separately to S-MOD, the other modes being C-MOD and V-MOD. The power consumption during S-MOD can be at least about 5, 7, 9, or 10 times lower, as compared to the AV operation in one or more of the other modes, with each mode compared to S-MOD separately. Operating in S-MOD may allow the AV to safely operate even if two or more actuators (e.g., engines or motors) of the AV fail. The two or more actuators may be the propeller actuators and/or the wing actuators. The actuator may be a motor such as a servomotor. Such actuator (e.g., engine) failure may be a key safety feature when flying over the general public and/or during critical missions. In some embodiments, C-MOD operation enables the AV to efficiently and/or quickly travel from point A to point B.

In some embodiments, the AV is configured for failure prediction and/or risk mitigation. For example, the AV may safely land when one or more of its actuators malfunction. The actuator may comprise the wing actuator, propeller actuator or hub actuator. If more than one, but not all, of the actuators (e.g., motors) fail, the AC may continue flying in at least one of the flying modes such as in H-MOD. The one or more actuators may comprise wing actuators, propeller actuators, or hub actuator. In some embodiments, while the AV is in H-MOD, one actuator (the hub actuator) is required to produce the required torque around the center of mass of the AC, to cause the AC to spin. The center of mass of the AC can be along the central axis. When a wing actuator fails and the hub actuator is operational, the AC can continue flying in H-MOD mode with the wing fixed. In that case, the speed of the hub actuator may be modulated.

In some embodiments, S-MOD (e.g., vortex mode) may allow the AV to be able to meet long endurance swarm drone missions, e.g., as the power consumption during S-MOD hover can be up to seven times lower when comparted to the AV operating in V-MOD (e.g., tri-copter mode). S-MOD (e.g., vortex mode) also allows the AV to be capable of safely hovering, e.g., even if two or more actuators (e.g., engines) fail. The two or more actuators may be the propeller actuators and/or the wing actuators. The actuator may be a motor such as a servomotor. Such actuator (e.g., engine) failure may be a key safety feature when flying over the general public and/or during critical missions. In some embodiments, C-MOD (e.g., fixed-wing mode) enables the AV to be able to efficiently travel from point A to point B. When in a mission-critical position such as a search zone, the AV may operate in S-MOD, e.g., to lower (e.g., optimize) energy consumption. While in S-MOD, the AV may be able to move laterally, e.g., (a) by changing the angle of attack of each wing during each rotation, (b) modulate the motor speed of each propeller on each wing during the rotation to adjust the thrust, or (c) a combination of (a) and (b), e.g., dependent on what is most energy efficient mode combination. The AV can transition (e.g., return) to C-MOD (e.g., fixed-wing mode), such as when traveling back to a landing position, and may return to V-MOD (e.g., tri-copter mode) such as when ready to land.

FIG. 1D shows an example of how an AV (e.g., vortex drone 10) can change between the various flight modes as discussed herein (e.g., above). When the AV (e.g., vortex drone 10) takes off, it may be in V-MOD (e.g., tri-copter mode). While traveling to its intended destination, the AV may be in C-MOD (e.g., fixed-wing mode), e.g., to arrive quickly while achieving optimal energy efficiency to allow maximizing time on scene. When in a mission-critical position such as a search zone, the AV may operate in S-MOD (e.g., vortex mode) to optimize energy efficiency. While in S-MOD (e.g., vortex mode), the AV can move laterally, e.g., (a) by changing the angle of attack of each wing during each rotation, (b) modulate the motor speed of each propeller on each wing during the rotation to adjust the thrust, or (c) a combination of (a) and (b), e.g., dependent on what is most energy efficient mode combination. The AV can transition (e.g., return) to C-MOD (e.g., fixed-wing mode), such as when traveling back to a landing position, and may return to V-MOD (e.g., tri-copter mode) such as when ready to land.

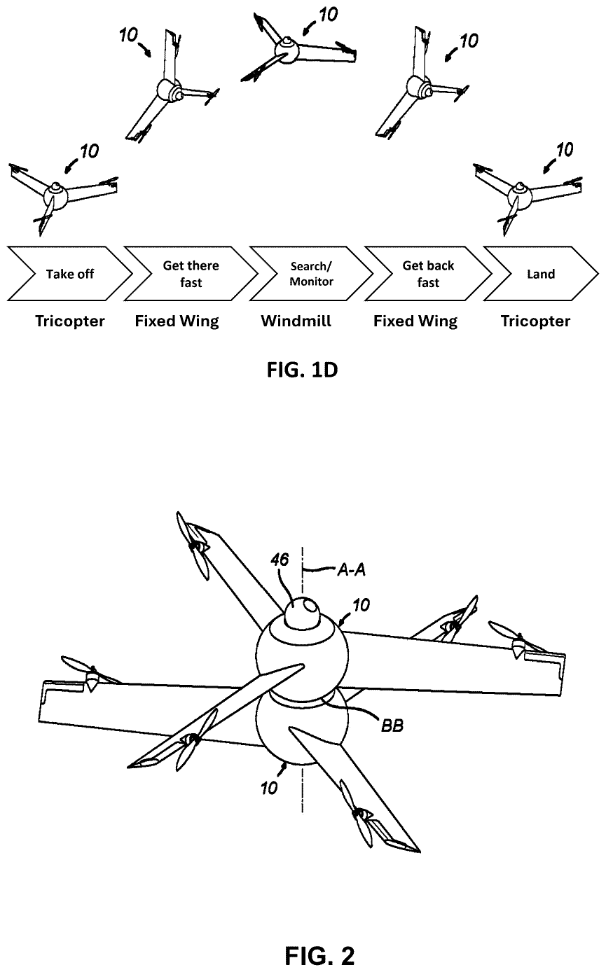

In some embodiments, each AV (e.g., UAV such as vortex drone 10) of a plurality of AVs of a similar type may be stackable with another AV (e.g., vortex drone 10) of the same type, such as shown in the example of FIG. 2. In practice, every other AV (e.g., vortex drone 10) can counter-rotate with the AV (e.g., vortex drone 10) they are (e.g., immediately) adjacently stacked next to. In some embodiments, this counter-rotating and stacking option increases efficiency, e.g., increase hover time and payload. The increased efficiency may be by an additional efficiency percentage of at least about 5%, 6%, 10%, 15%, or 20%. The increased efficiency may be by an additional efficiency percentage of at most about 10%, 15%, 16%, 20%, or 25% efficiency, as compared to when the AVs were each flying individually. The increased efficiency may be by an additional efficiency percentage between any of the aforementioned percentages, e.g., from about 5% to about 25% efficiency increase, or from about 6% to about 16% efficiency increase, as compared to when the AVs were each flying individually. Such efficiency increase may be due to the aerodynamic benefit.

Two AVs that are counter rotating in S-MOD may each consume at least about 60%, 70%, 80%, 90%, or 95% of the power when flying in a swarm mode to. Two AVs that are counter rotating in S-MOD may each consume a percentage of the power when flying in a swarm mode, the percentage being between any of the aforementioned percentages, e.g., from about 60% to about 95%, or from about 90% to about 95%. Two AVs that are counter rotating in S-MOD may each consume at most about 4%, 6%, 7%, 8%, 9%, 10%, 15%, or 25%, less power when flying in a swarm mode, as compared to each of them hovering individually. Two AVs that are counter rotating in S-MOD may each consume less power when flying in a swarm mode, as compared to each of them hovering individually, between any of the percentage values, e.g., from about 6% to about 16%. In an example, two vortex drones that are counter rotating in hover move may each consume from at least about 4% to about 25% less power, as compared to when the drones are hovering individually. In some embodiments, AVs operating in swarm mode may lift more weight as compared to their weightlifting ability when each of them is operating individually. The more weight may be more by at least about 1.5*, 2*, or 2.5* times more weight. The symbol “*” designates the mathematical operation “times.” For example, (e.g., Additionally,) if each AV (e.g., drone) can individually lift about 20 kg in vortex mode, a counter rotating AV (e.g., vortex drone) may be able to lift up to about 44 kg with the same, or substantially the same, energy used.

In one or more embodiments, the AV (e.g., vortex drones 10 of the present disclosure) can be utilized to assist in remote communications, such as for search and rescue missions. In such an embodiment, a swarm of AVs of the same type (e.g., vortex drones 10) can autonomously form a link between a service area and the area of interest, e.g., for the search. The AV (e.g., vortex drones 10) can be equipped with a signal repeater for wireless communication, e.g., cellular communication such as using cell phones. If someone is trapped with a wireless signal emitter (e.g., a cell phone), the signal may be relayed back to the service area via the repeaters. This method may be used to form an alternate communication network, e.g., in military missions and/or when natural disasters have destroyed standard (e.g., wired) communication infrastructure as part of the communication system. The communication system comprises a communication interface (e.g., hardware) and a communication platform (e.g., software). In one or more embodiments, the wings of the AV (e.g., vortex drone 10) can include one or more antennas, e.g., to boost the range of the signal.

In some embodiments, the AV may be configured to carry an excess weight that is in excess of its own weight. The AV may carry an excess weight of at least about 2.5 pounds (lbs.), 5 lbs, 10 lbs, 20 lbs, 40 lbs or 60 lbs. The AV may carry an excess weight between any of the aforementioned weights, e.g., from about 2.5 lbs. to about 60 lbs. The AV may an excess weight at most about 0.5 kilogram (Kg), 1 Kg, 5 Kg, 10 Kg, 15 Kg, 20 Kg, 25 Kg, or 30 Kg. The AV may carry an excess weight between any of the aforementioned weights, e.g., from about 0.5 Kg to about 30 Kg. The excess weight may comprise a package, e.g., for delivery. The AV may facilitate delivery of the weight from one location to another. The AV may be utilized in delivery, shipping, receiving, picking, optimizing warehouse operation, or any other warehouse management task. The AV may be operatively coupled with a warehouse management system. The AV may perform tasks comprising batch picking or discrete picking of the excess weight. The weight may comprise an animated object, or an inanimate object.

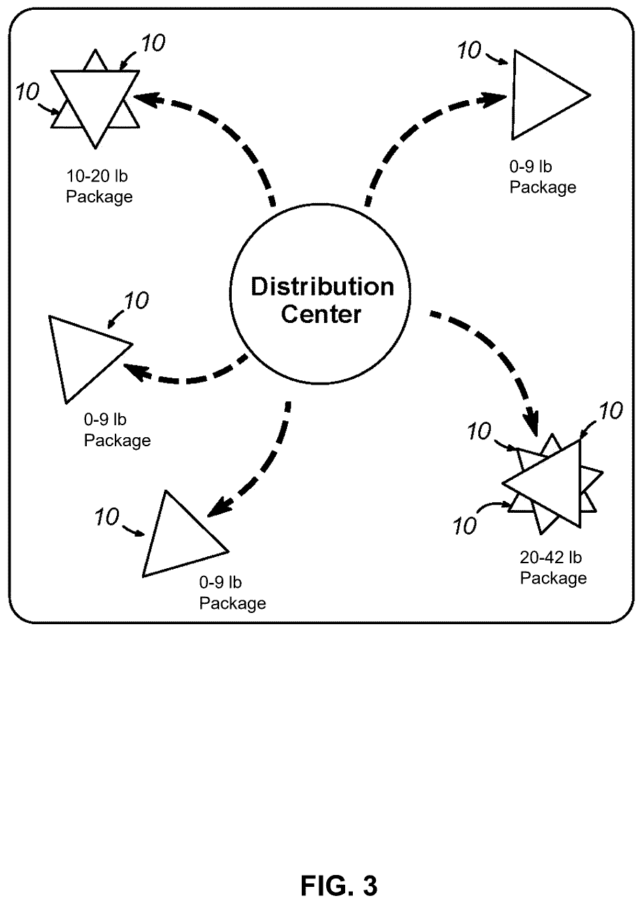

In one or more embodiments, the AV (e.g., UAV such as the vortex drones 10 of the present disclosure) can be utilized to deliver packages from a distribution center, such as shown in the example in FIG. 3. For example, if a package weighing less than about 10 pounds needs to be delivered, a single AV (e.g., vortex drone 10) can deliver the package. If a package weighing between 10 and 20 pounds (inclusive) needs to be delivered, two vortex drones 10 can be stacked together and operated in a counter-rotating way as discussed above to deliver the package. And, if a package weighing between 20-43 pounds (inclusive) needs to be delivered, four AVs (e.g., vortex drones 10) can be stacked together and operated in a counter-rotating way as discussed above to deliver the package. Such a system simplifies flight operations as AVs (e.g., vortex drones 10) are stackable with one another to deliver larger payloads.

In one or more embodiments, a motorized gimbal, camera, a cable and hook arrangement, or combinations thereof are secured to the underside of the AV, e.g., vortex drone 10. In a (e.g., typical) situation, the AV (e.g., UAV such as vortex drone 10) takes off in V-MOD (e.g., tri-copter mode), and then switches to a C-MOD (e.g., fixed-wing) for travel, or to an S-MOD (e.g., vortex mode) for hovering. The motorized gimbal may be able to spin in the opposite direction, e.g., to keep the camera, cable, hook, and object being carried from spinning relative to the ground.

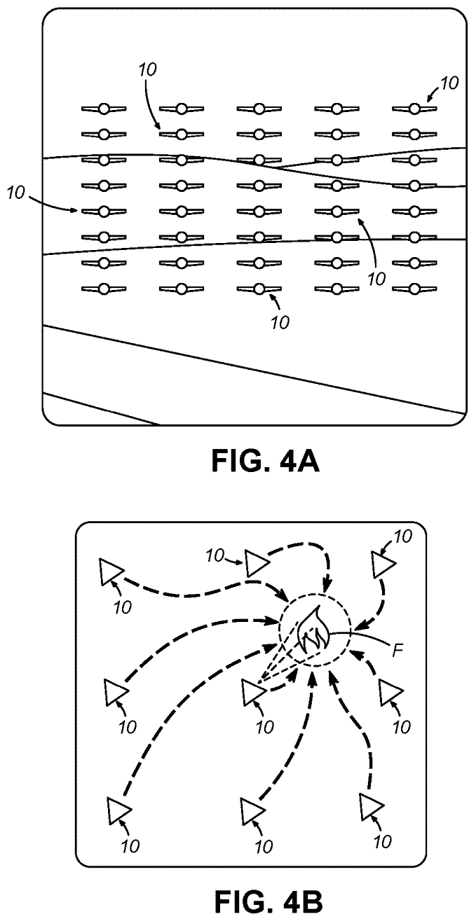

In one or more embodiments, the AV (e.g., vortex drones 10 of the present disclosure) can be utilized to monitor and/or protect areas under elevated risk (e.g., high risk) of wildfires. For example, as shown in the example of FIG. 4A, a swarm of AVs (e.g., vortex drones 10) can be set out in an area above a fire. The AV can use real time monitoring from a thermal camera, e.g., to provide information back to a fire-fighting team a safe distance away. As shown in the example of FIG. 4B, a swarm of AVs (e.g., vortex drones 10) can (e.g., also) be utilized to actively fight a fire by starting a controlled burn to isolate the area. The AV (e.g., Vortex drones 10) can be equipped with fire starting devices, e.g., to drop the fire-starting devices ahead of the fire in order to isolate the fire so that it does not spread, which can allow fire trucks and helicopters to have more time to get to the fire to extinguish it.

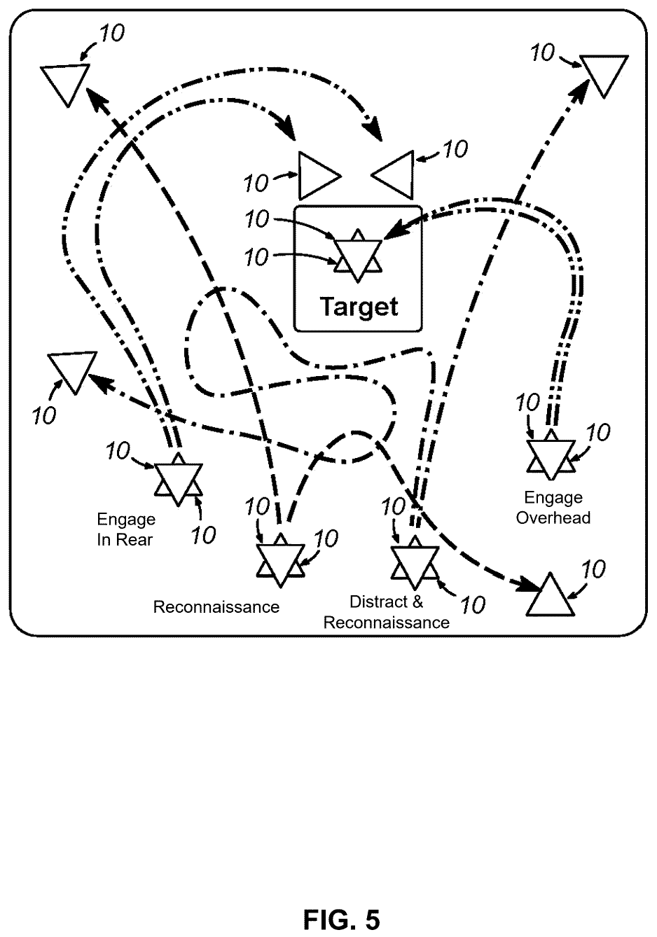

In one or more embodiments, the AV (e.g., vortex drones 10) can be utilized in a military situation. For example, a swarm of vortex drones 10 can be placed in a grid formation over a battlefield, and through the use of proximity sensor, LiDAR, radar and/or camera images, the AV (e.g., vortex drones 10) can provide detailed obstacle and landscape information. In one or more embodiments, through the use of detect and react artificial intelligence (e.g., machine learning) computational scheme, the swarm of AVs (e.g., vortex drones 10) can intelligently engage targets. Intelligent computational schemes (e.g., algorithms) can be applied to the swarm of AVs (e.g., vortex drones 10), which can be used to (a) engage targets and/or (b) overwhelm anti-drone defenses of the opponent. As shown in the example of FIG. 5, the swarm of AVs (e.g., vortex drones 10) can be singularly deployed (e.g., each AV in the swarm deployed individually), or they can be deployed (e.g., collectively) in a stacked formation as discussed herein (e.g., above). The AV stacked formation may separate in mid-air, e.g., to carry out their designated missions. In a plurality of AVs (e.g., swarm of AVs), at least two AVs may each be deployed together, e.g., collectively. In a plurality of AVs (e.g., swarm of AVs), at least two AVs may each be deployed individually. The two AVs deployed individually, may be deployed in parallel, sequentially, or otherwise in concert.

In some embodiments, the AV is equipped with propellers, e.g., disposed at the distal portion of the wing away from the hub. A propeller may be disposed at a distal portion of the wing towards the tip of the wing, or at the tip of the wing. The distal portion of the wing may span at most about ½, ⅓, ¼, ⅕, ⅛, 1/16, 1/32, or 1/64 of the long axis of the wing starting at the tip of the wing. The propeller may rotate in a space having a height and a base area. A FLS of the base area may be at least about 5″, 7″, 10″ or 12″, The FLS of the base area may be between any of the aforementioned values, e.g., from about 5″ to about 12″, or from about 7″ to about 10″. The propellers may receive control signal simultaneously from the control system, e.g., the same signal.

In some embodiments, the AV may comprise at least one light. The light may be disposed, or may be part of, the propeller, the wing, the hub (e.g., the first portion thereof and/or the second portion thereof), or any combination thereof. In one embodiment, the wing comprises at least one light. A light may be coupled with, or may be part of, the wing. The light may be disposed at a distal portion of the wing towards the tip of the wing, or at the tip of the wing. The distal portion of the wing may span at most about ½, ⅓, ¼, ⅕, ⅛, 1/16, 1/32, or 1/64 of the long axis of the wing starting at the tip of the wing. The light may integrate with the propeller related apparatus, e.g., to form one unit. The light, propeller, or light propeller unit may be modular and/or replaceable. The light may be configured reversibly and/or interchangeably, turn on and off. The light may be configured reversibly and/or interchangeably, changing from one light type to another light type. The light types may comprise electromagnetic radiation in the infrared, visible, ultraviolet, or any combination thereof. The light type may be configured to comply with jurisdictional regulations, e.g., night flight regulations such as those issued by the Federal Aviation Administration (FAA). The light type may be designated to change color and/or turn on and off, e.g., based at least in part on (A) a rotation (e.g., clocking) position of the wing, (B) a relation to the direction of movement, (C) relative to a target, and/or (D) relation to geographical directions such as cardinal directions. A relation to the direction of movement may comprise back, forward, right side, or left side. In an example, the right side may be designated as a green light, the left side may be designated as a red light, and their intersection may be the forward movement. In an example, the forward direction may be designated as a white light. The directional designations may be regardless of the rotation of the wings, e.g., while the AV is in any of its flight modes. The directional designations may comprise relative (e.g., to a target), or absolute directions (e.g., cardinal). The target may comprise a location or a direction of flight. The lightings may be comprised in, or attached to, the wing(s), e.g., along an edge of a wing, at a location of a wing such as at the distal tip of the wing. The light(s) can indicate operation preparedness, battery life, directionality of flight, temperature range, police lighting (e.g., comprising red or blue) such as for first responders, and/or malfunction. The lights can change color or not, e.g., to indicate the direction of the AV, e.g., at night, to differentiate between a side of the AV and its opposing side.

The light disposed along the distal face of the wing opposing the hub. The light(s) may be disposed parallel to the central axis of the hub. The light(s) may span at least a portion of the distal edge of the wing. The light(s) may be shielded by transparent (e.g., partially transparent) material, e.g., shaped as a cone. The color of the light can be controlled, e.g., based at least in part on the relative location of the wing such as relative to the geographical location of the AV. The color of the light can be controlled, e.g., based at least in part on a position of the hub (e.g., first portion of the hub) such as relative to the geographical location of the AV. The color of the light can be controlled, e.g., based at least in part on direction of the central axis of the hub, e.g., relative to the geographical location of the AV. The light positioning may relate to flight mode, e.g., to comply with jurisdictional flight regulations in which jurisdiction the AV is deployed, e.g., the federal aviation administration (FAA) regulations. In an example, during V-MOD (e.g., tri-copter mode), the front-left wing is lit up red, the front-right wing is lit up green, and the aft wing is lit up white. In an example, during S-MOD (e.g., windmill mode) lights comprise three 120° sectors where the front left sector lights up red, the front right sector lights up green, and the aft sector lights up white. In an example, the forward direction is indicated where the green and red lights intersect.

In one or more embodiments, each wing 16 can (e.g., also) include a wingtip light 22 to allow for night flights. In one or more embodiments, the wingtip lights 22 are configured to turn on and off based at least in part on the rotation of each wing 16 to comply with night-time regulations issued by the Federal Aviation Administration (FAA). In one or more embodiments, the wingtip lights 22 can change color or turn on and off based at least in part on a clocking position of each wing 16.

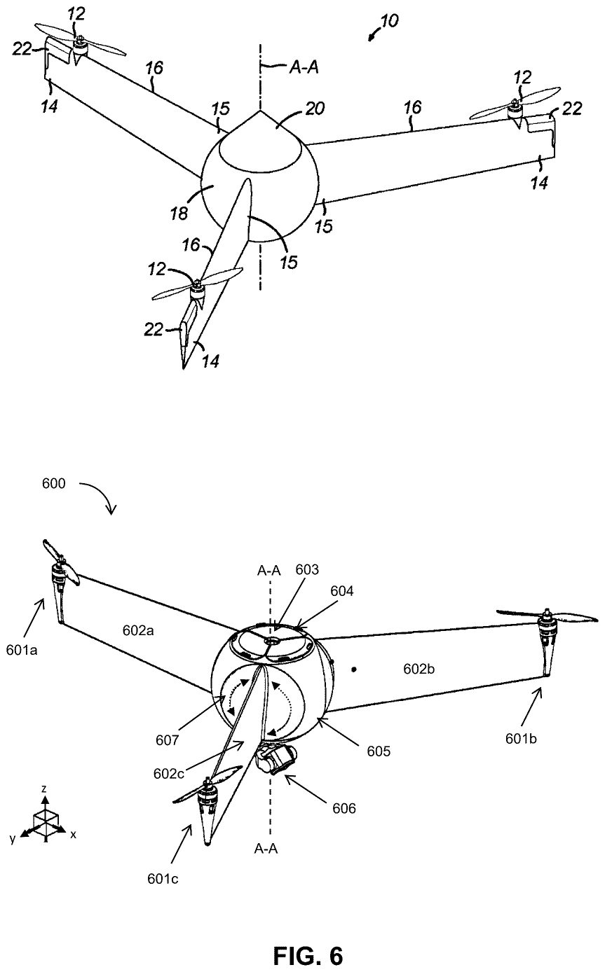

FIG. 6 shows an example detail of various external components of an AV (e.g., vortex drone) 10. AV (e.g., vortex drone) 10 may be equipped with one or more propeller systems located adjacent to an end 14 of each wing 16 of vortex drone 10. Each wing 16 may be secured to a center hub 18, which may be capped with a top hub cap 20, e.g., to protect the internal components found within the center hub 18. In one or more embodiments, each wing 16 can also include a wingtip light 22 to allow for night flights. In one or more embodiments, the wingtip lights 22 are configured to turn on and off based at least in part on the rotation of each wing 16 to comply with night-time regulations issued by the Federal Aviation Administration (FAA). In one or more embodiments, the wingtip lights 22 can change color or turn on and off based at least in part on a clocking position of each wing 16.

In some embodiments, components of the AV are symmetrical and/or are symmetrically arranged. The symmetry can be about a rotational axis, and or about a mirror plane. The symmetrical axis may comprise a Cn axis, with n being an integer having a value of at least about 2, 3, 4, 5, or 6. The axis may comprise the central axis of the AV, a chord of the airfoil, a long axis of the wing, a rotational axis of the propellor, a height of a battery pack, a height of a battery holder, a center of mass of the AV, an aerodynamic center of the AV, or any component thereof.

The components may comprise wings, hub casing, propeller system, set of supports, stage, platform, battery holder(s), aeration holes, windows, lighting, fasteners, fastener holes, actuators, circuitry, connectors, or battery pack(s). The windows may be for light to shine through, e.g., using any of the lighting disclosed herein such as LED. At least two of the components may have the same symmetry axis and/or plane. At least two of the components may have a different symmetry axis and/or plane. In an example, the wings, the first stage, the second stage, the first support set, the second support set, the electrical connectors, the aeration holes, the hub actuator, the wings actuators, the propeller systems, the battery holders, the battery packs in the AV, the structural aids (e.g., legs), the first hub casing, the second hub casing, and optionally the third hub casing, are each related by a C3 symmetry axis being the central axis of the hub, e.g., when the AV is stationary and/or in at least one flight mode.

FIG. 6 shows in example 600 an AV having wings 602a-c, each of which is coupled with a propeller system of propeller systems 601a-c, respectively. Each of wings 602a-c is coupled with hub 605 through a mount such having a cover, such as cover 607. The mount (and its cover) can rotate about a long axis of the wing, e.g., in the direction of the double arrows depicted on mount cover 607. The wings are disposed symmetrically about the central axis A-A of hub 605. A camera 606 is mounted to one side of hub 605, which can be the bottom side of the AV facing the ground. The top side of the AV opposing the camera side comprises three battery packs having a horizontal section in the XY plane having a petal shape such as 603. The battery packs are arranged symmetrically about central axis A-A. Each of the battery packs is secured to the body of hub 605 by two fasteners such as 604.

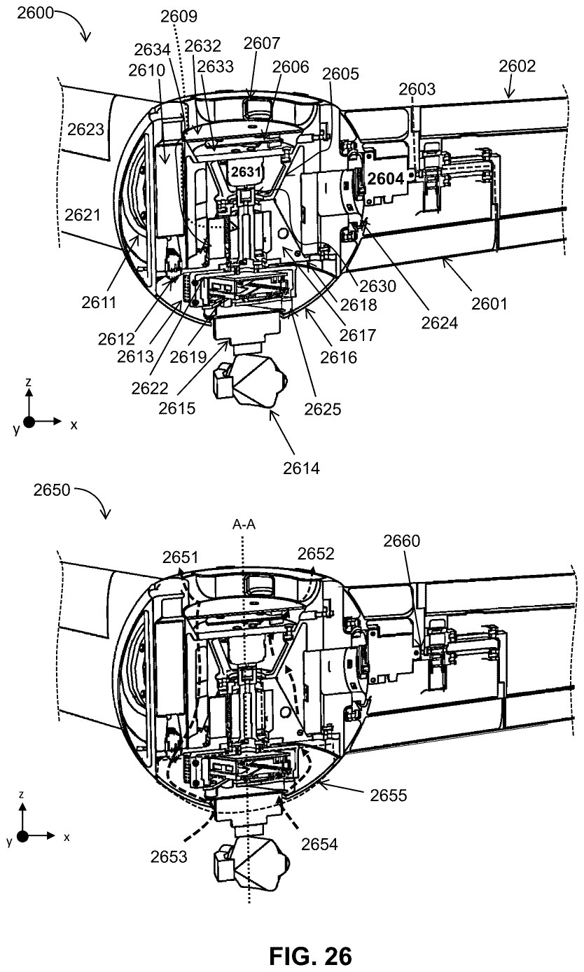

In some embodiments, the AV comprises one or more actuators. The actuator(s) may comprise motors, or engines. The motor(s) may comprise servomotor(s). The actuator disposed in the wing (e.g., servomotor). The actuator may comprise an arm, e.g., servo arm. The arm may be disposed at the end of the actuator, e.g., FIGS. 26, 2660. The arm may transmit torque between the wing and the hub. The arm may be free to slide axially. Transferring axial loads into the actuator may damage the actuator, e.g., during use of the AV. The axial slide of the arm may reduce the probability that axial loads are transferred into the actuator, e.g., prevent their transfer to the actuator.

In some embodiments, actuators are configured to actuate various components of the AV, e.g., during flight and/or testing. One or more actuators may be disposed in the hub, in the wing(s), in the propeller system(s), or any combination thereof. When the hub comprises a first portion and a second portion (e.g., turret), the one or more actuators may be disposed in the first hub portion and/or in the second hub portion. The actuator(s) may cause movement of one or more components of the AV. The movement may comprise translation or rotation. The actuator(s) may cause rotation of the first hub portion with respect to the second hub portion. The actuator(s) may cause rotation of the wing with respect to the hub (e.g., first hub portion and/or second hub portion). The actuator(s) may cause rotation of the wing about its long axis. The actuator may cause rotation of the propeller(s). The actuator(s) may comprise a motor, an engine, or a gear. In some embodiments, the motor is devoid of a gear, e.g., devoid of a gear external to a servomotor. The motor, engine, or gear may be any of the ones disclosed herein. At least two of the actuators may operate in concert. At least two actuators may operate independently of each other. At least two actuators may operate in parallel, or sequentially. At least two of the actuators may operate in a manner unrelated to each other. The Actuator(s) may be operatively coupled with a control system, e.g., as disclosed herein. For example, the actuator(s) may cause concerted action of the wings, e.g., alter their angle of attack, or their rotation relative to the central axis of the hub. In an example, one wing is actuated differently than the two other wings. In an example, a first hub portion is actuated to rotate with respect to the second hub portion. In an example, the propellers are actuated to rotate in the same matter. The actuator(s) may be powered by a power source, e.g., as disclosed herein. The power source may comprise a renewable or a non-renewable power source. The power source may comprise batteries. One actuator may be configured to actuate two or more components of the AV, e.g., three components of the AV. One actuator may be configured to actuate one component of the AV.

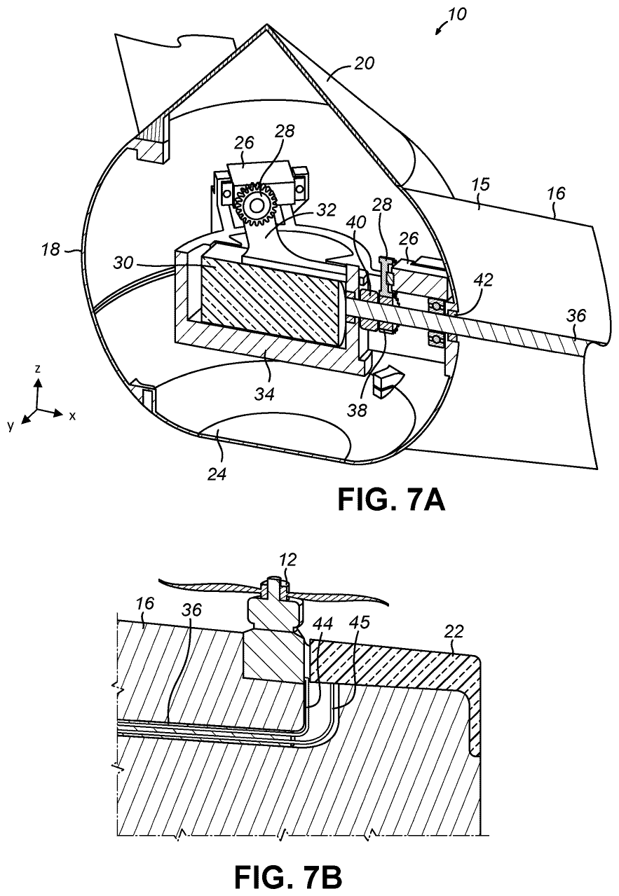

FIGS. 7A and 7B show example details of various internal components of a vortex drone 10. Center hub 18 includes the top hub cap 20 discussed herein (e.g., above), and a bottom hub cap 24. Bottom hub cap 24 can be (e.g., also) utilized to protect the internal components found within the center hub 18. Within the center hub 18 (also referred to herein as the “hub”) is an actuator system. In one or more embodiments, the actuator system includes (A) motors such as servo motors, e.g., three servos such as 26 and (B) gears such as three servo gears, e.g., gear 28 that (e.g., each motor-gear pair) operate to independently control the angle of attachment of each of the wings such as wing 16, to center hub 18, and to operate and independently control each propeller system 12 located at the end of each wing 16 by transmitting torque as needed. In one or more embodiments, the propeller systems 12 include both a propeller and a thrust motor. In one or more embodiments, the number of servos such as 26 and servo gears such as 28 can coincide with the number of propeller systems such as 12 that are located on vortex drone 10. The servos such as 26 and servo gears such as 28 are powered by a power source, such as one or more batteries, e.g., 30. The one or more batteries such as 30 may be held in place by a battery holder, e.g., 32. In one or more embodiments, a flight management unit (FMU) (not shown) comprising a plurality of electronic systems needed to control the battery 30, servos 26, and servo gears 28 are mounted underneath the battery 30. FIG. 7A is shown relative to a Cartesian coordinate system.

While the Cartesian coordinate systems disclosed herein shows axes X, Y, and Z, each pointing in a spatial direction, any of these axes may point to an opposite direction along the direction of the subject axis, as applicable.

In some embodiments, the AV comprises controller(s) configured to control one or more components of the AV, e.g., in real time during its use. In some embodiments, the AV is configured for navigation during flight. The AV may comprise one or more components configured to aid such navigation. The navigation system(s) may comprise a communication air unit transceiver. The navigation system(s) may comprise a sensor and/or a controller. The navigation system(s) may comprise a GPS, very high frequency omnidirectional range (VOR) navigation system, or defense mapping agency (DMA) navigation system. In an example, the controller comprises an FMU. The one or more navigation systems may be configured to provide information about the position, orientation, velocity, and/or acceleration, of AV as a function of time, e.g., during its operation. The operation may comprise flight, testing, or maintenance. The AV may comprise a portion of a communication system, e.g., to communicate between the AV and control system(s) disposed remotely from the AV such as during its operation. The communication system may be configured for radio frequency and/or broadband communication. The communication system may be configured for real-time communication, e.g., during operation of the AV. The communication system may be ay of the ones disclosed herein. The communication system may comprise a communication card, e.g., disposed in the AV. The communication system may comprise a transceiver such as a radio transceiver. The communication system may comprise a datalink system, e.g., to transmit data collected by sensors and/or detectors of the AV. The communication system may be configured for flight telemetry data communication. The communication system may be configured to communicate payload and/or other metrological data. The FMU may control (e.g., direct) the AV in real time during flight, e.g., based at least in part on sensor data, remote input, and/or pilot input. The remote input may comprise any control input disclosed herein, e.g., user input, data table, historic measurements, third party data, simulation (e.g., AI), or any combination thereof. The FMU may control, or assist in controlling, other component(s) of the AV. The other component(s) may comprise an actuator, circuitry, or lighting. The FMU may receive inputs (e.g., signals) from components of the AV related to the movement of various elements of the AV, the elements comprising: a sensor, an actuator, or an encoder. The FMU may receive input from a navigation system such as any disclosed herein, e.g., GPS. The FMU may receive a flight plan and/or target input, e.g., from a source remote from the AV. The flight plan data may comprise standard instrument departure (SID) data or standard terminal arrival route (STAR) data. The FMU may optimize flight trajectory and/or manage flight operation of the AV. The FMU may receive environmental input, e.g., from a remote source, from a third party, from a companion processor (e.g., computer) of the AV, and/or from sensors on the AV. The companion processor may be disposed in the hub. The companion processor may comprise processors distributed in various components of the AV, e.g., comprising in the hub, in the wings, or in the propeller systems. The companion processor may be part of, or may be operatively coupled with, the control system. The actuator may comprise the hub actuator, wing actuator, propeller actuator, or any other actuator disclosed herein. In an example, the other component(s) comprises the hub actuator, propeller motors, wing actuator, wing circuitry (e.g., PCB), and wing lighting (e.g., LED). The control may comprise (i) using communication protocols or (ii) using pulse modulation control such as pulse width modulation (PWM). The modulation control may utilize pulse-based modulation, e.g., varying pulse frequency, pulse width, pulse amplitude, and/or intermission width (e.g., time). The modulation control may be configured to modulate the power and/or amplitude delivered to a load, e.g., by altering a percentage of the power supply provided to a component and/or by altering a width of the signal pulse provided to a component. The communication protocol may comprise inter integrated circuit (I2C), universal asynchronous receiver transmitter (UART), serial peripheral interface (SPI), or controller area network (CAN). The communication protocol may be optimized for short distances between communicating components, e.g., in the AV. The communication protocol may comprise a serial protocol, a synchronous protocol, asynchronous, or any applicable combination thereof. The communication protocol may require (i) a data line in a forward direction, (i) a data line in a backward direction, (ii) a clock line, or (iii) a combination thereof. In some embodiments, the communication protocol is devoid of a clock line. In some embodiments, the communication protocol comprises a clock line. The clock line may be a serial clock line. In some embodiment, the forward and backward communication occupy the same data line. The data line can be a serial data line. The communication protocol may support several (e.g., slave) components on the same bus. The controller may comprise a microcontroller. The communication protocol hardware may reduce cabling. The communication protocol may employ a master-slave hierarchical configuration. The communication protocol may comprise (i) a serial clock, (ii) master out slave in, (iii) master in slave out, or (iv) slave select communication lines, with the component(s) to be controlled being the slave(s). The communication protocol may be configured to communicate between control units, e.g., within a control system. The communication protocol may comprise a message-based communication. The communication protocol may facilitate communication comprising between one master and slaves, between masters and slaves, or between master and one slave. The communication protocol may facilitate real time communication, e.g., during operation of the AV. The communication may facilitate communication between nodes, a node comprising a master or a slave. The communication protocol may allow the node to send and/or receive message(s). The communication protocol may allow prioritization of messages, e.g., by applying different weights and/or aligning in a priority-based hierarchy. The CAN protocol may comprise CANopen or SAE J1939. The communication protocol may be designed for machine automation. The communication protocol may be designed for vehicles, e.g., automotive and/or aviation. The communication protocol may support peer to peer communication. The communication protocol may support broadcast communication.

In some embodiments, the AV (e.g., drone 10) includes a communications air unit receiver (not shown) which may be the source of communication between the AV (e.g., vortex drone 10) and the control system, e.g., comprising a remote control (not shown), utilized to control the AV, e.g., drone 10. Also utilized with the control system may be control schemes, e.g., algorithms.

Further included with the FMU of the AV (e.g., drone 10) are various sensors, including accelerometers, gyroscopes, and GPS, which provide information about the position, orientation, and velocity of AV (e.g., drone 10) at any point in time. The remote control works in conjunction with the FMU to operate the AV (e.g., drone 10). The operator may use the remote control to send commands to the AV (e.g., drone 10), such as instructions to take off, land, move in a certain direction, or adjust its altitude. Alternatively, the AV (e.g., drone 10) can be autonomously controlled where the operator or swarm AI algorithms command the AV (e.g., drone 10) to move from coordinate A to coordinate B, search along a designated flight path or area, return home, or other general commands. In one or more embodiments, the communication link between AV (e.g., drone 10) and the ground control unit may be a wireless radio frequency signal or wireless broadband communication signal via the air unit receiver, which allows for real-time transmission of data between the AV (e.g., drone 10) and the ground control system.

In some embodiments, the AV comprises and/or is operatively coupled with, one or more controllers, e.g., as part of a control system. In some embodiments, the system, device, and/or apparatus disclosed herein comprises a control system. The control system may comprise one or more controllers. The control system may comprise, or be operatively coupled with, one or more devices, apparatuses, and/or systems of the mechanism (e.g., system, device or apparatus) disclosed herein, including any component of the device(s), apparatuses(s), and/or system(s). The controller(s) may comprise, or be operatively coupled with, a hierarchical control system. The hierarchical control system may comprise at least two, three, four, or five, control levels. In some embodiments, at least two operations are performed, or directed, by the same controller. In some embodiments, at least two operations are each performed, or directed, by a different controller. A control system may comprise an AV control system. A control system may comprise a laser control system. The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. A metrological control system may comprise one or more sensors, e.g., as disclosed herein. The control system may comprise, or be operatively coupled with, a metrological detection system and configured to receive measurement data from the metrological detection system. The control system may be configured to generate control signals responsive to the measurement data collected by the metrological detection system. The control system may comprise a processor (e.g., a computer), e.g., as disclosed herein.

In some embodiments, the systems, apparatuses, devices, and/or components thereof disclosed herein comprise one or more controllers. The one or more controllers can comprise one or more central processing unit (CPU), input/output (I/O) and/or communications module. The CPU can comprise electronic circuitry that carries out instructions of a computer program by performing arithmetic, logic, control and I/O operations specified by the instructions. The controller can comprise a suitable software (e.g., operating system). The control system may optionally include a feedback control loop and/or feed-forward control loop. The controllers may be shared between one or more systems or apparatuses. Each apparatus or system may have its own controller. Two or more systems and/or its components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers.

The controller may receive multiple inputs. The controller may generate multiple outputs. The controller system may comprise a single input single output controller (SISO) or a multiple input multiple output controller (MIMO). The controller may interpret the input signal received, e.g., from the sensor(s). The controller may acquire data from one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof.

The outputs may include a display (e.g., screen), speaker, or printer. The control system may comprise one or more controllers disposed in the AV, and/or one or more controllers disposed externally (e.g., and at a distance) from the AV. The control system may comprise a stationary controller or a mobile controller, e.g., a handheld controller. The control system may comprise controller(s) disposed in a facility and/or outside of a facility. The control system may comprise a control scheme and/or a computational scheme. In an example, the control scheme includes the computational scheme. The control system may be operatively coupled with a computational scheme, e.g., disposed externally to the control system such as in the cloud. In some embodiments, at least a portion of the control system resides in the cloud. The computational scheme may comprise fuzzy-logic, genetic fuzzy-logic, or other AI computational schemes, e.g., algorithms. The AI may comprise ML. The AI (e.g., ML) may be used in object recognition. The fuzzy-logic and/or genetic fuzzy-logic computational schemes may be used to identify obstacles, identify other aircraft or other forms of danger, plot a safe trajectory to the target destination, or any combination thereof.

In some embodiments, the control system is configured to anticipate at least one event having a plausible effect on the AV such as an adverse effect, e.g., during its operation.

Anticipating the event may comprise anticipating an external event. The external event may comprise environmental event. The environmental event may compromise the weather, fire, or vegetation such as trees. In an example, the environmental event comprises 50 kilometers per hour (km/h) wind blowing at tall (e.g., high) trees. In an example, the environmental event comprises fire extending on at least about 400 square kilometers. In an example, the environmental event comprises hailstorm, the hail particles having a central tendency (e.g., average) of FLS of at least about 0.5 centimeter. In an example, the environmental event comprises hot weather of at least about 40 degrees Celsius. In an example, the environmental event may comprise a hurricane. In an example, the environmental even may comprise an erupting volcano. The environmental weather event may comprise wind, snow, rain, hail, turbulence, heat, cold, clouds, fog, humidity, gas content, soot, or any other weather event. The environmental event may be benign, moderate, or extreme. The external event may be a manmade event. The manmade event may comprise intervention of other airborne objects in the subject AV's airspace, e.g., other AV, missile, bullets, building, tower, or sensor ballon. The AV may comprise airplane, air-balloon, zeppelin, drone, or missile. The AV may utilize its sensor(s) to sense the event. The control system may output data concerning the event, e.g., to third parties.

Humidity above a threshold may affect the thrust of the actuators (e.g., motors), e.g., affecting the takeoff of the AV. The actuators may be of the propeller system. Ice formation on the propeller may affect the ability of the AV to takeoff and/or fly. Temperature above a threshold may affect the batteries. Environmental events may have an effect on the AV in a similar manner to their effect on currently available aircrafts.

In some embodiments, the computational scheme comprises artificial intelligence. The artificial intelligence (AI) may comprise machine learning (ML) computational scheme(s). In some embodiments, computational scheme comprises a physics model that employs flight characteristics of the AV. The flight characteristics may comprise power consumption, height, speed, acceleration, rotation of wings about the central hub, rotation of a wing about its long axis, rotation of the propeller, power consumption, or rotation of the first hub section with respect to the second hub section. In some embodiments, the method further comprises forming a simulated flight employing the physics model. In some embodiments, the physics model employs an estimated fluid-mechanical change in the ambient environment. In some embodiments, the computational scheme (e.g., AI) comprises performing a data analysis. In some embodiments, the data analysis comprises: linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Harr measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM) technique, deep learning technique, or any combination thereof. In some embodiments, the control system utilizes feed forward and/or open loop control scheme. The control system may utilize historical data, tables, or artificial intelligence (AI) computational scheme such as a learning scheme, e.g., machine learning (ML). The learning scheme may utilize a learning set considering historical data, third party data (e.g., weather data), and synthesized data. The AI may generate the synthesized data. Synthetic data can be generated, e.g., using real-time raw sensor data from historical data, when real-time data becomes or is unavailable.

In some embodiments, the control scheme(s) (e.g., algorithms) used are responsible for processing the data from the sensors (e.g., and from the remote control), such as to determine the appropriate actions for the AV (e.g., drone 10) to take. These control schemes (e.g., algorithms) may (e.g., typically) use a combination of feedback control and feedforward control techniques to maintain stability and achieve requested (e.g., desired) performance. Feedback control involves continuously measuring the current state of the AV (e.g., drone 10) and comparing it to a requested (e.g., desired) state, then adjusting the actions of the AV (e.g., drone 10) to reduce any error between the two states. Feedforward control involves anticipating the effects of external disturbances, such as wind or turbulence, and adjusting the actions of the AV (e.g., drone 10) accordingly to minimize their impact.

In some embodiments, the AV comprises a wing. The wing may comprise a wing shaft. The wing shaft may be operatively coupled with actuator(s). Actuation of the wing shaft may cause the wing to move. The movement may comprise rotation or translation. In an example, the actuation of the wing shaft may cause the wing to rotate, e.g., about its long axis and/or about the wing shaft. In an example, the actuation of the wing shaft may cause the wing to tilt, e.g., with respect to a plane perpendicular to the central axis of the hub. The shaft may be operatively coupled with an actuator, e.g., comprising a motor and/or a gear. The wing shaft may be operatively coupled with the hub by a mount, also referred to herein as the “wing mount.” The mount may comprise bearing or a retaining collar. The bearing may comprise a ball bearing. The shaft may be configured to house wiring, e.g., the wiring traversing through the wing such as from the hub to the propeller and/or lighting. In some embodiments, the wiring traverse through the interior of the wing, and is not housed in the shaft. The wiring may be operatively coupled with the power source (e.g., battery) of the AV, e.g., directly or indirectly. The wing may comprise an outer surface (e.g., cladding). The wing may comprise an inner tube disposed along the long axis of the wing. The wiring of the wing may be disposed in the inner tube. The wiring may couple the actuator(s) of the wing and/or of the propeller, to the power source. The power source may comprise the batteries disposed in the hub, or any other power source of the AV disclosed herein.

In some embodiments, each wing 16 includes a wing shaft 36 is connected to a shaft gear 38. The ends of each wing shaft 36 are mounted on a bearing 40 and a retaining collar 42 may additionally be utilized to secure the position of each wing shaft 36. The wiring 44 that runs from the battery 30 through the speed controller of the propeller system 12 may be routed within the wing shaft 36. In embodiments with a wingtip light 22, wiring 45 for the wingtip light 22 can also be routed within the wing shaft 36. In one or more embodiments, each vortex AV (e.g., drone 10) can also include a ball bearing connection BB, as shown in the example of FIG. 2. The ball bearing connection can be located on both the top hub cap 20 and the bottom hub cap 24, e.g., to allow for a plurality of vortex drones 10 to stack onto one another as discussed above.

In some embodiments, the AV compromises a camera disposed in, or operatively coupled with, the hub. During spinning of the hub, it may be requested to decouple the camera from the spinning hub, e.g., so that the camera may be able to focus on, or towards, a target. The target may comprise a location or a direction. To decouple the camera from the spinning hub, the camera may be disposed in a gimble, or in another portion of the hub that is not occupied with the spinning wings. For example, the hub may comprise a first portion configured to spin the wings, and a second portion (e.g., turret) configured to remain focused on, or towards, the target. The camera may or may not be covered by a casing such as the top hub cap (e.g., nose), or the casing of the third hub portion. The camera may be operatively coupled with the power source of the AV, e.g., batteries. The spinning (e.g., rotation) of at least a portion of the hub about the central axis can be of at least 150 rotations per minutes (RPM), 200 RPM, 240 RPM, 250RPM, 300RPM, 330RPM, 400RPM, 500RPM, 700RPM, 800RPM, 830 RPM, or 850 RPM. The rotation of at least a portion of the hub about the central axis can be between any of the aforementioned values, e.g., from about from about 150 RPM to about 250 RPM, from about 300 RPM to about 400 RPM, from about 500 RPM, to about 850 RPM, or from about 200 RPM to about 850 RPM. The hub may comprise portions spinning at opposite directions. In an example, one hub portion rotates (a) in an opposite direction to another hub portion, and/or (b) at a rate (e.g., substantially) equal to that of the other hub portion. The hub may comprise portions spinning at the same direction. In an example, one hub portion rotates (a) in the same direction to another hub portion, and/or (b) at a rate (e.g., substantially) equal to that of the other hub portion.

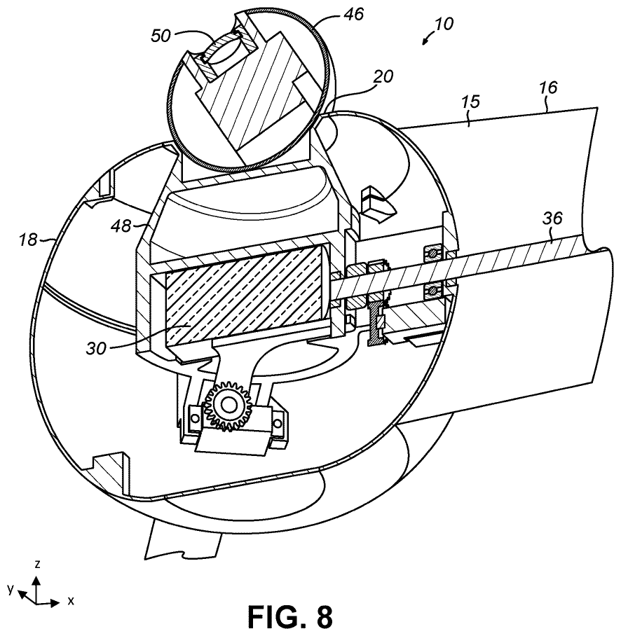

In yet other embodiments, such as shown in the example of FIG. 8, a camera gimbal 46 is mounted on the top hub cap 20. In such an embodiment, the top hub cap 20 may be designed to include a gimbal support 48 which can hold the camera gimbal 46. A camera 50 can then be carried by the camera gimbal 46. Although not shown, if present, the camera gimbal 46 may include additional wiring that can run to the battery 30 to power both the gimbal 46 and the camera 50. In one or more embodiments, if a plurality of vortex drones 10 are going to be in a stacked configuration, the uppermost vortex AV (e.g., drone 10) can include a camera gimbal 46, such as shown in FIG. 2. In some embodiments, the gimbal may be replaced by another (e.g., pivoting) connector.

In some embodiments, the AV is modular. The modular AV can be transported, carried and/or assembled, by an average user. The average user may differ from a field service engineer from an institution manufacturing the AV. The average user may comprise a member of a crew of an activity for which the AV is employed. The average user may comprise a policeman, a firefighter, a soldier, or a movie crew member. The modular AV can be transported, carried and/or assembled in a manner comprising reversibly or repeatedly. The modular AV can be transported, stored, carried and/or assembled, without harm to the AV and/or to its operation. The modular AV can be transported, reliably and/or consistently. The modular AV can be stored, reliably and/or consistently. Components of the AV may be reversibly and/or repeatedly disassembled and re-assembled. The disassembly may be after use, after storage, during transportation. Use may comprise maintenance, flight and/or testing. The assembly may be before use, after storage, and/or after transportation. Storage may comprise disassembled or assembled AV. For example, the wings of the AV may be reversibly disassembled from the hub, and re-assembled, e.g., repeatedly. For example, the power supply (e.g., battery) of the AV may be reversibly disassembled from the hub, and re-assembled, e.g., repeatedly. For example, any covering of the AV (e.g., battery, controller, and/or sensor covering), may be reversibly disassembled from the hub, and re-assembled, e.g., repeatedly. In an example, the AV may comprise a quick exchange joint for the wing shaft into, and out of, the hub. In an example, the disassembled AV is configured to fit in (e.g., standard) container. The container may be a box, crate, or packaging. The container may be a suitcase. The container may be a standard suitcase such as a carry-on airplane luggage, e.g., for ease of transportation. The standard suitcase may comprise a small (e.g., carry-on), medium, large or extra-large suitcase. In some embodiments, various components of the AV are modular. The AV comprises components that allow for ease of maintenance, repair, assembly, testing, and/or disassembly. The components comprise physical components. The components comprise electrical components. The AV may be configured to allow a quick swap of electronics, e.g., between airframes. In some embodiments, the second hub portion may allow the swift exchange of electronics, e.g., between airframes. The AV may be configured for ease of access into its various sections. The AV may be configured for ease of maintenance and/or testing. The maintenance may comprise soldering (e.g., electrical assembly), localized electrical testing, and/or troubleshooting. The AV may weigh at most about 4 pounds (lbs.), 5 lbs, 6 lbs, 8 lbs, or 10 lbs. The AV may have a weight between any of the aforementioned weights, e.g., from about 4 lbs. to about 10 lbs. The AV may weight at most about 1 kilogram (Kg), 2 Kg, 3 Kg, 4 Kg, or 5 Kg. The AV may have a weight between any of the aforementioned weights, e.g., from about 1 Kg to about 5 Kg. The assembly of the disassembled AV, e.g., from a suitcase, can take up to 6 minutes (min), 8 min, 10 min or 15 min, e.g., when carried by a user. The average user may differ from a field service engineer from an institution manufacturing the AV. Each of the disassembled components may be assembled beforehand. The previously assembled components that are disassembled (e.g., for transportation and/or storage) may comprise the hub, the wings, the batteries, or the battery packs. The previously assembled components that are disassembled (e.g., for transportation and/or storage) may comprise the hub, the first wing portion, the second wing portion, the batteries, or the battery packs. In an example, the first hub portion and the second hub portion are not disassembled and reassembled by an average user, e.g., for transportation and/or storage. In an example, the hub is not disassembled and reassembled from the camera by an average user, e.g., for transportation and/or storage. The AV can be deployed outdoor and indoor. The AV may be configured to operate at ambient conditions of an environment external to the AV. The environment can be a natural environment. The ambient conditions may comprise standard temperature, humidity, gas content, and pressure.

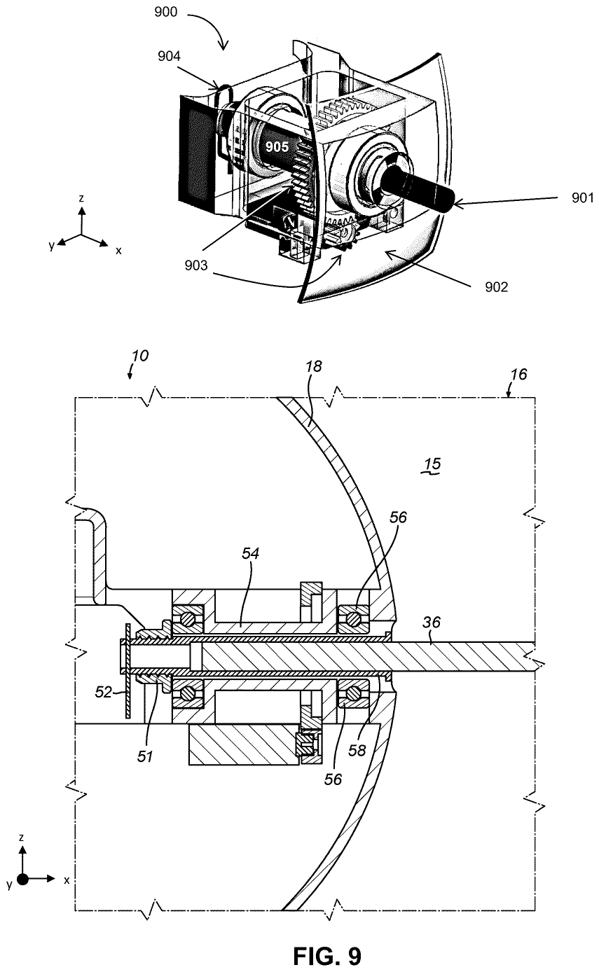

In one or more embodiments, each wing 16 of the vortex AV (e.g., drone 10) is secured to the center hub 18 with a quick exchange joint, as shown in detail in the example of FIG. 9, shown relative to a Cartesian coordinate system. The quick exchange joint includes a flanged locknut 51 a cotter pin 52, a spacer 54, two bearings 56, and an inner journal shaft 58. The end of the wing shaft 36 can be inserted into the inner journal shaft 58, the locknut 50 can be threaded onto the inner journal shaft 58, and the cotter pin 52 can be inserted as an anti-rotation feature. The quick exchange joint as discussed above allows for the quick insertion of a wing shaft 36 prior to use (e.g., takeoff) e.g., the quick replacement of a wing shaft 36 that has been damaged. Use may comprise flight, testing, and/or maintenance. Being able to utilize a quick exchange joint allows for transportation of an AV (e.g., vortex drone 10) within a much smaller enclosure than if the wings cannot be quickly removed when needing to transport the AV, e.g., vortex drone 10. FIG. 9 shows in example 900 a perspective view of shaft portion 901 emerging from casing 902 that encases a portion of the hub. Gears 903 are configured to turn shaft portion 901, the gears operatively coupled with actuator(s). Cotter pin 904 is operatively coupled with shaft portion 901, housed within spacer 905. Example 900 is shown relative to a Cartesian coordinate system.

In some embodiments, the AV is configured to sense its surroundings, e.g., during use.

Sensing the surrounding may be at least in part by using sensor(s). The sensor(s) may comprise camera, radar, LiDAR, gyroscope, accelerometer, a sensor of a navigation system such as GPS, or a proximity sensor. The sensor(s) may comprise an ultrasonic sensor. For example, the AV may comprise a plurality of proximity sensors. The proximity sensor may comprise a LiDAR or a time-of-flight (ToF) sensor. The sensor may measure the time it takes an optical signal emitted by the sensor to travel back from an obstacle such as an object. The proximity sensor may use a laser radiation, or an electromagnetic radiation that is not exclusively laser radiation, e.g., other electromagnetic radiation such as non-coherent radiation. The range of the proximity sensor (e.g., ToF sensor) may be a short range of at least about 0.5 meters (m), 1 m, 1.5 m, 2 m, 2.5 m, 3 m, or 5 m, or 15 m. The range of the proximity sensor (e.g., LiDAR) a medium range of at least about 5m, 10 m, 25 m, 50 m, 100 m, 200 m, 300 m, 400 m, or 500 m. The range of the proximity sensor (e.g., Radar) is a medium range of at least about 500 m, 1 kilometer (Km), 1.5 Km, 2 Km, 2.5 Km, 5 Km, or 10 Km. The sensor may comprise a barometer, or a flow sensor such as an optical flow sensor.

The flow sensor may be configured to measure movement of drone relative to the terrain. The flow sensor may be different from an air flow sensor. The flow sensor may comprise an optical sensor that tracks the movement of the AV relative to the ground (e.g., terrain), e.g., based on optical signals such as images. The flow sensor may be utilized to control (e.g., maintain) a position of the AV, e.g., in GPS denied environment. The flow sensor may be used to detect (e.g., check against) IMU error, e.g., cumulative IMU error. The control system may be operatively coupled with the sensor(s), e.g., to facilitate location of the AV in space, e.g., relative to a topographical feature and/or a requested target. The control system may utilize 3^{rd} party data to ascertain the location of the AV, e.g., mapping data. The control system may output data concerning the location of the AV in space, e.g., to third parties.

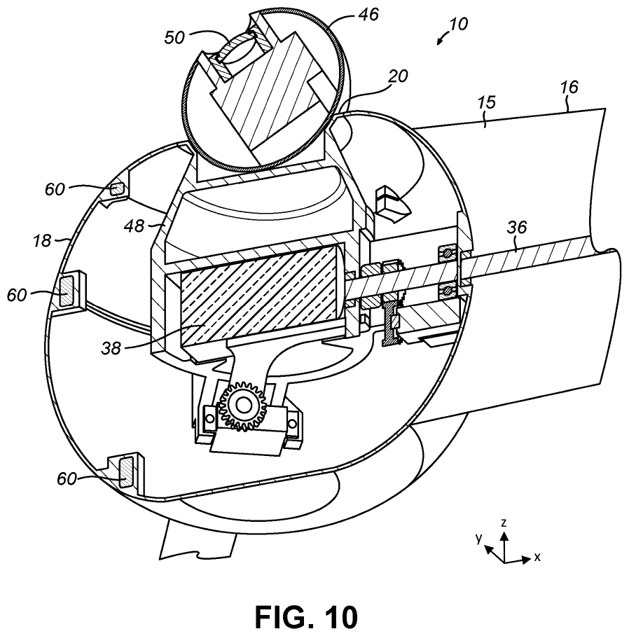

In one or more embodiments, as shown in the example of FIG. 10, the center hub 18 includes a plurality of proximity sensors 60 on the top, side, and bottom of the center hub 18. These proximity sensors 60 give spatial intelligence for the control system to be able to utilize detect and avoid algorithms. The sensors comprise proximity sensors, LiDAR, or ultrasonic sensors. In one or more embodiments, the proximity sensors 60 are selected from the group consisting of LiDAR sensors, ultrasonic sensors, or a combination thereof. FIG. 10 is shown relative to a Cartesian coordinate system.

In some embodiments, the AV is configured to be stacked with AVs of the same type, e.g., for transport and/or use in swarm mode. At least 5, 10, 50, 100, 250, 500, 750, or 1000 AVs of the same type may be stacked together and/or operate together as a swarm of AVs. The stacked AVs may be disposed in an enclosure such as a box. The box may be a cargo box. At least two of the AVs may take off from the enclosure individually. At least two of the AVs may take off together, e.g., collectively. The collective takes off of the AVs may be when they are connected to each other or disconnected from each other. In some embodiments, a portion of the enclosed AVs take off together while another portion of the AVs take off individually. In some embodiments, all the enclosed AVs take off together. In some embodiments, all the AVs take off individually from the enclosure. When the AVs take off collectively from the enclosure, at least two of the AVs may be connected to each other. When the AVs take off collectively from the enclosure, at least two of the AVs may be disconnected from each other. When the AVs take off collectively from the enclosure, at least two of the AVs may be connected to each other and at least two of the AVs may be disconnected from each other. When fully assembled, about 10 AVs may be enclosed in at most about 35 cubic feet (ft³), 40 ft³, 50 ft³, 54 ft³, 60 ft³, or 70 ft³ . When fully assembled, about 10 AVs may be enclosed in at most about 0.9 cubic meters (m³), 1 m³, 1.3 m³, 1.5 m³, 1.7 m³, 1.9 m³, or 2 m³. As an example, 10 AVs are enclosed in 3 feet (′) by 3′ by 6′ enclosure, or in about 0.9 meters (m) by 0.9 m by 1.8 m. When fully assembled, about 10 AVs may be enclosed in a space between any of the aforementioned space values, e.g., from about 0.9 m³ to about 2 m³ . When fully assembled, about 1000 AVs may occupy an area of at most about 700 square feet (ft²), 800 ft², 900 ft² or 1000 ft² square feet. When fully assembled, about 1000 AVs may occupy an area of at most about 65 meters square (m²), 74 m², 83 m², or 92 m² . When fully assembled, about 1000 AVs may occupy an area between the aforementioned areas, e.g., from about 65 m² to about 92 m². At least two AVs in the swarm mode may take off sequentially, or in parallel. At least wo AVs in the swarm mode may take off in concert. Closely stacking the AVs may reduce their occupancy FLS, and/or the horizontal area occupancy, by at least about 2*, 5*, 10*, 50*, or 100*, as compared to their non stacking. Closely stacking the AVs may reduce their occupancy FLS, and/or the horizontal area occupancy, by at least about 2*, 5*, 10*, 50*, or 100*, as compared to their non stacking. The symbol “*” designates the mathematical operation “times.” The control system controlling the swarm of AVs may utilize AI (e.g., ML). The AVs (e.g., in swarm mode) may be rapidly deployed. The AVs may be modular and/or multimodal AVs.

The AV (e.g., UAV) occupies a space. The space may have a height perpendicular to an area having a FLS. The FLS of the area may be at least about 50 mm, 100 mm, 200 mm, 300 mm, or 500 mm. The FLS of the area may be of any of the aforementioned values, e.g., from about 50 mm to about 500 mm, or from about 100 mm to about 300 mm. The center of gravity of the AV may be along the central axis of the hub. The center of gravity may vary and depend at least in part on the size, position, or type, of the batteries.

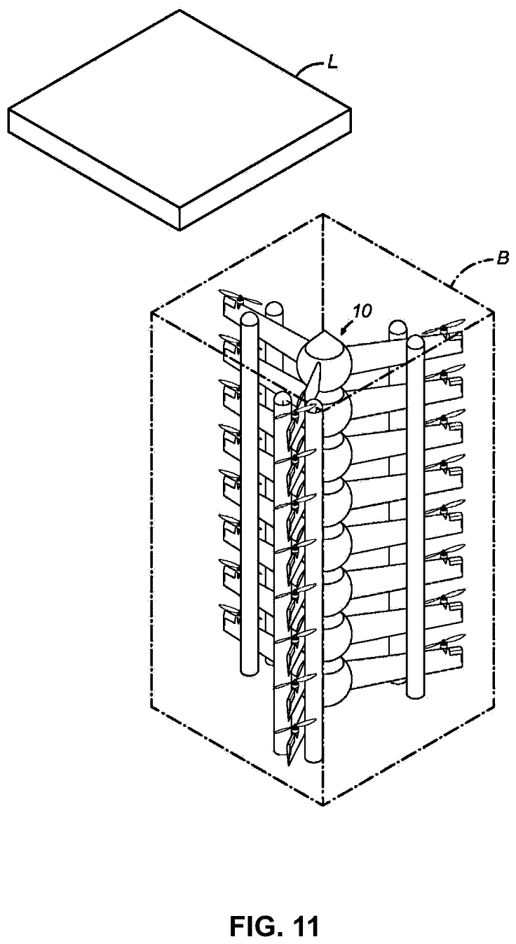

In some embodiments, the lid L of the cargo box B can be removed and the plurality of drones 10 can take off, e.g., in V-MOD (tri-copter mode) individually or attached to one another. In one or more embodiments, the drones 10 launch in sequential order once the lid has been removed. Current requests from the military for drone technology require a massive takeoff area. Having a stackable deployment method, such as shown in the example of FIG. 11, changes the takeoff area for 100 drones from about an area of a football field to about an area of a flatbed truck, which may be advantageous for a plurality of reasons.

In one or more embodiments, as shown in the example of FIG. 11, a plurality of AVs (e.g., vortex drones 10) can be stacked together and shipped to a designated area in a cargo box B.

The lid L of the cargo box B can be removed and the plurality of drones 10 can take off, e.g., in V-MOD (tri-copter mode) individually or attached to one another. In one or more embodiments, the drones 10 launch in sequential order once the lid has been removed. Current requests from the military for drone technology require a massive takeoff area. Having a stackable deployment method, such as shown in the example of FIG. 11, changes the takeoff area for 100 drones from a football field to a flatbed truck, which may be advantageous for a plurality of reasons.

In some embodiments, the AV comprises a hub. The hub may occupy a spherical shape such as a ball. The spherical shape may be truncated. For example, the spherical shape may be truncated at its camera facing side, at a side opposing to the camera, at the wing mount, or any combination thereof. The mounting of the wing to the hub may comprise a cover that is flush with the spherical shape of the hub, e.g., if it would not be truncated in that area. In some embodiments, the propeller is disposed at the tip of the wing. In some embodiments, the propeller is part of an assembly comprising its actuator and/or wing lighting. The lighting may be disposed in a container, e.g., having a cover that is at least partially transparent to the light. There may be a plurality of lighting types disposed at, or operatively coupled with, the wing, e.g., at its tip or adjacent to its tip such as disclosed herein. A propeller system may be operatively coupled with, or be part of, the wing. The propeller system may comprise the propeller, any fastener of the propeller, actuator, wiring, sensor, controller, lighting, or wingtip container. The different lighting may comprise different lighting types. The types of lighting can be of any type disclosed herein.

The different lighting types may differ in wavelength, mode of operation, strength (e.g., power), or any combination thereof. At least two of the lighting types on a wing may be of diverse types. At least two of the lighting on a wing can be (e.g., substantially) of the same type. In some embodiments, the AV comprises at least one propeller operatively coupled with a wing. The propeller can be actuated by an actuator, e.g., a servomotor. The propeller can be part of a propeller system, e.g., as disclosed herein. The motor of the propeller may be integrated with a controller or be operatively coupled with the controller, e.g., as part of the control system. The propeller may rotate clockwise and/or anti clockwise, e.g., interchangeably, reversibly, or any combination thereof. The propeller may be operatively coupled (e.g., electrically connected) to the central hub power supply, e.g., batteries.

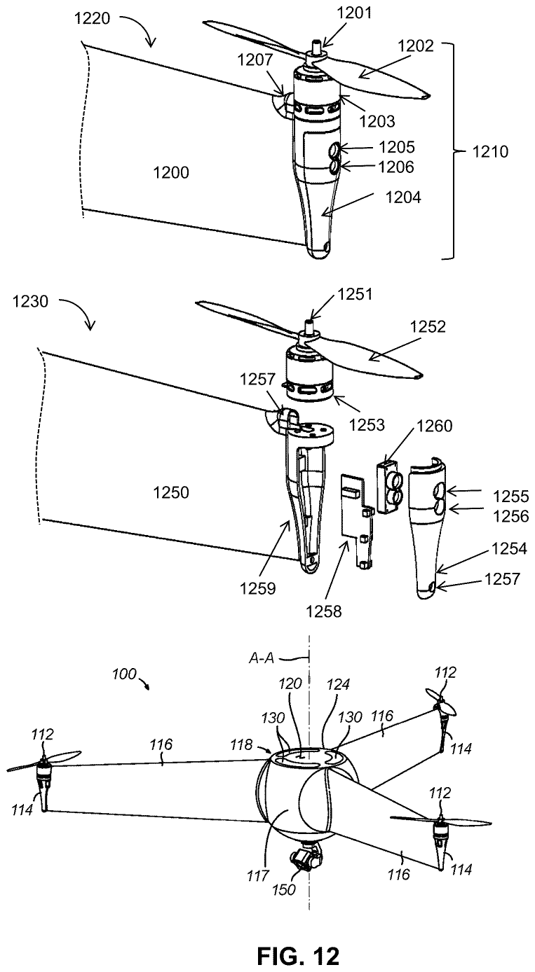

FIG. 12 shows in example 1200 a perspective view of wing portion 1200 comprising propeller 1202 secured by fastener 1201, e.g., pin or screw. Propeller 1202 is operatively coupled with actuator 1203 configured to actuate it during use. The propeller 1202 is part of a propeller system 1210 disposed at the tip of wing portion 1200. The propeller system comprises fastener 1201, actuator 1203, wingtip container 1204 with cap, first sensor 1205, and second sensor 1206. Wingtip container 1204 may house circuitry, e.g., PCB. The sensors can be proximity sensors, or any other sensor disclosed herein, as appropriate. The different lighting (also herein “light”) may comprise colored light (e.g., red and green light), or white light. The lighting type can be any lighting type disclosed herein. Wing portion 1200 comprises an extrusion 1207, e.g., to allow placement of wiring in the wing body. The wiring (not shown) can be coupled with the lighting and/or encoder of the propeller system. In some embodiments, the wing of the AV is devoid of extrusion such as 1207—disposed adjacent to propeller system 1210. The wingtip container cover can be referred to as a “wingtip cap.”

FIG. 12 shows in example 1230 a perspective view of 1220 with propeller system 1210 in an exploded view. Wing portion 1250 comprises propeller 1252 (e.g., propeller wing) secured by fastener 1251, e.g., pin or screw. Propeller 1252 is operatively coupled with actuator 1253 configured to actuate the propeller during use, e.g., to spin over a vertical axis going through fastener 1251. The propeller 1252 is part of a propeller system disposed at the tip of wing portion 1250. The propeller system comprises fastener 1251, actuator 1253 (e.g., servomotor), wingtip container cap 1254, first hole 1255, and second hole 1256. The wingtip container cap may be fully or partially transparent to the light emitted by the lighting. Wingtip container body 1259 is coupled with the tip of wing 1250 and is configured to engage with wingtip container cap 1254, e.g., when closed by fastener (e.g., screw) engaged with fastener hole 1257. Wingtip container 1259 encloses circuitry disposed on PCB 1258 and sensors 1260. Wing portion 1260 comprises an extrusion 1267, e.g., to allow placement of wiring in the wing body. The wiring (not shown) can be coupled with the lighting and/or encoder of the propeller system. The lighting may comprise LED. In some embodiments, the wing of the AV is devoid of extrusion such as 1257—disposed adjacent to the propeller system.

In some embodiments, the AV utilized at least one power source. The power source may comprise a renewable or a non-renewable power source. The renewable source may comprise solar, or motion. The motion may comprise wind motion. The motion may comprise a breaking motion, e.g., of the AV. The renewable energy source may utilize electromagnetic induction. The renewable energy source may comprise motion harvesting device, e.g., comprising piezoelectric or electromagnetic technology. The power source may comprise one or more batteries. The batteries may be arranged in a battery pack. The battery pack may comprise at least about 2, 3, 5, 6, 8, or 10 batteries. In some embodiments, the battery pack is a five-cell battery pack configured to house five batteries, e.g., five battery cells. The battery pack(s) may be configured to be housed in the hub, e.g., in the first hub portion. The battery housing comprises a socket. The battery pack(s) may be configured to be disposed in the hub and (a) along the casing (e.g., skin) of the hub and/or (b) about the central axis of the hub. The battery pack(s) may be configured to adopt a curved shape along the top truncated face of the hub opposing the camera. The battery pack may have a curved horizontal cross section, and a rectangular vertical cross section such as to accommodate the battery's height. The batteries can be rechargeable or non-rechargeable batteries (also referred to herein as “battery cells”). At least one of the batteries can be rechargeable. At least one of the batteries can be non-rechargeable. The battery pack may be configured to be readily, reliably, and reversibly removable and insertable into the AV, e.g., before or after use of the AV. The batteries may be configured to be readily, reliably, and reversibly removable and insertable into the battery pack, e.g., using an (e.g., ergonomic) depression and fasteners such as any fastener disclosed herein. The depression and fasteners may be disposed close to the top of the battery pack, the fasteners being disposed at opposing side of the battery pack to the depression. The battery pack may be configured to be inserted into a battery holder disposed in the hub, e.g., in the first portion of the hub. The battery holder may have a shape that snuggly fits to accommodate the battery pack when inserted. The battery pack may include a first member of a (e.g., electrical) connector that mates with (e.g., docks to) a second member of the connector disposed in the battery holder to form a male-female type fit, e.g., mating pair. The connector can be any connector disclosed herein as applicable, e.g., for transmission of power and optionally also data. The male-female pairing may occur upon insertion of the battery pack into the battery holder. The battery pack may be secured to the battery holder by a reversibly openable and closeable fastener, e.g., a tab or any other fastener disclosed herein. The battery pack may attach to the battery holder by magnetic and/or mechanical connection. The batteries and/or battery pack may be configured to encircle the center axis of the hub at least in part. The batteries and/or battery pack may be configured to at least in part follow the skin of the hub, e.g., first section of the hub. At least one power supply element (e.g., battery) may be disposed in the first hub portion. At least one power supply element (e.g., battery) may be disposed in the second hub portion. The power supply arrangement may adopt a curved shape at least one of their Cartesian cross sections. The batteries may comprise a lithium-ion, lithium-titane, lithium-ion-phosphate, or lithium-manganese-oxide, battery. The battery may be a high energy density, e.g., as compared to consumer batteries. The energy density may be at least about 100 Watt-hours per kilogram (Wh/Kg), 150 Wh/Kg, 200 Wh/Kg, 250 Wh/Kg, or 300 Wh/Kg. The battery may have an extended shelf life of at least about 5, 8, or 10 years. The battery may be configured to undergo at least 100, 250, 500, 750, or 1000 discharge-recharge cycles, e.g., without undergoing substantial and/or measurable capacity loss. The battery may be configured to lose minimal charge when not utilized, e.g., during storage and/or idle time of the AV. The minimal discharge rate may be at most about 0.5%, 5%, or 10% of its charge per month, e.g., at ambient atmospheric conditions such as temperature. Ambient atmospheric conditions include standard room temperature and pressure, e.g., of 25 °C and pressure of 1 atmosphere. The battery may be configured to have an electrical potential difference of at least about 0.5 Volts (V), 1V, 1.5 v, 2V, 3 v, or 3.5 V. The battery may or may not require scheduled maintenance, e.g., to preserve its life. The battery may have a fast-recharging current rate, e.g., of at least about 0.5 C-rate (C), 0.8C, or 1.0C, with C-rate being the measure of the current at which a battery is charged or discharged relative to its maximum capacity. The battery may or may not be required to be fully discharged before recharging. The power source may comply with Dronecode Foundation standards. The power source may comply with the smart battery standard. The batteries may occupy at least about 15%, 20%, 25%, 30%, or 40% of the AV's mass, e.g., UAV's mass. The batteries may occupy a percentage of the AV's mass between any of the aforementioned percentage values, e.g., from about 15% to about 40%.

In some embodiments, the battery pack has a symmetric structure. The battery pack may have a horizontal cross section comprising a curve, and a vertical cross section devoid of a curve. The battery pack is structured to allow the battery to stand in the battery back such that the height of the battery corresponds to the height of the battery pack. The battery pack is structured to allow the battery to stand in the battery back such that the vertical cross section of the battery corresponds to the vertical cross section of the battery pack. The vertical cross section may comprise the height of the battery pack, e.g., respective to the height of the batteries designated to be enclosed therein. The horizontal cross section may comprise at least one curved side, e.g., two curved sides. The horizontal cross section may comprise at least one arch in a side of a circumferences of the horizontal cross section, e.g., two arches, each on an opposing side of the circumferences of the horizontal cross section. The two arches may be of different lengths. The two arches may or may not have the same radius. The two arches are connected by two opposing sides comprising a curvature or a straight (e.g., non-curved, or linear) line. In one embodiment, the two arches are connected by two opposing sides devoid of a straight line. In one embodiment, the two arches are connected by two opposing sides including a straight line, e.g., and including a curved line. The horizontal cross section may be symmetric, e.g., comprising mirror symmetry. The battery pack may be symmetric, e.g., comprising mirror symmetry in a plane comprising the height of the battery pack. The battery pack may be symmetric across the vertical cross section of the battery pack, e.g., disposed about line splitting each of the longer arch and the shorter arch, into two equal sections. Each of the two arch connecting sides can be reflected into the other along the symmetrical mirroring plane. The battery packs may be disposed in the hub about the central axis of the hub, e.g., to engulf it. The battery holder may snuggly accommodate the battery pack, and thus have a similar shape. The battery pack may comprise a first member of a connector at its (e.g., planar) end that enters first the battery holder, the battery holder having a mating member to the connector configured to mate with the first member of the connector of the battery pack. The connector can be any connector disclosed herein as applicable, e.g., for transmission of power and optionally also data. The connector of the battery holder may be comprised in the second stage of the hub, e.g., first hub portion. The battery holder may have an aeration hole, e.g., adjacent to the connector such as disposed on the second stage. The aeration hole may relieve overpressure when inserting the battery pack to the battery holder and/or relieve underpressure when extracting the battery pack from the battery holder. The battery holder may be formed by contacting the body of the hub (e.g., of the first hub portion) with internal wall(s) of the hub (e.g., first hub position). The battery holder may comprise directing component(s) to direct the battery pack into the battery holder. The directing component(s) may comprise a protrusion, an insertion, a guide, a beveled top surface, a connector (e.g., connecting data and/or electricity), vertical wall(s), or any combination thereof. The guide may comprise an insertion or a protrusion. The battery pack may comprise directing component(s) to direct the battery pack into the battery holder. A directing component of the battery pack may interact (e.g., mate) with a respective directing component of the battery holder. The battery pack may comprise one or more fasteners, e.g., tabs, configured to secure the battery pack to the battery holder. The battery pack may be configured to reversibly, repeatedly and/or reliably open and close, e.g., to allow insertion and extraction of the batteries. The batteries may recharge in the battery pack and/or outside of the battery pack. The batteries may wirelessly charge, e.g., when in the battery pack and/or when outside of the battery pack.

In some embodiments, the AV is configured for continuous flight. The continuous flight may last any maximal flight time disclosed herein. The continuous flight may be devoid of a battery recharge. The continuous flight may comprise battery recharge, e.g., from renewable sources such as renewable sourced disposed at, or operatively coupled with the AV during its operation.

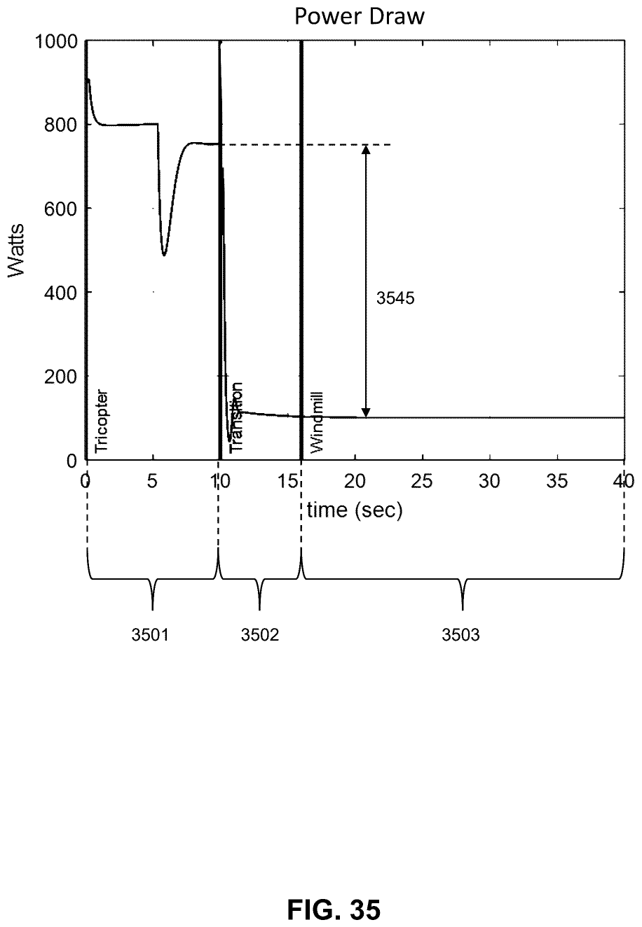

The renewable sources can be solar panels disposed, e.g., on the wings of the AV. In some embodiments, the maximal flight time of the AV in a first flight mode may be longer than the maximal flight time in a second flight mode and/or the maximal flight time in a third flight mode, e.g., long than the maximal flight time in the second mode and of the third mode combined. The maximal flight time in S-MOD may be longer than in V-MOD and/or in C-MOD, e.g., long than the max. flight time of V-MOD and C-MOD combined. The maximal flight time in C-MOD may be longer than in V-MOD. The maximal flight time in one flight mode may be longer than in another flight mode of the AV, e.g., by at least about 2*, 3*, 5* or 10*. The maximal flight time in S-MOD may be longer than in V-MOD by at least about 2*, 3*, 5* or 10*, with the symbol “*” designating the mathematical operation “times.” The maximum flight time of the AV in C-MOD can be at least about 0.5 hours (h), 1 h, 1.5 h, 2 h, or 3 h. The maximum flight time of the AV in V-MOD can be at least about 0.1 h, 0.3 h, 0.5 h, 1 h, or 1.5 h. The maximum flight time of the AV in S-MOD can be at least about 1.5 h, 2 h, 3 h, or 5 h hours. The flight of the AV in one flight mode may require less power than in another flight mode. Less power may be less by at least about 30%, 40%, 50%, 80%, 85%, 90%, or 95%. In an example, flight of the AV in S-MOD requires 85% less power than when the AV flies in V-MOD, e.g., see FIG. 35. The AV, when Unmanned (e.g., UAV), may have an increased time of flight relative to currently available multi-copter UAVs. The increase in flight time of the AV relative to currently available multi-copter UAVs can be by at least about 2*, 3*, 5*, 6*, or 8*. The symbol “*” designates the mathematical operation “times.”

In some embodiments, the AV (e.g., UAV) has a flight range limited by the capability of its devices that communicate to a base, e.g., a user and/or a control system. In an example, a practical maximal range is limited to video streaming capability. In an example, the camera may stream at a range of at most about 1 mile, 5 miles, 10 miles, or 20 miles. The communication system (e.g., comprising a transceiver) may have a maximum range of at most about 12 miles, 15 miles, 30 miles, or 50 miles.

FIG. 12 shows example details of various external components of a vortex AV (e.g., drone 100) of the present disclosure. Vortex AV (e.g., drone 100) may be equipped with one or more propeller systems 112 located adjacent to an end (e.g., tip) 114 of each wing 116 of vortex AV (e.g., drone 100), e.g., at the tip of the wing or adjacent thereto. Each wing 116 may be secured to a center hub 118. AV (e.g., vortex drone 100) further includes a plurality of battery packs 130 that slide vertically into an upper (e.g., truncated) surface 120 of the center hub 118. Once the battery packs 130 are in place, they may also provide a form of protection for additional internal components found within the center hub 118. In one or more embodiments, there are three battery packs 130 wherein each battery pack 130 contains 2 to 10 individual battery cells. In one or more embodiments, each battery back 130 contains 5 individual battery cells. In yet other embodiments, each battery back contains 6 individual battery cells.

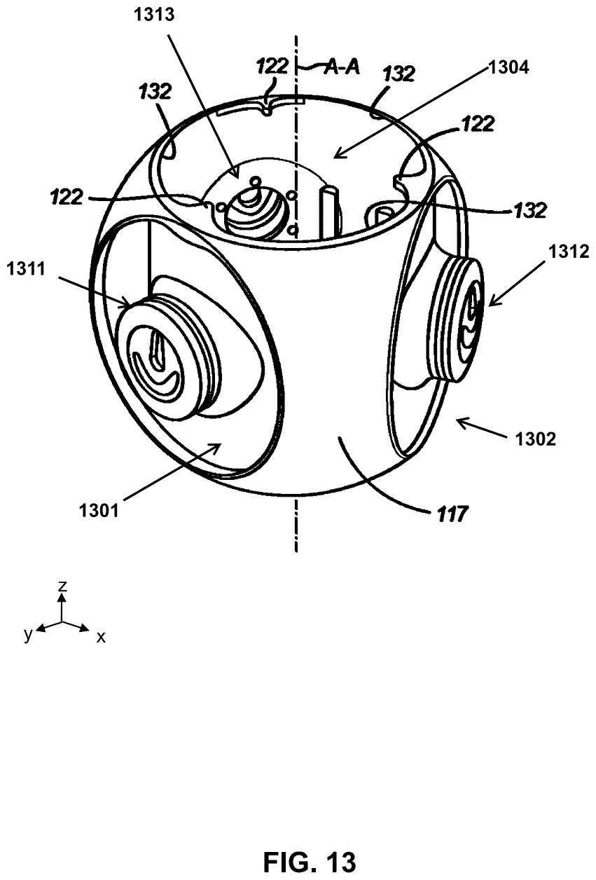

As can be seen in the example of FIG. 13, beveled edges 122 of upper surface 120 of the center hub 118 (e.g., at the truncated top face) may form a portion of battery holder 132 that may allow for the battery packs 130 to (e.g., snuggly) fit with ease within main body 118. The center hub may be the first portion of the hub. In another embodiment, the battery holder may fit and/or connect to section 132 configured to guide the battery pack into the battery holder coupled with section 132. Section 132 may be part of the body of the hub or may be attached to the body of the hub, e.g., to the body of the first section of the hub. FIG. 13 is shown relative to a Cartesian coordinate system. FIG. 13 shows an example of hub 117 having the shape of a truncated ball, with truncations 1301 and 1302 housing wing mounts 1311 and 1312, respectively. A third truncation corresponding to wing mount 1313 is not visible. Hub 117 comprises a truncated top 1304. Hub 117 comprises a central axis A-A.

In some embodiments, the hub of the AV comprises several portions, e.g., that move with respect to each other. The movement may comprise rotation, e.g., about the central axis of the hub. The center of mass and/or the aerodynamic center of the AV may be disposed along the central axis, e.g., in the center of the hub. For example, a first portion of the hub may rotate with respect to a second portion (e.g., turret) of the hub. The first portion may comprise a body. The body may comprise a casing, or skin exposed to the external environment to the hub. The first portion of the hub may comprise a navigation system, an encoder, an actuator, a coupler to the second portion of the hub, wing mounts, power supply, or circuitry. In an example, the hub (e.g., first portion and/or the second portion of the hub) may comprise one or more encoders. The navigation system may comprise any navigation system disclosed herein, e.g., GPS. The navigation system may utilize computational scheme(s), e.g., AI such as ML. The navigation system may be based at least in part (A) on input from sensor(s) (B) historical data, (C) 3^{rd} party data, and/or (D) predictions such as from the AI. The sensors may be the AV sensors. The 3^{rd} party data may comprise weather forecasts, topographical maps, or any other 3^{rd} party data disclosed herein. The computational schemes may comprise simulations, e.g., physics simulations such as dynamic flow simulations and/or other aerodynamic related simulations. The encoder may be configured to convert motion to electrical signals. The encoder may provide feedback to a control system of the AV, e.g., the FMU. The encoder may detect the position, speed, and/or direction. The encoder may be operatively coupled with the control system. The encoder may utilize optics, magnetics, or mechanics (e.g., resistance). The encoder may be an incremental encoder, or an absolute encoder. The encoder may report the angular velocity. The encoder(s) may comprise rotary encoder, magnetic encoder, optical encoder, inductive encoder, capacitive encoder, or resolvers. In an example, the encoder(s) comprise a rotary encoder. The encoder may report angular position. The encoder may report angular velocity. In an example, the encoder is a rotary encoder reporting angular position and angular velocity between the first portion of the hub and the 2^{nd} portion of the hub, e.g., as an input for the control system. The rotary encoder may measure rotation accurately and/or reliably, e.g., during use of the AV. The rotary encoder may measure the angle at an accuracy of at least about 0.5 degrees (°), 0.25°, 0.2°, or 0.15° or higher. The rotary encoder may require calibration after at least about 500 hours (h), 1000 h, or 5000 h of AV flight. The encoder may be operatively coupled with an inertial measurement unit (IMU). The IMU may be disposed in the first hub portion or in the second hub portion. Inputs from the encoder may be received by the control system, e.g., comprising an FMU. Inputs by the IMU may be received by the control system. The IMU may be any IMU disclosed herein. The actuator may comprise a motor, or an engine. The hub (e.g., first portion and/or second portion) may comprise one or more actuators. The motor may be a single axis motor. The motor may be affixed to the casing, e.g., of the first hub portion. The motor may be disposed in the first hub portion above the platform and away from the camera. The motor may be disposed along the central axis of the hub. The motor may cause the first portion of the hub to rotate relative to the second portion of the hub. The motor may rotate about the central axis of the hub. The motor may receive input from one or more sensors, e.g., directly and/or through the control system. The motor may be operatively coupled with the control system and/or comprise an integrated controller. The coupler to the second portion of the hub may comprise torque coupling. The coupler may comprise an axial float. In an example, the coupler is configured to couple to an axial float that extends from the second hub portion into the space of the first hub portion. The axial float may allow the shaft to move back and forth along its axis of rotation. The axial float may allow thermal expansion and contraction of the shaft during use. The axial float may at least in part prevent excessive thrust on the bearing operatively coupled with the slip ring mechanism. The axial float may reduce vibrations, e.g., associated with the hub's actuator and/or with the slip ring mechanism. The coupler may be configured to connect the first hub portion with the second hub portion, e.g., during operation of the AV, e.g., to transmit electricity and/or data. The coupler may comprise a slip ring. The coupler may comprise a stator. For example, the stator may be operatively coupled, e.g., connected, to the body of the first hub portion. The coupler may comprise an electromechanical device. The coupler may allow the transmission of power and data (e.g., signal) from the first portion of the hub to the second portion of the hub. The coupler may comprise a component and a rotating component. In some embodiments, the stationary component is disposed in the first hub section, and the rotating component is disposed in the second hub section. In some embodiments, the rotating component is disposed in the first hub section, and the stationary component is disposed in the second hub section. The coupler may comprise a ring, a coil, a brush, electricity transmitting liquid, magnet, or wiring. The ring may be an electrically conductive circular component disposed about the central axis of the coupler, e.g., about the rotating component. The coupler may comprise a series of rings/coils, e.g., closely situated separate from each other. Passing electrical current through the rings/coils may generate a changing magnetic field, e.g., that may induce current in the adjacent ring/coil. The brush may be a stationary contact forming electrical connection with the rotating component. The electricity transmitting liquid may comprise liquid metal, e.g., mercury. The slip ring connector may comprise a brush-type, mercury wetted, or wireless, slip ring connector. The coupler may be configured to transmit power and signals between stationary and rotating components, e.g., without, or with minimal, physical connection between its stationary and rotating components. The minimal physical contact may be sufficient to transmit electrical current. The minimal physical contact may not affect the hub-actuator, e.g., in a substantial and/or measurable way. The minimal physical contact may not affect the rotation of the first hub portion with respect to the second hub portion, e.g., in a substantial and/or measurable way. The coupler may utilize inductive coupling. The coupler may be devoid of a brush type connection. The coupler may utilize electromagnetic induction. The wiring may connect the ring and/or brush to a power source, e.g., electrical power source. The coupler may enable continuous rotation while maintaining electrical (e.g., and data) connectivity. In some embodiments, the number of wing mounts disposed, or operatively coupled, with the first hub body, corresponds to the number of wings of the AV, respectively. The wing mount may allow reversible back and forth rotation, e.g., accurately and/or repeatedly. The rotation may be a full circle rotation, e.g., 360° rotation. The rotation may be controlled, e.g., by the control system. The rotation of the wing may be actuated by actuator(s) disposed in the wing and/or by actuator(s) disposed in the hub. In an example, the rotation of the wing is actuated by actuator(s) disposed in the wing. The rotation of the wing may be about the long axis of the wing. The rotation of the wing about its long axis may be controlled by the control system. In some embodiments, the hub actuator actuates rotation of the hub (e.g., 1^{st} hub portion of the hub) about the main axis of the hub, and the actuator of the wing actuates rotation of the wing about the long axis of the wing. The hub actuator may comprise a single axis motor. The rotation of the wing about its long axis can be during rotation of the hub, e.g., during rotation of the first portion of the hub. The rotation of the wing about its long axis can be in concert with, or irrespective of, the rotation of the hub, e.g., from the rotation of the first portion of the hub. The power supply may comprise batteries, e.g., as disclosed herein. The power supply may comprise renewable or non-renewable sources. The power supply may be rechargeable.

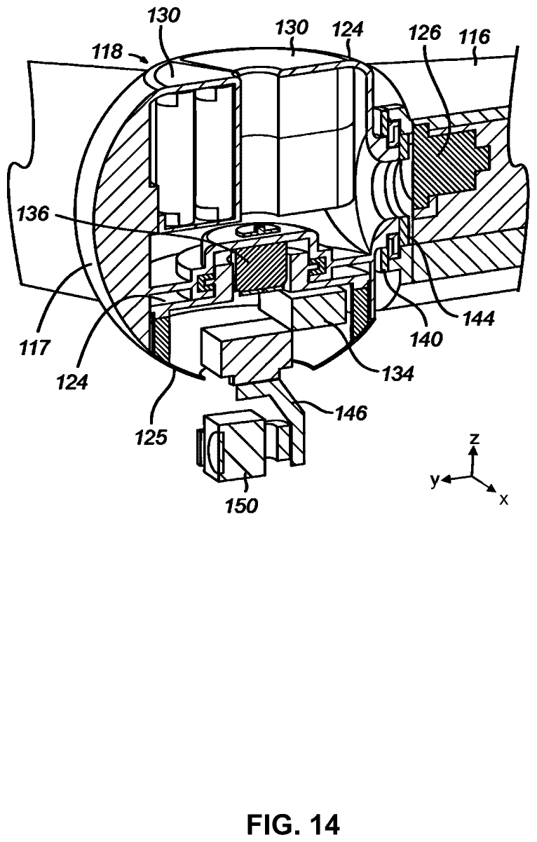

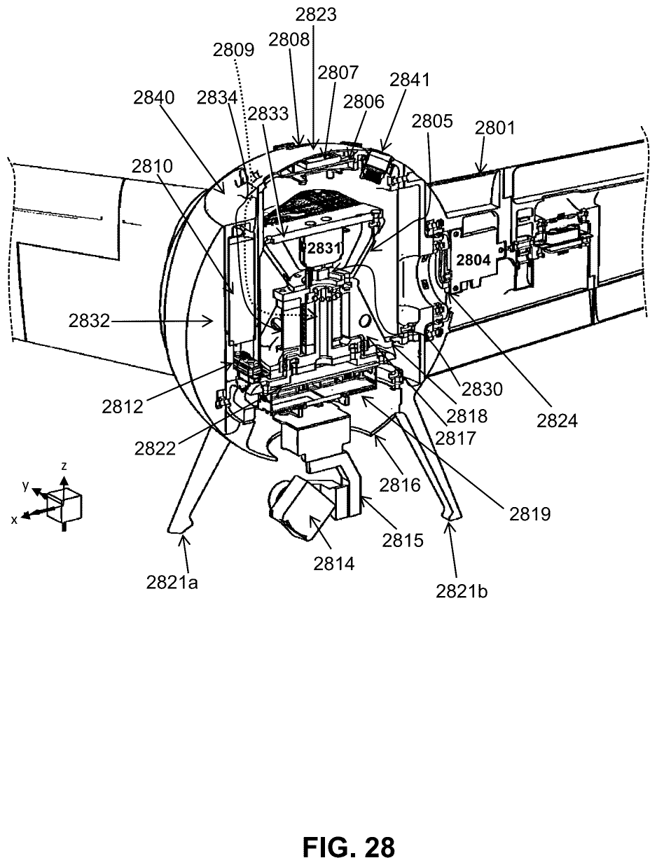

In some embodiments, the hub of the AV comprises several portions, e.g., that move with respect to each other. The movement may comprise rotation, e.g., about the central axis of the hub. The second hub portion may comprise, or be operatively coupled with, sensor(s), gimble, platform, second hub portion casing, connector to the first hub portion, encoder, IMU, controller (e.g., FMU), communication system (e.g., comprising a radio transceiver), wiring, other circuitry, or structural aid, e.g., comprising a strut, a support, or a leg. The sensor(s) may comprise a camera. The camera may be operatively coupled with the platform and/or to the gimble. In some embodiments, the camera is coupled with the platform by a gimble. The gimble may comprise a pivoted support, e.g., holder. The gimbal may allow rotation of an object coupled with it, e.g., a gimbal connected to a camera allows rotation of the camera. The rotation may comprise pivot, or partial rotation. The gimbal may or may not comprise rings configured to independently move with respect to one another. The hub casing of the second hub portion may or may not house one or more of the sensors of the second hub. For example, the top hub cap configured to cover the camera is present in some embodiments, and absent in others. A shape of the top hub cap may be pointed (e.g., FIG. 1C) or curved (e.g., FIG. 28). The top hub cap may be the casing of the third hub portion. The casing of the second hub portion may continue the spherical shape of the first hub portion at least in part (e.g., FIG. 14), or deviate from it. The casing of the second hub portion may comprise an aperture, e.g., through which the camera emerges, such as in FIG. 14, shown relative to a Cartesian coordinate system. The casing of the second hub portion may be also referred to herein as “bottom hub cap.” The platform may be a rotatable platform, e.g., about the central hub axis. The coupler may be the same type of coupler as disclosed herein in the context of the first hub portion, e.g., a slip ring connector. The mobile portion of the coupler may be disposed in the second hub portion, or vice versa. The structural aid of the AV may comprise one or more legs. The legs may be part of, or be operatively coupled with, the casing of the second hub portion. The structural aid may be stationery or mobile. The structural aid may allow the AV to rest on the ground while the camera of the AV points towards the ground and remains suspended above the ground. The structural aid may allow the central axis of the hub to be disposed (e.g., substantially) perpendicularly to the ground, when the AV is not flying, e.g., when it is not operating. The structural aid may balance the AV upon landing and/or takeoff. The structural aid may comprise legs, e.g., at least 2, 3, or more legs. During operation of the AV (e.g., during flight) the structural aid may or may not change its configuration relative to its configuration in the resting position of the AV. The structural aid may fold, retract, or otherwise change its structure relative to the hub, e.g., before, or during, or after operation of the AV. The legs may fold, retract, or otherwise change their structure relative to the hub, e.g., before, during, or after operation of the AV. In an example, the legs of the AV may remain stationary before, after, and during flight of the AV. In an example, the legs of the AV may (a) be extended during rest time of the AV, and (b) folded during flight of the AV. The retracted and/or folded structural aid may be disposed at least in part outside of the hub's casing, e.g., first hub casing and/or second hub casing. The retracted and/or folded structural aid may be disposed at least in part in the hub's casing, e.g., first hub casing and/or second hub casing. The structural balancing aid may or may not change its configuration based at least in part on the mode of flight of the AV. In an example, the legs retract and/or fold during flight in C-MOD. The camera may capture electromagnetic images. The electromagnetic images may comprise visible (VIS), infrared (IR), or ultraviolet (UV) images. In some embodiments, the camera may be a VIS and/or IR camera. The camera may be configured to capture stills and video images. The camera may comprise a video mode or a stationary mode. The camera may comprise an electrooptical camera. The camera may be a high-definition camera such as a 4K camera, e.g., comprising about 3840 by 2160 pixels. The camera may comprise a charge coupled device (CCD) camera. The camera may comprise a Red Green Blue (RGB) type camera. The camera may comprise a zoom camera. The camera may comprise a thermal camera. The camera may be configured to collect data and/or aid in controlling the AV, e.g., during flight. The camera may be configured for image recognition, object tracking, and/or video compression. The camera may be configured to couple with the control system. Images of the camera may be provided as input to the control system. The movement and/or operational mode of the camera may be controlled by the control system. The camera may be configured to rotate, e.g., during operation of the AV. The rotation may be about the central axis of the hub. The rotation of the camera may comprise a pivoting movement. The rotation of the camera may be such that its field of view will not be obstructed by other component(s) of the AV, e.g., the structural balancing aid of the AV such as the legs. The legs may form a tripod. Each of the legs may be angled with respect to a plane perpendicular to the central axis of the hub. The IMU may comprise nine degrees of freedom. The IMU can measure movement in three-dimensional space. The IMU can measure three types of movement across the three Cartesian axes. The IMU can detect translation and rotation along and around the X Y and Z Cartesian axes, e.g., with respect to the central axis of the AV. The IMU can report translation, rotation, acceleration and/or angular velocity of the AV, e.g., to the control system. The IMU can report translation, rotation, acceleration and/or angular velocity in the AV, e.g., of the first hub portion with respect to the second hub portion. In some embodiments, the IMU measures translation, rotation, acceleration and/or angular velocity, of the first hub portion with respect to the second hub portion. The IMU may measure (e.g., and report) the magnetic field. The IMU may measure magnetic field and provide orientation data relative to Earth's magnetic field. The IMU may comprise a magnetometer, e.g., to provide directional (e.g., heading) information. The IMU may be able to measure (A) linear acceleration, or (B) angular velocity. The IMU may measure accurately and/or reliably, e.g., during use of the AV.

The IMU may have an accuracy of at least a tactical missile a rocket, or of a cellular phone. The tactical missile may comprise a cruise missile or a ballistic missile. The IMU may have an accuracy required for precise application such as use of a LiDAR, photogrammetry, survey grade mapping, or any combination thereof. The IMU may have a positional accuracy of at least about 0.2 meters. The IMU may have a velocity accuracy of at least about 0.3 meters per second (m/s). The IMU may have an angular velocity accuracy of at least about 1 degree/hour (°/h). The IMU may require calibration after at least about 2 hours (h), 5 h, 10 h, 50 h, 100 h or 500 h of AV flight.

The calibration of the IMU may be during the flight, e.g., using an absolute measuring system. The calibration of the IMU may be during the flight utilizing GPS and/or an altitude-meter. The AV may comprise a plurality of IMUs, e.g., embedded in or operatively coupled with the FMU. A control system may compute a central tendency of the IMUs, e.g., to increase output accuracy and/or reduce calibration frequency. The communication system may comprise a radio transceiver. The radio transceiver may receive signals for two-way communication. The radio transceiver may modulate outgoing signals for transmission and/or demodulate incoming signals for reception. The radio transceiver may operate in a half-duplex, or full duplex mode. The radio transceiver may be configured for communication comprising wireless communication, two-way wireless emergency service, amateur radio equipment, or satellite communication. The radio transceiver may be configured for communication (A) with the AV crew (if any), (B) with ground control, (C) with video receiver, (D) with other AVs (e.g., of a swarm), (E) payload system(s). The payload system(s) may comprise sensor(s) or other mission-specific equipment, the sensors comprising the camera. The FMU may control at least in part the AV's navigation and/or response to at least one event having a plausible effect on the AV, e.g., as disclosed herein. The FMU may integrate data, e.g., arriving from one or more sensors. The data can be any input data disclosed herein, e.g., forecasts, AI data, and/or sensor data. The FMU may control automatic and/or autonomous navigation of the AV. The FMU may be configured to run flight control software. In an example, the software comprises PX4. The FMU may comprise a microcontroller, e.g., cortex M4F. The FMU may be configured to operatively couple with navigation related sensors (e.g., GPS), actuator outputs, and/or the communication system. The actuator may be any actuator disclosed herein. The FMU may comply with applicable jurisdictional standards. The FMU may comply with Dronecode Foundation standards, e.g., Pixhawk standard. The FMU may comprise FMUv5X, FMUv6X, or FMIUv6C.

In some embodiments, the AV comprises sensors. The sensors may comprise temperature, positions, location (GPS), distance (e.g., horizontal, vertical, and angular), velocity, acceleration, angular position, rotation, power, torque, force, proximity, or optical sensors. The optical sensors may comprise IR, VIS, or UV sensors. The sensor(s) may be integrated in a detector, or detection system. The AV may comprise a detector configured to detect and/or map the surroundings of AV, e.g., during flight. The detector may comprise a Radar or a Light Detector and Ranging sensor (LiDAR). The detector (e.g., Radar) may comprise radio frequency emitters, e.g., that can detect far object such as in adverse weather. The detector (e.g., LiDAR) may comprise a laser, scanner, and/or GPS. The detector can provide detailed topographical mapping of the external environment to the AV such as in real time during its flight, e.g., a three-dimensional map. The sensor may comprise proximity sensor, e.g., that differs from a LiDAR. The sensor and/or detector may be configured to allow warning against nearby obstructions comprising structures, trees, other objects; the obstruction potentially obstructing the flight of the AV. Data from the sensor and/or detector may be fed into the control system and/or other computational scheme. The computational scheme may operatively couple with, or be integrated into, the control system. The computational scheme may comprise a detect-and-avoid computational schemes, e.g., operative during flight of the AV such as an autonomous flight. The location detected may be relative to a global reference frame, and/or relative to a geographical mark. Sensor(s) may be integrated with the actuator (e.g., motor) and/or control system of the AV. Sensor(s) may be integrated with the encoder of the AV, e.g., a rotary encoder.

The AV comprises structural components, e.g., the AV comprises a skin. The skin may be an external surface of various components of the AV, comprising the hub, or the wings. The casing of the hub may comprise the skin. The casing may be of the hub, e.g., a first casing of the first hub portion, and a second casing of the second hub portion. The body of the hub may comprise the skin. The body of the wing may comprise the skin. The body of the AV may comprise the body of the hub, wing, or propeller, of the AV. Any structural component of the AV (e.g., the body of the AV, the propeller, mount, or wingtip container) may be made of a material comprising an elemental metal, a metal alloy, a ceramic, an allotrope of elemental metal (e.g., carbon fiber), a polymer, a resin, glass (e.g., fiberglass), or wood. In an example, non-transparent portions of the AV comprise carbon fiber, e.g., embedded as a composite in a polymer such as nylon. The polymer may comprise nylon, acrylonitrile, styrene, acrylate, or acrylonitrile-styrene-acrylate (ASA). One component of the AV may comprise one polymer, while another component may comprise anther polymer. In an example, the battery pack comprises ASA. In an example, the non-transparent portion of the AV except for the battery pack, comprise nylon, e.g., in which carbon fiber is disposed to form a composite material. Any component of the AV may comprise an opaque or a transparent material. The transparent material comprises a partially transparent material. The transparent material may be at least partially transparent to VIS, IR, and/or UV radiation. Any structural component of the AV may or may not comprise a composite material. Any of the AV structural components can be three-dimensionally printed, molded (e.g., using injection molding), carved, milled, or otherwise crafted. The crafting may utilize a computer numerical control (CNC) machine. In some embodiments, forming the structural component comprises additively and/or substantively forming. The forming may comprise extrusion, molding, or sculpting.

In some embodiments, the hub comprises a first portion and a second portion. The first portion may be configured to rotate relative to the second portion, e.g., during use such as flight. The first portion of the hub may comprise the power supply (e.g., batteries), the wing mounts, or the hub motor. The second portion may comprise the camera. Any additional sensor(s), controller(s) and any other circuitry of the hub, may be disposed in the first portion of the hub and/or in the second portion of the hub. The first portion of the hub may be operatively coupled with the second portion of the hub, e.g., via power connection. Rotation of the first hub portion relative to the second hub portion may be requested to facilitate keeping the camera (e.g., and any other sensors as applicable) fixated on the target during rotation of the first hub portion, e.g., and rotation of the wings coupled with the first hub portion.

In some embodiments, the wing is actuated using an actuator disposed in the wing. In some embodiments, the propeller operatively coupled with the wing, is actuated using an actuator disposed in the wing. The actuator may comprise any actuator disclosed herein, e.g., a servomotor. At least one actuator may be mounted in the wing. In an example, one actuator actuates rotation of the wing about its axis, and another actuator actuates rotation of the propeller about its axis. The rotational axis of the propeller may be at an angle relative to the long axis of the wing. The angle may be fixed or dynamic. The angle may be altered, e.g., using the control system. Alteration of the angle may be before, during, or after use of the AV. The wing may have portions. At least one actuator is disposed in a portion of the wing. In an example, a first actuator is disposed in the first wing portion, and a second actuator is disposed in, or operatively coupled with, a second wing portion. The first actuator may be configured to rotate the wing about its long axis. The second actuator may be configured to rotate the propeller about its rotational axis. The actuator may be disposed in a cavity in the wing. The cavity may act as a receptacle for the actuator. The actuator(s) may be operatively coupled with a power source of the AV, e.g., disposed in a hub of the AV. At least one actuator may be individually controlled. At least two of the actuators may operate in concert comprising simultaneously or sequentially. At least two of the actuators may operate in (e.g., substantially) the same way. At least two actuators may operate in diverse ways. Individual (e.g., and different) wing actuation may facilitate controlling the AV to be in S-MOD mode at least in part by modulating the AoA in each rotation of the wings about the central axis of the hub, to move the AV in the requested direction. The rotation of the wings in H-Mode may mimic rotation of a swashplate on a conventional helicopter.

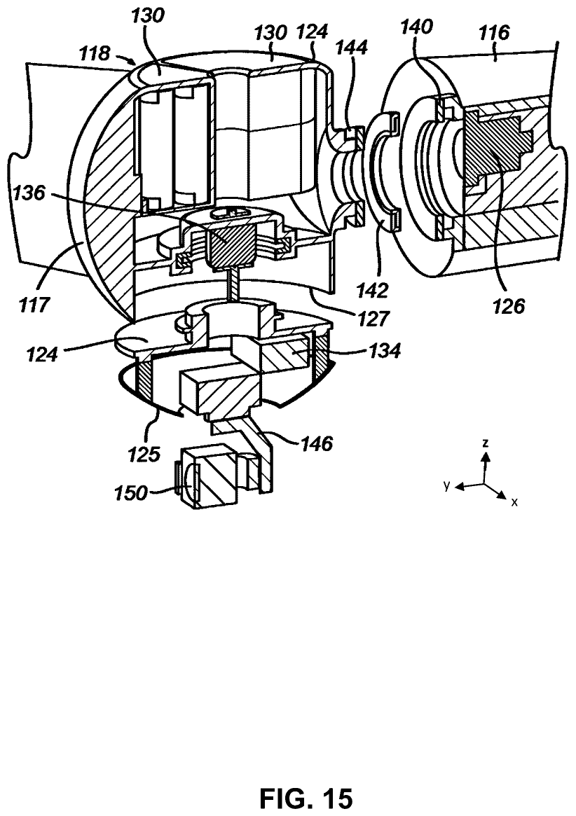

FIGS. 14 and 15 show example details of various internal components of an AV (e.g., vortex drone 100). The center hub 118 comprises a main hub body 117 (of the first hub portion) and a platform portion 124 (of the second hub portion). The platform portion 124 may be located at a bottom of, or with respect to, main hub body 117, wherein the platform portion 124 fits into an aperture 127 on the bottom of main hub body 117. Platform portion 124 additionally includes a bottom hub cap 125 (of the second hub portion), e.g., utilized to protect the internal components found within the center hub 118. The bottom hub cam can be utilized to protect the internal components disposed in the first hub portion and in the second hub portion, e.g., during use of the AV. Within the center hub 118 (first hub portion) can be a hub motor 136, which controls the movements of the pivoted holder (e.g., gimble) 146 and the camera 150 as discussed in further detail below. The hub motor 136 may be powered by battery packs 130. As discussed above, the battery packs 130 may be held in place by the battery holders 132. In one or more embodiments, the FMU 134 is needed to control the battery 30, the holder (e.g., gimble) 146, the camera 150 and the actuator systems 126 found in each of the wings 116.

In some embodiments, included within the AV (e.g., drone 100) is a communications air unit receiver (not shown) which can be the source of communication between the AV (e.g., vortex drone 100) and the remote-control unit of the control system (not shown) utilized to control the AV (e.g., drone 100). Also utilized with the control system may be control schemes, e.g., algorithms. Further attached to the FMU 134 of AV (e.g., drone 10) are various sensors, including accelerometers, and gyroscopes, which provide information about the position, orientation, and velocity of AV (e.g., drone 100) at any point in time. The ground control system (e.g., remote control) may be used by the operator to send commands to the AV (e.g., drone 100), such as instructions to take off, land, move in a certain direction, move in a certain mode, or adjust its altitude. Alternatively, or additionally, the AV (e.g., drone 100) can be autonomously controlled, e.g., where the operator or swarm AI algorithms command the AV (e.g., drone 100) to move from coordinate A to coordinate B, search along a designated flight path or area, return home, and/or any other (e.g., general) commands. In one or more embodiments, the communication link between the AV (e.g., drone 100) and the ground control unit may be a wireless radio frequency signal or wireless broadband communication signal, which allows for real-time transmission of data between the AV (e.g., drone 100) and the ground control system.

In some embodiments, the control schemes (e.g., algorithms) used are responsible for processing the data from the sensors and the remote control to determine the appropriate actions for the AV (e.g., drone 100) to take. These control schemes (e.g., algorithms) may (e.g., typically) use a combination of feedback control and feedforward control techniques to maintain stability and achieve requested (e.g., desired) performance. In some embodiments, feedback control involves continuously measuring the current state of the AV (e.g., drone 100) and comparing it to a requested (e.g., desired) state, then adjusting the actions of the AV (e.g., drone 100) to reduce any error between the two states. In some embodiments, feedforward control involves anticipating at least one event (e.g., as disclosed herein) such as the effects of external disturbances, such as wind and/or turbulence, and adjusting the actions of AV (e.g., drone 100) accordingly to minimize their impact.

In some embodiments, the wing is coupled with the hub, e.g., through a mount. The wing may couple with the hub, e.g., with the first hub portion. The coupling may be reversible and/or precise. The coupling may be configured to alleviate mistakes in joining the wing with the hub. The wing may be configured to couple with the hub in a keyed coupling, also referred to as keyed joint coupling. The wing may couple with the hub in a male-female interlock configuration. The mounting may comprise dovetail joint, spline shaft, puzzle type interlocking, or any combination thereof. The coupling may facilitate control of the attachment, e.g., controlling at least in part the direction, position, and/or angle of connection of the hub with the wing such as during their coupling. The mount may comprise bearing, e.g., ball bearing. The mount may comprise end plates, e.g., disposed on the hub facing portion and on the wing facing portion. The mount may allow full rotation of the wing about its long axis, e.g., a 360° rotation. The rotation may be continuous. A direction of the rotation may be reversible, e.g., and controllable such as during operation of the AV. The mount may allow partial rotation of the wing about its long axis, e.g., pivot. The mount may comprise end plates, e.g., disposed at the hub and at the wing, e.g., first portion of the wing. The mount may comprise bushing, e.g., to allow contact during rotation of the wing with respect to its long axis, the contact comprising electrical and/or data connection. In some embodiments the mount may comprise a bearing and a plate. The mount may be configured to rotate (e.g., pivot) the wing about its long axis and provide restraint in the remaining five degrees of freedom of the wing. The actuator may mount into the wing in a similar configuration, e.g., in a male to female interlock configuration.

In some embodiments, each wing 116 includes an actuator system 126 including a male arm and a female interlock 144 that operate to independently control the angle of attachment of each wing 116 to center hub 118 and to operate and independently control each propeller system 112 found adjacent the end 114 of each wing 116. As shown in the example FIG. 15, each wing 116 includes a wing bushing end plate 140 and a wing bushing 142 which interacts with a hub-bushing end plate 144 found on the main hub body 117. Wing bushing 142 allows for ease of movement about the wing axis while keeping the wing 116 fixed to the main hub body 117 in all other degrees of freedom. In one or more embodiments, during S-MOD (e.g., vortex mode), the hub motor 136 rotates relative to platform 124. In one or more embodiments, during S-MOD (e.g., vortex mode), the platform 124 does not rotate due to the hub motor 136 acting in a counter rotating manner. (e.g., Therefore) Regardless of the movement of the AV (e.g., drone 100), the camera 150 secured to the holder (e.g., gimble) 146 may not be out of position, e.g., relative to the target. Based at least in part on the various sensors discussed herein (e.g., above), such as the accelerometer and magnetometers, the hub motor 136 can know how fast to spin and at what rate to keep the camera 150 steady, e.g., fixated on the target during operation of the AV. FIG. 15 is shown relative to a Cartesian coordinate system.

In some embodiments, the hub is configured to decouple the rotational movement of the wings about the central axis of the hub, from the camera, e.g., that is directed to a target comprising a location or a direction. In some embodiments, the hub comprises two portions, a first hub portion and a second hub portion, the first hub portion couples with the second hub portion such that the first hub portion is rotated relative to the second hub portion. The wings can be coupled with the first hub portion, and the camera can be coupled with the second hub portion.

The first hub portion can comprise a power source, e.g., comprising batteries disposed in battery pack(s) situated in battery holder(s). Connection can be established between the first hub portion and the second hub portion, the connection comprising electrical and/or data connection. The connection can be minimally (e.g., un-) affected by the relative rotation of the hub portions which they connect. For example, a first hub portion can be connected with a second hub portion by a rotary connector such as a rotary interface, the first hub portion rotating with respect to the second hub portion. The rotary connector may be configured to pass (e.g., electrical) power and/or data therethrough, e.g., during its operation. The rotary connector may be configured to allow a continuous full rotation (of 360 degrees) about its central axis during its operation, e.g., while providing a stable supply of power and/or data. The rotary connector may transmit analog and/or digital signal. The rotary connector may comprise a rotary transformer, rotary capacitive coupler, fiber optic rotary joint (FORJ), fluid rotary union, inductive power transfer system, or a slipring mechanism. The slipring mechanism can be a multi-channel slip ring mechanism. The slipring mechanism may comprise a rotor (e.g., central shaft), stator, brushes, or multiple channels. The multiple channels may separate circuits for independent signal and/or power transmission. In the rotary connector, the signal and/or power may initially land on the stator, and be carried by the central shaft, e.g., of a slipring mechanism. The first hub portion may or may not comprise a light, or an actuator. In one embodiment, the first hub portion comprises an actuator configured to rotate the first hub portion relative to the second hub portion, e.g., and thus rotate the wings about the central axis of the hub. Various components of the first hub portion may be operatively coupled with a body of the first hub portion, e.g., using fasteners. The first hub portion may comprise one or more stages. In an example, a first stage of the first hub portion is operatively coupled with circuitry. A second stage of the first hub portion may be connected to the rotary connector. A first set of supports may be coupled with the first stage and face the second stage. A second set of supports may be coupled with the second stage and face the second stage. The first set of supports may engage with the second set of supports. The engagement may comprise resting, contacting, or connecting. The first set of supports may be connected to the side of the first stage facing the second stage and towards the camera of the AV. The second set of supports may be connected to the side of the second stage facing the first stage and away the camera. A FLS of a first base area encircling the first set of supports on the first stage may be larger than the FLS of a first meeting area encircling the meeting place of the first set of supports with the second set of supports. A first imaginary envelope engulfing the first set of supports may be an inverted first truncated cone or a truncated pyramid, the truncated top of which faces the second stage in the direction of the camera. The pyramid may have edges corresponding to the number of supports, e.g., a support can define the edge of the pyramid. The base of the pyramid may have a polygonal shape corresponding to the number of supports, e.g., with a support corresponding to an edge of the polygon. A FLS of a second base area encircling the second set of supports on the second stage may be larger than the FLS of a second meeting area encircling the meeting place of the first set of supports with the second set of supports. A second imaginary envelope engulfing the second set of supports may be an upright truncated cone or a truncated pyramid, the second truncated top of which faces the first stage in the direction away from the camera. At least one FLS of the first truncated cone may be different than the respective FLS of the second truncated cone. At least one FLS of the first truncated cone may be (e.g., substantially) the same as a respective FLS of the second truncated cone. At least one characteristic of the first set of supports may differ from that of the second set of supports. The at least one characteristic comprises the number of supports in each of the sets, a shape of a support, a FLS of the support, a density of the support, a material comprised in the support, relative location of the support on the respective stage, or any combination thereof. The FLS can comprise length, width, area, radius (e.g., of the imaginary truncated cone base or truncated pyramid base), height e.g., of the imaginary truncated cone or of the truncated pyramid), or any other FLS disclosed herein. The two imaginary cones may form a shape similar to an hourglass. The two imaginary pyramids may form a shape similar to an hourglass. The hourglass shape may facilitate accommodation of a shaft therethrough. The shaft can be of the rotary connector. Each of the stages can be fastened to the body of the first hub portion by fasteners, e.g., as disclosed herein. The fasteners may be fastened utilizing vertical holes disposed in tabs. The stages may be planar, and have one or more holes disposed therein, e.g., horizontal holes. The planar stage is devoid of a curvature in the plane, e.g., the plane is flat such that it is two dimensional. The tabs may be angled on one or more sides of the planar stage. A stage may be operatively coupled with wall(s). The wall(s) may be configured to encircle the rotary connector. The wall(s) may (e.g., also) form at least one side of the battery holders. The body of the first hub portion may form at least one side of the battery holders. In some embodiments, distant side of the battery holders is formed by an internal portion of the body of the first hub portion, and an adjacent side of the battery holders if formed by the wall(s), which distant and adjacent are relative to the central axis of the hub. The wall(s) may have a side facing the battery holder interior, and an opposing side facing the innermost space of the hub. The innermost space of the hub comprises the first and second sets of supports, and the rotary connector. The first stage may be coupled with circuitry and/or sensors. The first stage may be coupled with a navigation system (e.g., GPS), a controller, an IMU, an encoder, or an actuator. The actuator may face the second stage. Components of the hub may be coupled with either side of the stage, e.g., the first stage and/or the second stage. The stage may be planar, e.g., the first stage and/or the second stage. The second hub portion may comprise a holder of a camera, and the camera. The second hub portion may comprise a sensor or a circuitry. The circuitry may comprise a controller or a communication system, e.g., comprising a communication interface. The second hub portion may or may not comprise a light, or an actuator. The second hub portion may comprise a gimble. Various components of the second hub portion may be operatively coupled with a platform connected to the rotary connector. Various components of the second hub may be coupled with the platform by at least one brace. The second hub portion may have a casing operatively coupled with the platform, e.g., by one or more legs and/or fasteners such as any of the ones disclosed herein. The second hub portion may comprise an IMU, an encoder, or an actuator. In some embodiments, a component of the hub resides in the first hub portion, and in other embodiments the component resides in the second hub portion; the component comprising an actuator of the hub, a controller, a navigation system (e.g., GPS), a communication system, an IMU, an FMU, a sensor other than the camera, an encoder, a power supply (e.g., batteries), or lighting. In some embodiments, the actuator of the hub resides in the first hub portion, and in others in the second hub portion. In some embodiments, lighting resides in at least two portions of the hum, e.g., in the first hub portion and in the second hub portion.

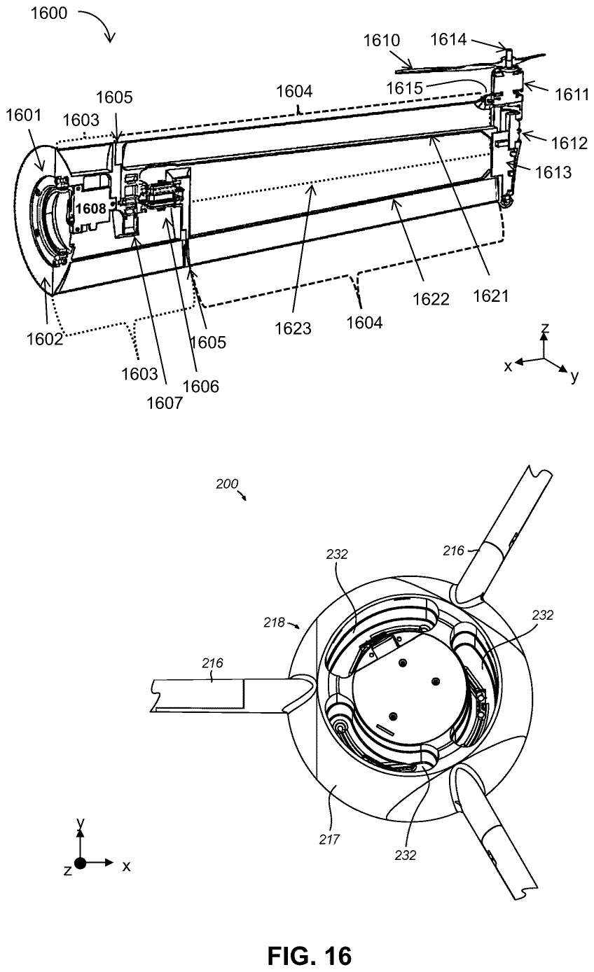

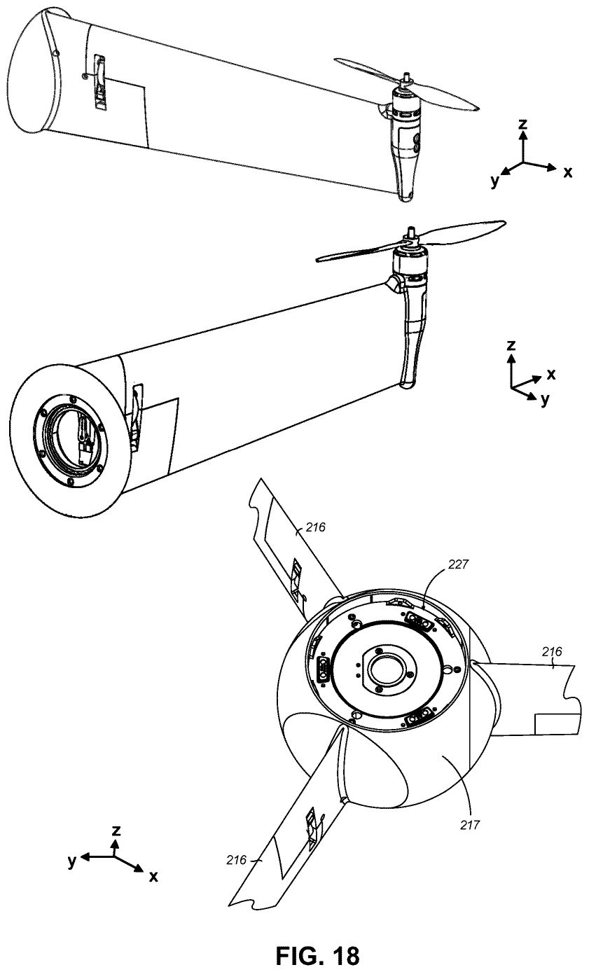

Example FIGS. 16 to 21 show various details of components of a vortex AV (e.g., drone 200) of the present disclosure. As shown in example FIG. 16, vortex AV (e.g., drone 200) utilizes a slimmer design for battery holders 232 as compared to the battery holders 132 of vortex AV (e.g., drone 100). This allows for more internal room for the internal components of vortex AV (e.g., drone 200) which will be discussed in detail herein (e.g., below). A center hub 218 includes a main hub body 217 (also referred to as the “first hub portion”) and a platform portion 224 (also referred to herein as the “second hub portion,” or the “turret”). The platform portion 224 may be located at the bottom of main hub body 217, wherein the platform portion 224 fits into an aperture 227 on the bottom of main hub body 217. Platform portion 224 additionally includes a bottom hub cap 225, utilized to protect the internal components found within the center hub 218. Within the main hub body 217 may be a hub motor 236, which powers an FMU 234, a GPS system 235, a holder (e.g., gimble) 246, and a camera 250 as will be discussed in further detail herein (e.g., below). Although the FMU 234 is shown on the platform 224 and the GPS 235 is shown within the main hub body 217, the position of each component 234, 235 may be interchangeable between the platform 224 and the main hub body 217, and it may also be envisioned that each component 234, 235 can both be positioned with one of either the platform 224 or the main hub body 217. AV (e.g., Vortex drone 200) also utilizes an air control unit 255 located on the platform 224 to assist with communications between the AV (e.g., vortex drone 200) and the ground control system (e.g., comprising a remote-control unit). Although shown as being located on the platform 224, it may also be contemplated that the air control unit 255 may be located within the main hub body 217. The hub motor 236 may be powered by battery packs 230, which fit into the battery holders 232 and connect with battery connectors 231 located at a bottom of the battery holders 232. The platform 224 may be attached to the main hub body 217 with an axial female coupling 253 to a male coupling 252 located on platform 224, which connects to a female coupling 254 located within the main hub body 217. This coupling system allows the motor torque to be transmitted between the main hub body 217 and platform 224 without axial load overloading hub motor 236. Also, such a connection between the main hub body 217 and the platform 224 allows for the main hub body 217 to rotate in S-MOD (e.g., windmill mode) while the platform 224 can counter-rotate while in S-MOD (e.g., windmill mode), allowing the platform 224 to remain still while the main hub body rotates. As discussed herein (e.g., above), the control system such as the FMU 234, the GPS system 235, the holder (e.g., gimble) 246, the camera 250, and the air control unit 255 are dispersed between the platform 224 (second hub portion) and the main hub body 217 (first hub portion); therefore, AV (e.g., vortex drone 200) includes a rotary connector that is a multi-channel slip ring 256 that connects the platform 224 and the main hub body 217 together, so that the various elements of the control system can (e.g., easily) communicate with one another. FIGS. 16 to 21 are shown relative to respective Cartesian coordinate systems.

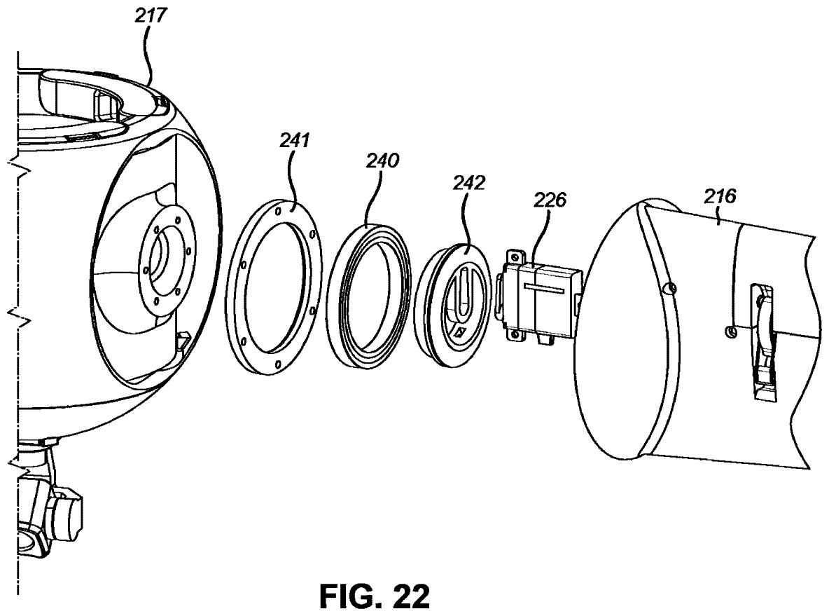

In some embodiments, each wing 216 includes an actuator system 226 including a male arm and a female interlock that operate to independently control the angle of attachment of each wing 216 to center hub 218 and to operate and independently control each propeller system 212 found adjacent an end 214 of each wing 216. Example FIG. 22 shows an exploded view of how wings 216 are secured to the main hub body 217 using a mount. A wing bearing end plate 241 fits around a ball bearing 240 while a hub bearing end plate 242 fits within ball bearing 240. The hub bearing end plate 242 also interacts with the actuator system 226 secured within wing 216 while the wing bearing end plate 241 also interacts with the main hub body 217. The mount components comprising the bearing and its associated components.

FIG. 16 shows in example 1600 a perspective cross sectional view of a bifurcated wing having two portions that are coupled with each other, first wing portion 1603 is coupled at its base to a mount having bearings and plate assembly 1601, and mount cover. The wing has a first portion 1603 and a second portion 1604 coupled by coupling system along border 1605, the coupling system comprising fastener 1607 (e.g., latch) and connector 1606 transmitting electricity and/or data. First wing portion 1603 comprises actuator 1608, e.g., servomotor. The second wing portion is coupled at its tip to a propeller system comprising propeller 1610 held by fastener 1614 and coupled with an actuator 1611 that is in turn coupled by wiring 1615 to a power source, which rest of the wiring is not shown. The power source can be in the hub coupled with the mount (hub not shown). Actuator 1611 (e.g., servomotor) is coupled with a wingtip container comprising sensors 1612, e.g., proximity sensors, and circuitry disposed on a PCT 1613. The wing comprises supports in the body of the wing. In an embodiment, the wing comprises tailing spar 1622 and leading spar 1621. In an example, the wing comprises an internal channel, with 1622 and 1621 being cross sectional sections of the channel disposed in the wing. The wing has a long axis 1623. The wing may have ribs.

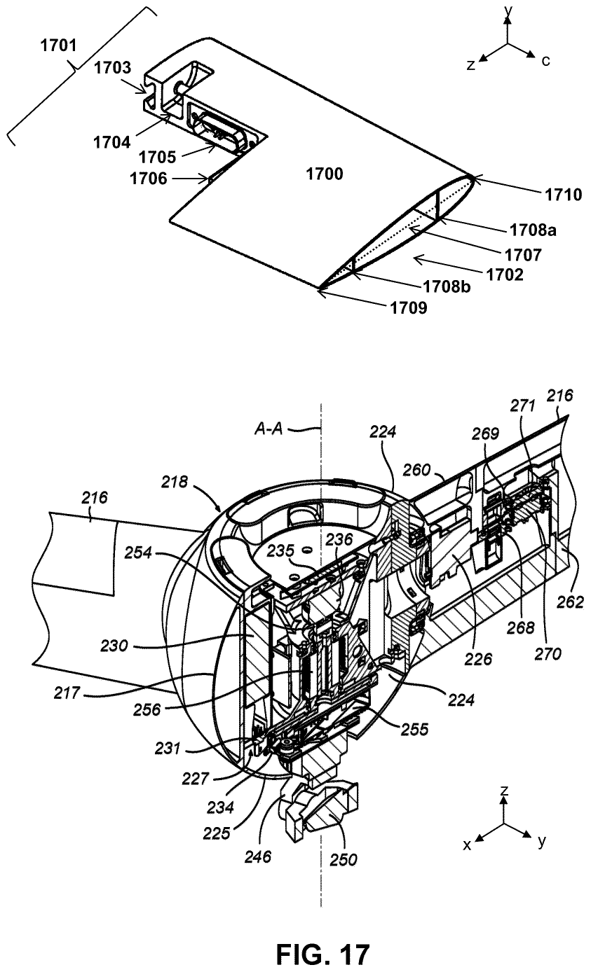

FIG. 17 shows a perspective view of a section 1700 of a second wing portion comprising a side 1701 at which a coupling system is disposed, and an opposing side of the wing portion comprising an airfoil 1702. The coupling system comprises a dovetail receptacle 1703, a coupler such as a keeper 1704 for a hook/latch disposed in a depression relative to the skin surface of wing portion 1700, the keeper can be an eyelet, a connector 1705, and a dovetail insert 1706.

The connector can transmit data and/or electricity therethrough. The connector may comprise a Molex type connector or any other connector disclosed herein, as applicable. The connector may comprise a socket side and an insert side that mate upon their connection. Airfoil 1702 is symmetric along its long axis 1707, the airfoil comprising spars 1708a and 1708b, extending into wing portion 1700. Airfoil 1702 comprises a leading edge 1710 and a tailing edge 1709 disposed along long airfoil axis 1707.

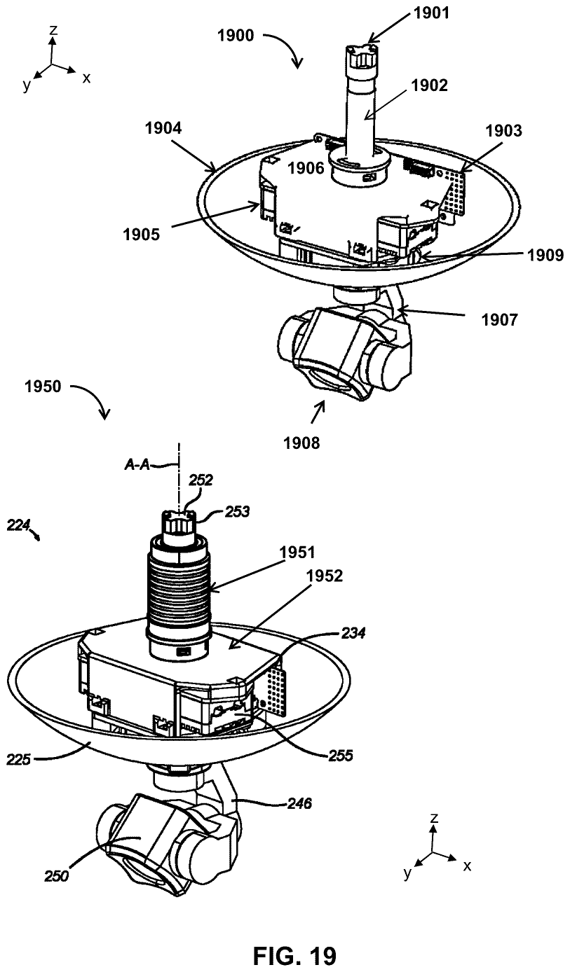

FIG. 19 shows an example of the second hub portion comprising cover 1904 having aperture 1909 from which holder 1907 of camera 1908 protrudes. Holder 1907 is coupled with platform 1906 to which circuit board 1903 is coupled, and a communication system 1905, e.g., transceiver. The PCB may comprise an FMU and an IMU. Shaft 1902 of a rotary connector such as a slipring is coupled with platform 1906. The shaft is operatively coupled with connectors 1951 comprising rings, coils, or brush forming a unit coupled with platform 1952, as can be seen in example 1950 shows an example of the second hub portion relative to a Cartesian coordinate system. Example 1900 is also shown relative to a Cartesian coordinate system.

In some embodiments, the wing is separated into several portions that are coupled for use of the AV. For example, the wing can be bifurcated into two sections that are coupled for use of the AV. The coupling may comprise physical coupling. The coupling may comprise mechanical coupling or electronic coupling. The coupling may comprise electricity and/or data coupling. The coupling between the first wing portion and the second wing portion may utilize a coupling system. The coupling system may comprise at least 1, 2, 3, or 4 separate and distinct coupling mechanisms. The coupling mechanisms may be spatially separate from each other. The coupling mechanisms may be spatially distinct from each other. At least two of the coupling mechanisms may be of the same type. At least two of the coupling mechanisms may be of a different type. The coupling mechanisms may comprise any coupling mechanism disclosed herein. The coupling may be reversible and/or precise. The coupling may be configured to alleviate mistakes in joining a first wing portion with a second wing portion. The first wing portion may be configured to couple with the second wing portion in a keyed coupling. The first wing portion may couple with the second wing portion in a male-female interlock configuration. The coupling may comprise dovetail joint, spline shaft, puzzle type interlocking, fastener, or any combination thereof. The coupling action may facilitate control of connecting the first wing portion with the second wing portion, e.g., at least in part by controlling the direction, position, and/or angle of the connecting wing portions such as upon their coupling. The first wing portion may be a proximal portion with respect to the hub, e.g., with respect to the first hub portion. The second wing portion may be a distal portion with respect to the hub, e.g., with respect to the first hub portion. The coupling operation may couple one mating end of the first wing portion with a second mating end of the second wing portion, e.g., such that the surfaces of the first mating end and the second mating end will oppose each other and/or contact each other. In an embodiment, the coupling of the two wing portions withstands forces placed upon the wing during operation of the AV, e.g., during its flight including in all modes of flight. Each of the mating ends may comprise one or more (respective) surfaces. For example, each of the mating ends may comprise at least 2, 3, or more surfaces. Two contacting surfaces of the mating end may form an angle. The angle may or may not be a (e.g., substantially) right angle. The angle may be an obtuse angle. The angle may be an acute angle. In an example, the mating end may comprise three surfaces, e.g., a first surface, and second surface and a third surface, the first surface contacting the second surface, and the second surface contacting the third surface.

The smallest angle between the first surface and the second surface may or may not be (e.g., substantially) the same as the smallest angle between the third surface and the second surface. In an example, the smallest angle between the first surface and the second surface is (e.g., substantially) the same as the smallest angle between the third surface and the second surface, which angle is (e.g., substantially) a right angle. The mating surface may accommodate 1, 2, 3, or more coupling mechanisms. At least two of the mating surfaces may have the same number of coupling mechanisms. At least two of the mating surfaces may have a different number of coupling mechanisms. In an example, the first mating surface has the same number of coupling mechanisms (e.g., a dovetail) as the third mating surface. In an example, the first mating surface has a different number of coupling mechanisms (e.g., a dovetail) as the second mating surface, e.g., a fastener and a connector transmitting electricity and/or data.

In some embodiments, component(s) of the AV has a unique identification, e.g., and can be individually identified and/or controlled, by the control system. The unique identification may be in the form of a circuitry. The component(s) may comprise the wing, wing portion, propeller, or actuator. The component(s) may be any controllable component of the AV, e.g., as disclosed herein. The components may comprise the actuator, the sensor, or the detector.

In some embodiments, the wing of the AV comprises portions configured to couple to a single wing prior to use of the AV, e.g., before its flight. In some embodiments, the AV comprises a first (e.g., proximal) portion and a second (e.g., distal) portion. The first wing portion may comprise an actuator, wiring, mount coupler, lighting, sensor(s), or a coupling mechanism to the second wing portion. The actuator may comprise a motor or an engine. The actuator may be configured to precisely control the angular and/or linear position of the wing, e.g., with respect to the hub, e.g., first portion of the hub. The motor may comprise a servomotor. The servomotor may comprise a DC servo motors, AC servo motors, positional rotation servo motor, continuous rotation servo motors, or linear servo motors. The motor may comprise a thrust motor, or a mini quad motor (e.g., brushed or brushless). In some embodiments, each of the wings comprises a dedicated actuator (e.g., servomotor). Sensor(s) may be integrated with, or operatively coupled with, the actuator (e.g., motor). In an example, the actuator is an electric motor with sensor(s). The actuator (e.g., motor) may have an integrated controller. During operation of the AV, the wing may be coupled with the hub through the mount, e.g., the coupling comprising a bearing. The coupling system of the two wing portions may comprise one or more diverse (e.g., different) types of coupling mechanisms. The coupling system of the two wing portions may comprise at least 2, 3, 4, or more types of different coupling mechanisms, e.g., engagement mechanisms. The coupling mechanism may comprise a mechanical (e.g., physical) coupling, an electrical connector, a magnetic coupling, or data coupling. The coupling mechanism may comprise a mechanical coupling, a connector, and a fastener. The connector may comprise a male and female harness members configured to couple with each other to establish the connection. The connector may transmit electricity and/or data. The connector may be any connector disclosed herein, as applicable. The mechanical coupling may comprise a keyed connection. The keyed connection can be any keyed connection disclosed herein, e.g., a dovetail connection-dovetail joint. The connector may or may not comprise a keyed connection. The fastener may comprise a latch (e.g., snap-latch, or slig-latch), clip, catch, hook, a pin, clam, compression, push-to-close, draw, screw, washer, or tab. The fastener may comprise a spring or be devoid of a spring. The fastener can be configured as a reversible snap fit. The keyed connection can comprise a female member and a male member. The fastener may comprise a female member and a male member. The connector may be configured to communicate electrical power and data signal such as communication signal. The connector may comprise a male member and a female member of a mating pair, e.g., a male harness and a female harness. The magnetic connection may comprise a male member and a female member. One or more of the male members (e.g., all male members) may be disposed in the first wing portion. One or more of the female members (e.g., all female members) may be disposed in the first wing portion. The first wing portion wing may comprise a female member of at least one coupling mechanism type. The first wing portion wing may comprise a male member of at least one coupling mechanism type. The first wing portion wing may comprise a female member of at least one coupling mechanism type and a male member of at least another coupling mechanism type. The coupling system may comprise at least two mechanical coupling mechanisms, e.g., at least two keyed couplings such as at least two dovetail couplings. At least two of the mechanical coupling mechanisms may differ from each other. At least two of the mechanical coupling mechanisms may be (e.g., substantially) the same. The mechanical coupling mechanisms may differ from each other in shape, size, mechanics, and/or material. The coupling system may be configured to couple at least two (e.g., all) of the coupling mechanism therein simultaneously, e.g., on coupling the first wing portion to the second wing portion. The first wing portion may comprise wiring, e.g., directed to power actuator(s), light(s), and/the propeller systems, e.g., at least some of which are disposed in the second wing portion. The connectors of the AV may adhere to the power systems connector standard of the applicable jurisdiction. The connectors of the AV may adhere to the Dronecode Foundation. The lighting and sensors may be any of the ones disclosed herein. The propeller system may comprise an actuator, e.g., propulsion motor. The lighting may comprise LED. The second portion may comprise a processor, e.g., for effectuating actions directed by communication protocols, e.g., the actions of the wing such as actions of the second wing portion or components operatively coupled thereto. The communication protocols may comprise I2C, CAN, UART, SPI, or any other communication protocol disclosed herein. The second wing portion may comprise a sensor. The sensor(s) may comprise a proximity sensor. The sensor may sense any close objects to the skin of the second wing portion, e.g., to the tip of the second wing portion, which is the tip of the wing. The proximity sensor may comprise a LIDAR, a time-of-flight (ToF) sensor, or any other proximity sensor disclosed herein.

In some embodiments, the wing of the AV comprises portions configured to couple to a single wing prior to use of the AV, e.g., before its flight. In some embodiments, the AV comprise a first (e.g., proximal) portion and a second (e.g., distal) portion. The second wing portion may comprise an actuator, wiring, lighting, sensor(s), a coupling mechanism to the first wing portion.

The actuator, wiring, lighting, sensor(s), and coupling mechanism, may be any of those disclosed herein. The wiring may comprise cabling. The wiring may operatively couple the power source (e.g., batteries) of the AV with the propeller actuator, any sensor(s), and/or any lighting. The coupling of between two immediately adjacent wing portions may occur in a concerted action to couple at least two (e.g., all) coupling mechanism types. In an example, coupling the first wing portion with the second wing portion may comprising coupling three types of coupling mechanisms, e.g., comprising two dovetails, a latch, and a connector coupling member. The axial slide movement of the dovetail coupling may direct the connector member to slide axially into place with the sliding movement. There may be radial space between the coupling mechanism types (e.g., dovetails, e.g.) of the coupling system, such as to provide a wheelbase for two of the coupling mechanisms to withstand the torque from the aerodynamic bending loads, while also withstanding the high centrifugal loads. For example, there may be radial space between the coupling mechanism types (e.g., dovetails, e.g.) of the coupling system, such as to provide a wheelbase for the two dovetails to withstand the torque from the aerodynamic bending loads, while also withstanding the high centrifugal loads. The dovetails may slide axially from front to back during the coupling operation. Each of the coupling mechanisms in the coupling system may comprise a male member and a female member, e.g., as disclosed herein. One or more of the male members (e.g., all male members) may be disposed in the second wing portion. One or more of the female members (e.g., all female members) may be disposed in the second wing portion. The second wing portion wing may comprise a female member of at least one coupling mechanism type. The second wing portion wing may comprise a male member of at least one coupling mechanism type. The second wing portion wing may comprise a female member of at least one coupling mechanism type and a male member of at least another coupling mechanism type. The coupling system may comprise at least two coupling mechanisms of the same type, e.g., that are separate and distinct from each other—as disclosed herein. In an example, each of dovetail mechanism portion of the two dovetail mechanisms, is disposed at a different vertical and different horizontal location, with respect to the wing portion body at which they are located. The pair of dovetails may span the chord of the wing. The pair of dovetails may be disposed at a distance from each other with respect to the long axis of the wing. The fastener (e.g., latch) may be disposed along the long axis of the wing between the two dovetails. The fastener may have a protruding portion on one wing portion, configured to couple with a depression on the other wing portion to which the one wing portion is coupling to. The one wing portion can be the first wing portion, and the other wing portion can be the second wing portion, or vice versa. The fastener may be any fastener disclosed herein. The fastener may be disposed along the long axis of the wing, e.g., to keep the dovetails in place. The location of the fastener may be chosen to be disposed in a direction where there are lower operational loads, e.g., during the coupling operation and/or during operation of the AV. The connector may comprise a coupler or any other connector such as disclosed herein for transmitting electricity and/or data, as applicable. The connector may comprise a member that may be disposed along the long axis of the wing between the two keyed coupling mechanisms, e.g., between the dovetails. The wing may be configured to withstand (A) high radial (e.g., centrifugal) loads and/or (B) high transverse (e.g., bending) loads, e.g., during operation of the AV. The airfoil of the wing may be any airfoil disclosed herein. In some embodiments, the airfoil has is nonsymmetrical, e.g., along its chord. The wing may comprise a nonsymmetrical cross section of the wing along its long axis. The wing may be tapered towards its tip relative to its base.

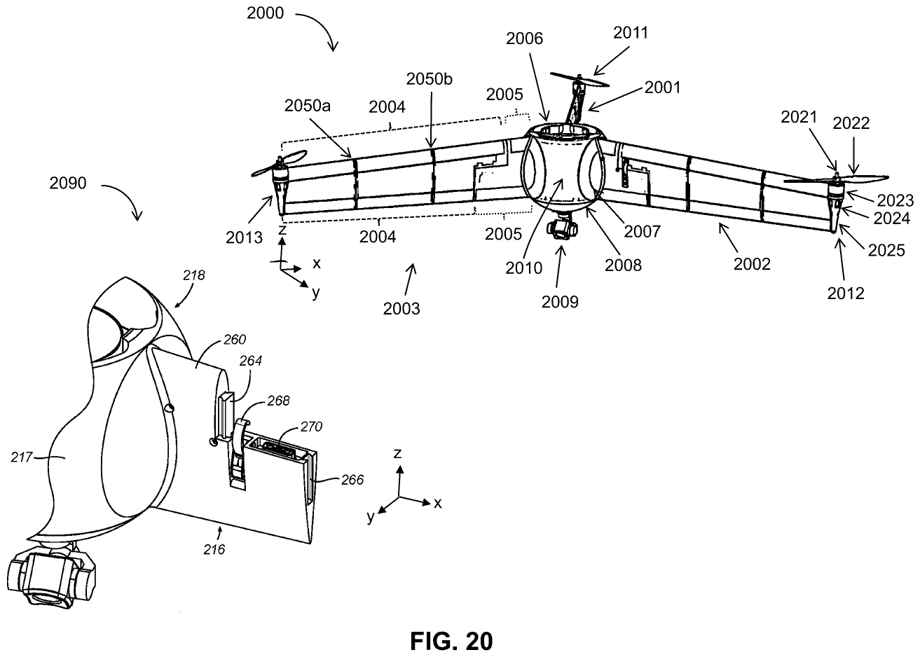

FIG. 20 shows in example 2000 an AV having three wings 2001, 2002, and 2003, with each of the wings coupled with hub 2006 at the base of the respective wing, and each of the wings having a respective propeller assembly 2011, 2012, and 2013 at its tip (e.g., end). Each of the wings is composed portions. Wing 2003 comprises (a) first wing portion 2005 coupled with the base of hub 2006, and (b) second wing portion 2004 coupled with the first portion 2005 and with propeller system 2013 disposed along the long axis of the wing in opposite directions. Propeller system 2012 comprises propeller wings 2022, fastener 2021, actuator (e.g., servomotor) 2023, and optional wingtip container 2025, e.g., comprising lighting and/or circuitry (not shown). Each of the wings is mounted to hub 2006 by a respective mount having a mount cover. For example, the AV's wing 2002 is coupled with a mount disposed in mount cover 2007. Hub 2006 comprises a first hub portion having cover 2010, and a second hub portion having cover 2008. Cover 2008 has an aperture through which the holder of camera 2009 protrudes, e.g., the holder may optionally cause the camera to move, e.g., pivot). The holder of the camera can comprise a gimble. Second wing portion 2004 comprises optional items numerals 2050a-b, any of which may represent (a) an internal support such as a rib, or (b) sectioning of portion 2004 coupled with a coupling system such as any of the ones disclosed herein, or (c) fabricated sections merged to one section 2004 in the manufacturing process. Such optional wing sectioning may be pre-assembled before providing the AV to a user.

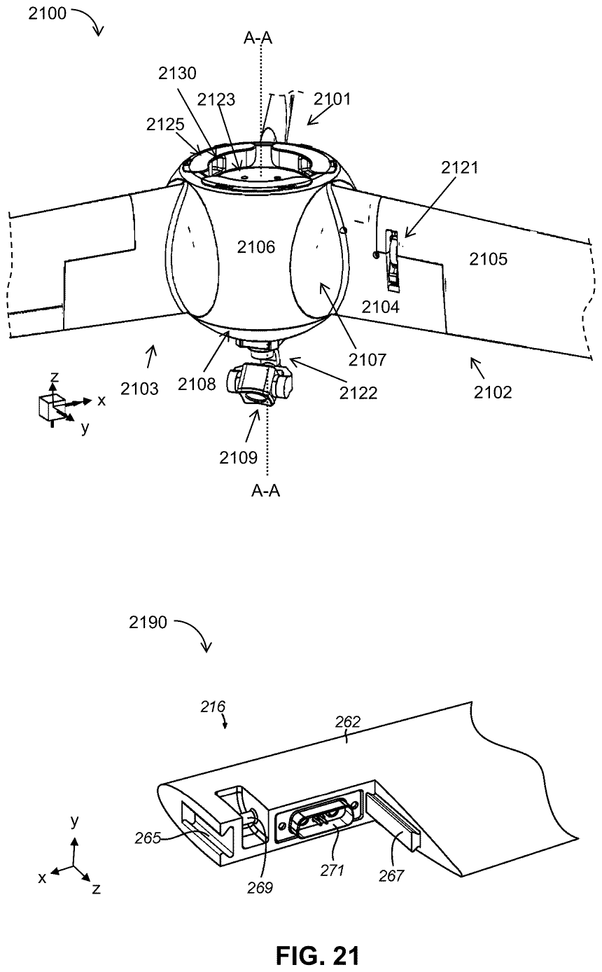

As can be seen in more detail with FIG. 20, example 2090 and FIG. 21, example 2190, each wing 216 of AV (e.g., vortex drone 200) may be broken down into two main component parts, namely a proximal portion 260 and a distal portion 262. The wings 216 need to withstand high radial (e.g., centrifugal) loads while also having high transverse (e.g., bending) loads. Typical wing attachments only need to worry about high radial loads. To overcome these issues, wings 216 utilize a double dovetail mechanism. Specifically, the proximal portion 260 of each wing 216 includes a first male dovetail 264 and a second female dovetail 266, and the distal portion 262 of each wing 216 includes a first female dovetail 265 and a second male dovetail 267. The first male dovetail 264 interacts with the first female dovetail 265 while the second female dovetail 266 interacts with the second male dovetail 267 to secure the proximal portion 260 and the distal portion 262 of each wing 216 together. This double-dovetail mechanism has a large amount of radial space between the dovetail pairings 264/265 and 266/267 to provide a moment arm between the dovetail pairings 264/265 and 266/267 to withstand torque from aerodynamic bending loads, while also withstanding high centrifugal loads.

In some embodiments, the dovetail pairings 264/265 and 266/267 slide axially front to back during assembly. As an added means of security, the proximal portion 260 also includes a clip 268 that interacts with a fastener (e.g., latch hook) 269 on the distal portion 262. It may also be contemplated that the proximal portion 260 could contain the fastener (e.g., latch hook) 269 while the distal portion 262 contains the clip 268. To provide an electrical and/or data connection between the proximal portion 260 and the distal portion 262, the proximal portion 260 includes a female connector member 270, and the distal portion 262 contains a male connector member 271. It may also be contemplated that the proximal portion 260 could contain the male electrical and/or data connector member 271 while the distal portion 262 contains the female electrical and/or data connector member 270. An electrical and/or data connection may be needed because the actuator system 226 may be located within the proximal portion 260 while the one or more propeller systems may be located on the distal portion 262.

FIG. 21 shows in example 2100 a portion of an AV having first hub portion having first hub casing 2106 coupled with second hub portion having second hub casing 2108. Camera 2109 protrudes from an aperture of second hub casing 2108, the camera disposed at the end of the hub away from the first hub portion. The first hub portion has a truncated end opposing camera 2109, showing three battery packs, e.g., 2125, having a horizontal cross section curved at the horizontal plane, and a central depression 2123, the horizontal cross section being along the XY plane of the cartesian coordinate system of example 2100. Battery pack 2125 comprises a depression 2130 configured to allow (e.g., reversible) extracting the battery back from the AV and/or (e.g., reversible) opening the lid of the battery holder, e.g., using a finger. The depression and battery pack ends can remain as such or be covered, optional cover not shown in example 2100. The first hub portion having cover 2106 comprises mounts, each mount mounting an AV wing. Wing 2102 is mounted to the first hub portion through a mount having mount cover 2107. The first hub portion is coupled with three wings, sections of which are 2101, 2102, and 2103. Wing section 2102 is bifurcated into a first portion 2104 directly coupled with the first hub portion through its base, and second wing portion 2105 coupled with first wing portion 2104, e.g., by latch 2121 showing its lip engaged with its hook (not shown). The latch lip and hook are disposed in a depression with respect to the external surface of wing 2102. The latch, when closed, can be flush with the wing's skin, or disposed more internally to the wing relative to the external surface of the wing skin.

Camera 2109 is coupled with an interior of the second portion of the hub (not shown) by a holder 2122, e.g., that may pivot. The holder may comprise a gimble. The battery packs are shown following the circumference of the exterior of the top truncation of the first hub portion with a smaller radius, the top truncation opposing camera 2109. The battery packs are shown as encircling a central axis A-A of the hub and creating a central space.

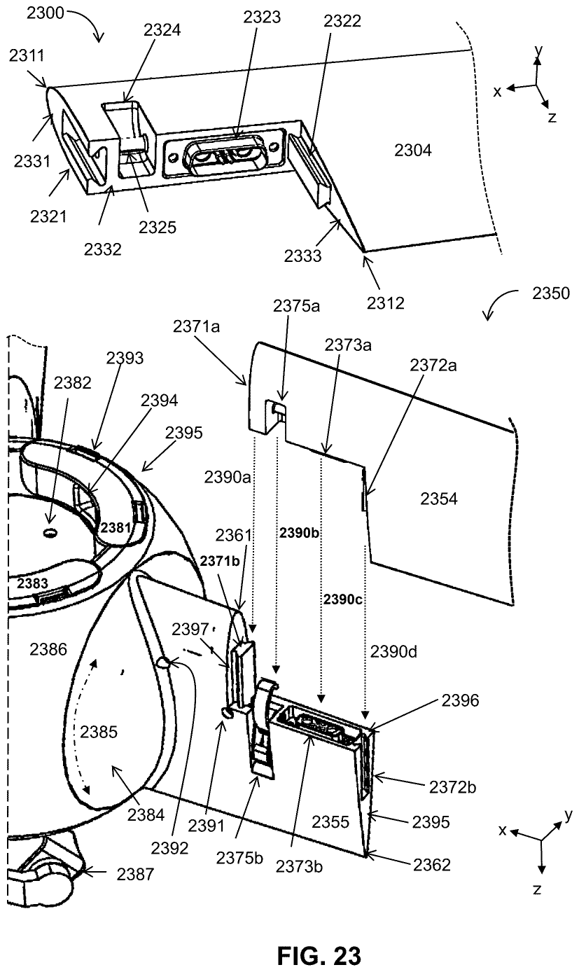

FIG. 23 shows in example 2300 a perspective view of a section 2304 of second wing portion comprising a first dovetail insert 2323, a female member 2323 (e.g., female harness) of an electrical and/or data connector, hook 2325 of a fastener, the hook being disposed in depression 2324 relative to the external surface of section 2304 of the second wing portion, the depression being towards the interior of section 2304, and dovetail receptacle 2321. Section 2304 of the second wing portion has an airfoil. A cross section of the airfoil can be seen as being bifurcated between one portion having first surface 2331 and accommodating dovetail receptacle 2321 and having leading edge 2311; and a second portion having surface 2333 and accommodating dovetail insert 2322 and having tailing edge 2312. Surfaces 2331, 2332, and 2333 form the mating surfaces designated to meet (e.g., contact) with respective surface of the first wing portion. The first surface 2331 is normal to the second surface 2332 that is normal to third surface 2333, with surfaces 2331 and 2333 bifurcating the airfoil of the wing. The different dovetail sections are disposed along the bifurcated airfoil, whereas the fastener (e.g., latch) and the connector are disposed at a surface normal to the airfoil portions. FIG. 23 shows in example 2350 a perspective view of section 2354 of the second wing portion that is similar to section 2304 of the second wing portion. Section 2354 of the second wing portion comprises a first dovetail insert 2372a, a female member 2373a of a connector for electricity and/or data, hook 2375a of a fastener, the hook being disposed in a depression relative to the external surface of second 2354 of the second wing portion, and dovetail receptacle 2371a (receptacle not shown). During the operation of coupling the first wing portion with the second wing portion, the second wing portion is pressed towards the mating surface of first wing portion, e.g., in the direction indicated by arrows 2390a-d. After the mating process, surface 2397 should face a surface analogous to 2331; surface 2396 should face a surface analogous to 2332; and surface 2395 should face a surface analogous to 2333. First wing portion 2355 comprises first dovetail receptacle 2372b, male member 2373b (e.g., male harness) of a connector disposed in a depression relative to the mating surface of the first wing with the second wing, latch 2375b disposed in a depression relative to skin of first wing portion 2355, and second dovetail insert 2371b. Section 2355 of the first wing portion has an airfoil. The connector may be configured to transmit electricity and/or data. A cross section of the airfoil can be seen as being bifurcated between one portion having first surface 2397 and accommodating dovetail insert 2371b and having leading edge 2361; and a second portion having surface 2395 and accommodating dovetail receptacle 2372b and having tailing edge 2362. Surfaces 2395, 2396, and 2397 form the mating surfaces designated to meet (e.g., contact) with respective surface of the second wing portion. The first surface 2397 is normal to the second surface 2396 that is normal to third surface 2395, with surfaces 2397 and 2395 together (e.g., substantially) spalling the airfoil of the wing. First wing portion 2355 is coupled with the hub having casing 2386 through a mount. The mount facilitates rotation of the wing relative to the hub, e.g., along double arrow 2385 such as in an angle of at most about 180°, 270° or 360°. The mount is covered by casing 2384 that can rotate along double arrow 2385 relative to hub casing 2386. The hub is coupled with a camera, e.g., through coupler 2384, e.g., a gimble. The hub is truncated at its top side opposing the camera (e.g., and opposing coupler 2384). The top truncated portion comprised battery packs having curved cross sections, e.g., such as 2395. Battery pack 2395 comprises (a) two fasteners such as 2393 to secure the battery pack to the body of the hub, and (b) an (e.g., ergonomic) depression 2394 for reversible releasing the battery pack from the hub and/or for opening the battery pack. The top of the battery pack 2381 is parallel to the horizontal cross section of the battery pack perpendicular to its long axis along the Y direction. The fasteners being disposed at a side of the battery pack having the longer arch as compared to an opposing side of the battery pack having a shorter arch, the arches being concentric. Depression 2394 is located at the side of the battery pack having the smaller arch, depression 2394 being disposed adjacent to the top of the battery pack, centered at the smaller arch. The depression disposed at a side of the battery pack opposing the fasteners. In other embodiments, the fasteners are disposed at the side of the battery pack having the smaller arch, and the depression is disposed at the side having the longer arch. Each of the battery packs is held in a battery holder, e.g., using a fastener such as 2383. The hub comprises a cover having an access hole 2382, e.g., relief for bolts. Access hole 2382 can be utilized for assembly, testing, and/or maintenance of the hub. Access hole 2382 can be allow access to a fastener, e.g., a screw. The fluid can be, or can act as, a cooling fluid. First wing portion 2355 comprises access hole 2391, e.g., to fasten an actuator onto the first wing portion. The mount-wing-base edge comprises another access hole 2392, e.g., to faster the actuator onto the first wing portion. In some embodiments at least one (e.g., all) of the access holes are absent.

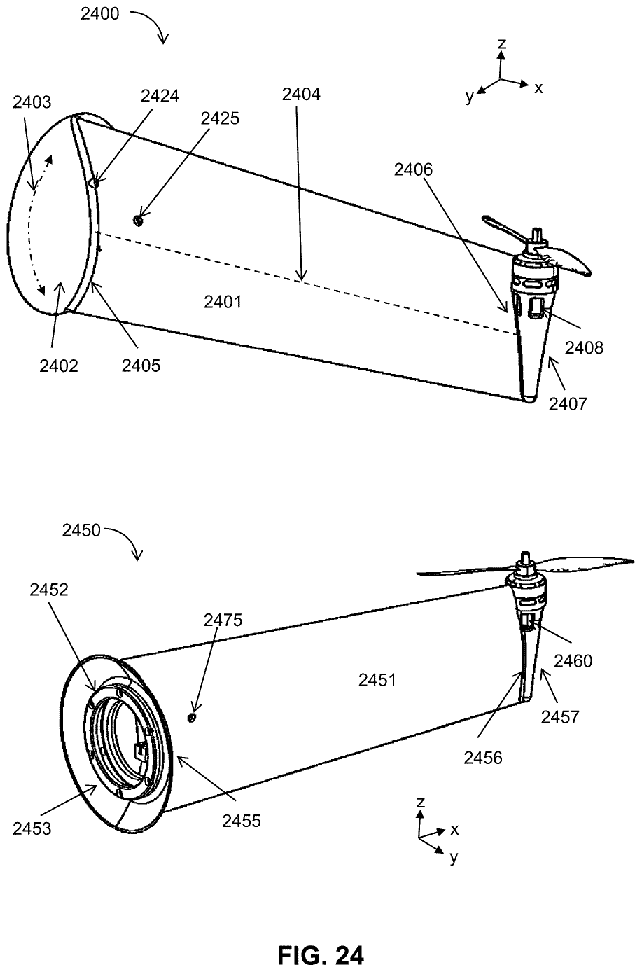

FIG. 24 shows in example 2400 a perspective view of wing 2401 connected to a mount having cover 2402 that can rotate about double sided arrow 2403, e.g., pivot. The rotation can be about long axis 2404 of wing 2401. Wing 2401 has a base 2405 contacting mount cover 2402, and a tip 2406 to which wingtip container 2407 is connected with. Wingtip container 2407 may house lighting, and/or circuitry. Sensors (e.g., proximity sensors) can be disposed in the wingtip container or operatively coupled thereto. The wingtip container can be included in a propeller system.

Access holes can be located around actuators, e.g., to allow its maintenance, testing, and/or assembly, e.g., at locations 2408, 2424, and 2425. The access hole may allow access to a fastener, e.g., of an actuator. Access holes 2424 and 2425 may facilitate fastening the actuator of the wing, e.g., that can rotate the wing about its main axis. Access holes such as 2408 may allow securing the propeller actuator.

FIG. 24 shows in example 2450 a perspective view of wing 2451, which is another view of wing 2401. Wing 2451 is connected to a mount having cover 2452. The mount has components 2453 configured to mount wing 2451, e.g., to a hub of an AV. Wing 2451 has a base 2455 contacting mount cover 2452, and a tip 2456 to which wingtip container 2457 is connected with, wingtip container 2457 being analogous to wingtip container 2407. Wingtip container 2457 has access holes such as 2460, e.g., that can couple to electrical and/or data wiring disposed in the wing (not shown), and allow access to an actuator, to its fastener, and/or to its wiring. Wing 2451 has at least one other access hole 2475. Access hole 2475 is adjacent to mount cover 2453, covering mount 2452, e.g., that can comprise a bearing held by plates as is depicted in FIG. 22.

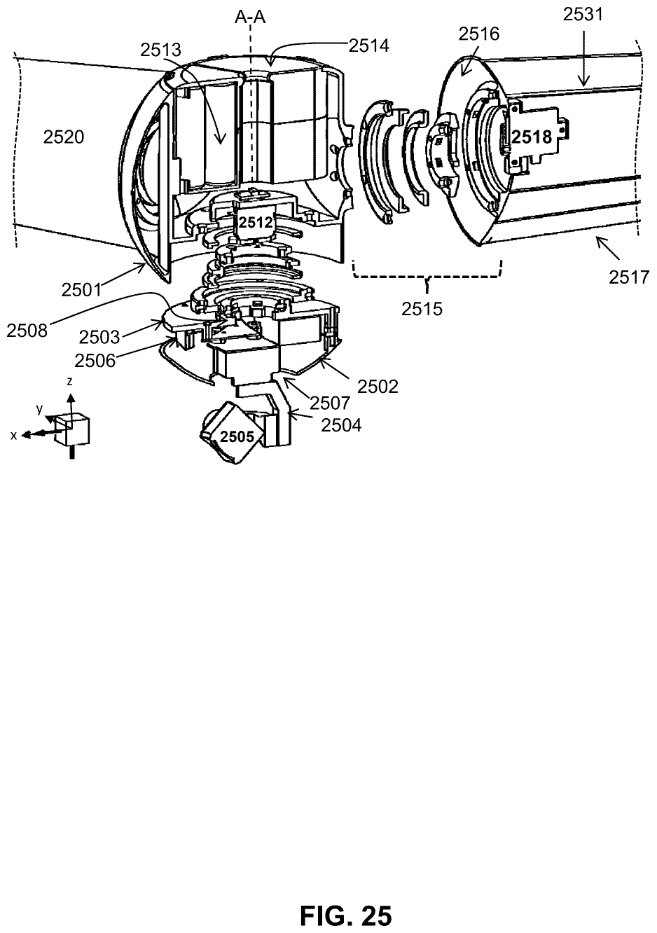

FIG. 25 shows an example of a perspective view of various portions of an AV that is partially exploded. The AV comprises a first hub portion having cover 2501 and second hub portion having cover 2502 being disconnected for illustrative purposes from the first hub portion. The second hub portion comprises platform 2503 to which holder 2504 is connected to. Holder 2504 coupled camera 2505 to platform 2503. Platform 2503 is coupled with cover 2502 of the second hub portion, e.g., via legs such as 2506. Cover 2502 has an aperture 2507 through which holder 2504 protrudes outside of the cover. Platform 2503 comprises an opening 2508 configured to receive a shaft from the first hub portion, the shaft being of a of a rotary connector such as a slipring. The first hub portion comprises actuator 2512 configured to rotate the shaft of the rotary connector. The haft can be coupled with actuator 2512 by a torque coupler, e.g., having an axial float. Actuator 2512 is coupled with the body of the first hub portion having casing 2501. Batteries such as 2513 can provide electrical power to, e.g., actuator 2512. The batteries are disposed in battery holders such as battery holder 2514. The battery holders are disposed in the first hub portion about central axis AA, along which the shaft or the rotary connector may be disposed. The first hub portion includes a mount having components 2515 shown in an exploded view. The mount has casing 2516. The mount 2515 (e.g., bearing thereof) and its casing 2516 are configured to rotate about a long axis of the wing, long axis not shown. Section 2517 of a first AV wing is shown as disconnected from the first hub portion, e.g., for illustrative purposes. Section 2517 of the first wing comprises an actuator 2518. The batteries can provide electrical power to actuator 2518, e.g., to cause the wing to rotate about its long axis. Section 2517 of the AV wing can comprise 2531 that may represent (a) a wall of an inner tube disposed about the long axis of the wing and/or (b) a spar of the wing. The inner tube may house wiring, e.g., operatively coupled with the propellor system (now shown). The first hub portion is shown as connecting to section 2520 of a second wing. In FIG. 25, the rotating shaft of the first hub portion is pointing into the second hub portion. FIG. 25 is shown relative to a Cartesian coordinate system. Any of the wing sections can represent the first portion of the wing having a coupling system such as disclosed herein. Any of the wing sections may be of a wing devoid of a coupling system.

In some embodiments, the AV is configured to facilitate temperature conditioning, e.g., within the hub. The temperature conditioning (e.g., cooling) can be active (e.g., requiring power from a power source such as batteries), and/or passive (e.g., does not require additional input of power). In some embodiments, the temperature conditioning is passive. The temperature conditioning may transpire due to passage of fluid, e.g., gas such as air. The fluid may enter the hub during its operation, e.g., during flight. The fluid may enter through the aperture of the second hub portion's casing, e.g., at the space between the camera holder and the second hub portion's casing. The gas may travel upwards through the interior of the hub such as the interior of the first hub portion, e.g., (a) within the internal walls of the hub, (b) about the (e.g., hourglass shaped) supports, (c) about the rotation mechanism of the hub, (d) about the electrical conduction mechanism of the hub, (e) about the data communication system (e.g., portion thereof) disposed in the hub, (f) about the various circuitries (e.g., PCBs), or (g) within the battery holder(s), (h) about the battery pack(s), (i) about the sensors, (j) any other component which the gas can infiltrate into, or (k) any combination thereof. The rotation mechanism may comprise (A) the rotary connector such as slipring mechanism or (B) the actuator of the hub. The electrical conduction mechanism and/or data communication system, may comprise (i) the rotary connector (e.g., slipring mechanism), (ii) the wiring, or (iii) any other circuitry. The fluid may enter the first hub portion through aeration holes and/or through the slipring mechanism. The fluid may travel through the battery holder(s), and/or the battery pack(s). The fluid may exit the top side of the first hub portion opposing the camera side.

In some embodiments, the AV comprises one or more circuits, e.g., in the form of PCBs.

The circuit(s) may comprise a power board, an electronic speed control, or a carrier board. The power board may direct power from batteries to the other components of the AV requiring power supply. The Electronic speed control may direct power to actuators (e.g., motors) of the AV. The carrier board may route signal(s) between the FMU to appropriate subcomponent(s) (e.g., subsystems). The appropriate subcomponents may comprise an actuator (e.g., a motor), a power board, a circuitry dedicated to the wing, a sensor. The circuitry dedicated to the wing may be disposed in the wing and/or in the hub, e.g., any portion of the wing and/or of the hub, respectively.

FIG. 26 shows, in example 2600, portions of an AV having a first hub portion and a second hub portion. The second hub portion (e.g., turret) comprises casing 2616 having an aperture through which holder 2615 protrudes, the holder coupling camera 2614 to platform 2622 of the second hub portion. The second hub portion comprises an FMU 2613 and a communication system component 2619, e.g., comprising a transceiver. PCB 2613 and communication system component 2619 are coupled with platform 2622. The PCB can comprise an FMU or an IMU. The FMU may comprise, or be operatively coupled with, the IMU. Platform 2622 is coupled with a rotatable central shaft 2609 of a rotary connector that is a slip ring mechanism, which central shaft 2609 is coupled with platform 2622. Casing 2616 of the second hub portion is coupled with platform 2622, e.g., using connectors such as 2625. The first hub portion comprises mounts such as mount 2611, which respectively mount the wings of the AV to the first hub portion. Mount 2611 couples with section 2621 of first wing portion to the first hub portion, and section 2623 of the second wing portion couples with first wing portion 2621. A more detailed manner of mounting the wing of the AV with the first hub portion is illustrated via coupling of first wing portion 2601 to mount 2624. First wing portion 2601 comprises actuator 2604, e.g., a servomotor. First wing portion 2601 is shown as coupled with section 2602 of the second wing portion using a coupling system disposed along broken line 2603, e.g., a coupling system disclosed herein. The first hub portion comprises hub actuator (e.g., servomotor) 2631 configured to rotate a torque coupler comprising axial float 2630. Actuator 2631 and axial float 2630 are supported by a first set of supports comprising support 2605, the supports being coupled with the body of the first hub portion, the supports of the first support set connected their distal ends relative to the first stage, and the connection of the supports at their opposing end comprises a ring having an aperture allowing axial float 2630 to connect with the central shaft 2709 of a rotary connector that is a slip ring mechanism 2634 comprising rings, coils, or brush. Each of the first set of supports (e.g., 2605) has an external face that can be part of a hypotenuse of a right triangle. Each of external face of the first set of supports forms an acute angle with respect to first stage 2633, and each of the first set of supports' external face forms an acute angle with respect the central axis of the hub (not shown) and/or with shaft 2609, which is disposed along the central axis of the hub. The external face of the support is the face further away from the central axis. Electrical power and/or data is provided to the actuators (e.g., motors) using batteries such as battery 2610 disposed adjacent to the casing of the first hub portion, and about the central axis of the hub. The batteries are disposed in battery packs inserted into respective battery holders of the first hub portion. The insertion of the battery pack can be from a (e.g., top) side of the hub opposing camera 2614. The electrical power can be routed from the batteries to a carrier board from which it may be distributed to clients such as the actuators, e.g., using wiring. The data may be routed from the FMU. Actuator 2631 is coupled with first stage 2633 to which a navigation system (e.g., GPS) is coupled with, e.g., via circuitry (e.g., printed circuit board (PCB)) 2606. It may be advantageous to locate the navigation system close to the top end of the hub pointing upwards during flight relative to the ambient gravitational vector pointing towards the gravitational center of the external environment to the AV, e.g., such that the navigation unit may may receive satellite signals. The inertial mechanism of the hub is shielded by a first cover 2632 and an optional section cover, not shown. A portion of the slip ring 2634 mechanism excluding the central shaft, is disposed in the first hub portion, coupled with a second stage 2618 having, or being coupled with, a second set of supports including support 2617. Each of the second set of supports has a base larger than their top portion, the base being closer to the camera than their top. The second set of supports are connected at their top by a ring comprising an aperture through which the central rotating shaft 2609 of the slip ring mechanism and/or torque coupler 2630 penetrate through. Each of the second set of supports (e.g., 2617) has an external face that can be part of a hypotenuse of a right triangle. Each of the second set of supports' external face forms an acute angle with respect to second stage 2618, and each of the second set of supports' external face forms an acute angle with the central axis of the hub (not shown) and/or with shaft 2609. The external face of the support is the face further away from the central axis. Seconds stage 2618 comprises half of (e.g., either male or female) a member of a connector mating pair 2612 configured to transmit power and/or data, the other half being of the battery pack.

Example 2650 of FIG. 26 shows the AV of example 2600 having central axis A-A. The second hub portion is marked by broken line 2655. The first hub portion can rotate about central axis A-A relative to second hub portion 2655. During flight, the first hub portion can rotate to cause rotation of the wings mounted with the first hub portion, e.g., in S-MOD, while the camera of the section portion of the hub is directed during flight to (e.g., fixed on) a target comprising a location or a direction, the target disposed externally to the AV. The target may be disposed in an indoor environment or in an outdoor environment. The hub facilitates gas flow therethrough, e.g., during operation. The gas may condition an internal temperature of the hub, e.g., the gas may be utilized for cooling. The gas (e.g., air) can enter the aperture at the bottom side of the hub, e.g., where the camera is disposed. Gas can enter and travel in the hub such as schematically depicted along broken lines 2653 and 2654. The gas can schematically exit from the hub broken lines 2651 and 2652. In FIG. 26, the rotating shaft of the second hub portion is pointing into the volume enclosed by the casing of the first hub portion. The first support set and the second support set in FIG. 26 forms together an hourglass-like structure, the interior of which accommodates the rotating shaft of the rotary connector, e.g., the slip ring mechanism. The hourglass like structure may be symmetric or non-symmetric with respect to a plane perpendicular to its long axis, the symmetry plane being disposed at the narrowest point of the hourglass. In the example shown in FIG. 26, the imaginary hourglass-like structure engulfing the support s is non-symmetric with respect to a plane perpendicular to its long axis, the symmetry plane being disposed at the narrowest point of the hourglass. FIG. 26 is shown relative to respective Cartesian coordinate systems.

In some embodiments, the hub comprises portions. At least two of the portions can rotate one with respect to each other. At least two of the portions can rotate one with each other. In an example, the hub comprises three portions wherein (a) the first hub portion rotates with respect to the second hub portion, and (b) the third hub portion rotates with the first hub portion. During flight, the first hub portion can rotate and cause rotation of the wings, e.g., in S-MOD, while the camera of the section portion of the hub is directed to (e.g., fixed on) a target. The third hub portion may be a distal portion opposing the second hub portion. The first hub portion can be disposed between the third hub portion and the second hub portion. The third hub portion may comprise a navigation system such as one requiring satellite communication, e.g., GPS. The second hub portion may comprise sensor(s) such as a camera. The first hub portion may be operatively coupled with the wings of the AV and may comprise a hub actuator causing the wings to rotate about a central axis of the hub such as when the AV flies in S-MOD, e.g., while the camera of the second hub portion is directed to the target is does not rotate with the first hub portion. The first hub portion may comprise a carrier board to route the electrical power of the hub from the power source of the hub to various clients. The clients may comprise actuators, circuit boards, sensors, lighting, or any other component of the AV requiring electricity to operate. The circuit board may comprise a processor, an inertial measuring unit (IMU), or a controller such as an FMU. The FMU may comprise or be operatively coupled with the IMU. The IMU may be configured to adequately (e.g., reliably and/or accurately) operate when it rotates up to a maximum rotational speed threshold, e.g., the IMU's gyroscope. The first portion may rotate above the maximum rotational speed threshold that the IMU can accurately and/or reliably measure. The IMU may be operatively coupled with the FMU or may be part of the FMU, e.g., embedded in the FMU. The IMU may be configured to measure a maximum rotational speed threshold of at most about 350 rotations per minute (RPM), 300 RPM, 250RPM, 200 RPM, or 150 RPM. The first hub portion may be configured to rotate at a speed of at least about 150 RPM, 200 RPM, 250 RPM, 300 RPM, 330 RPM, 400 RPM, 500 RPM, 700 RPM, 800 RPM, 830 RPM, or 850 RPM. The first hub portion may be configured to rotate at a speed between any of the aforementioned speeds, e.g., from about 150 RPM to about 250 RPM, from about 350 RPM to about 400 RPM, from about 500RPM, to about 850 RPM, or from about 200 RPM to about 850 RPM. The IMU may be configured to measure absolute angular velocity and/or absolute acceleration. The IMU may be utilized for navigation of the AV in space during use. To facilitate operation of the IMU, it may be advantageous to locate it in the second hub portion that minimally rotates with respect to the first hub portion, e.g., during operation of the AV. The (rotary) encoder may be configured to measure relative angular velocity and/or angular acceleration. The IMU may facilitate correction of measurements of the encoder, e.g., to keep the AV and its camera aligned with its target of flight such as in a decoupled manner from the rotation of the first hub portion and/or rotation of the wings.

In some embodiments, portions of an AV having a first hub portion, a second hub portion, and a third hub portion. The first hub portion may rotate relative to the second hub portion. At least one of the hub portions may rotate relative to another hub portion. In an example, the first hub portion rotates relative to the second hub portion. The third hub portion may comprise a third stage. A circuitry and/or a sensor may be operatively coupled with the third stage. A navigation system (e.g., GPS) may be coupled with the third stage. An on/off button may be disposed in a hub portion, e.g., in the third hub portion. The hub may comprise a casing that may comprise an aeration hole, e.g., to facilitate gas circulation such as for temperature conditioning of the interior of the hub including during use. In an example, the third hub casing comprises an aeration hole.

The aeration hole may comprise round or an elongated shape. Circumference of the aeration hole may be devoid of (a) a non-curved (e.g., straight) line such as a side and/or (b) a corner. The aeration hole may have a cross section of an ellipse such as a circle, or a curved shape such as a bent capsule, or a bent stadium. The aeration holes may be adjacent to the battery holder opening such as in the casing of the third portion. The aeration holes may be configured to allow gas to flow adjacent to the batteries during use of the AV. A casing of one hub portion may be coupled (e.g., by fasteners) to a casing of another hub portion. In an example, a casing of a third hub portion is coupled with the casing of the first hub portion, e.g., using fasteners such as disclosed herein. At least one of the hub portions may rotate relative to at least one other of the hub portions. In an example, the first hub portion rotates relative to the second hub portion, e.g., about the central axis of the hub. At least one of the hub portions may rotate with at least one other of the hub portions. In an example, the first hub portion rotates with the third hub portion. The wings may be coupled with one of the hub portions, e.g., a rotating hub portion about the central axis. In an example, during use, the first hub portion rotates about the central axis to cause rotation of the wings, e.g., in S-MOD flight. The third hub portion may be disposed at one end of the hub opposing the second hub portion. Components of the hub may be disposed in a hub portion depending at least in part on (a) rotational speed of the hub portion, (b) vicinity to the ground, or (c) optimal interconnection. In an example, an IMU of the AV is disposed in a hub portion having a lower (or no) rotational speed during use of the AV than another portion of the hub. In an example, a navigation system (e.g., GPS) of the AV is disposed in a third hub portion being more distant from the ground during use of the AV, than another portion of the hub. The casing of the hub portions may contribute to a spherical external shape of the hub, e.g., together with the casing of the wing mounts. At least one casing of a hub portion may have at least one aperture/hole open to the ambient environment external to the AV. In an example, a casing of the second portion of the hub comprises an aperture, and a casing of the third hub comprises aeration hole(s).

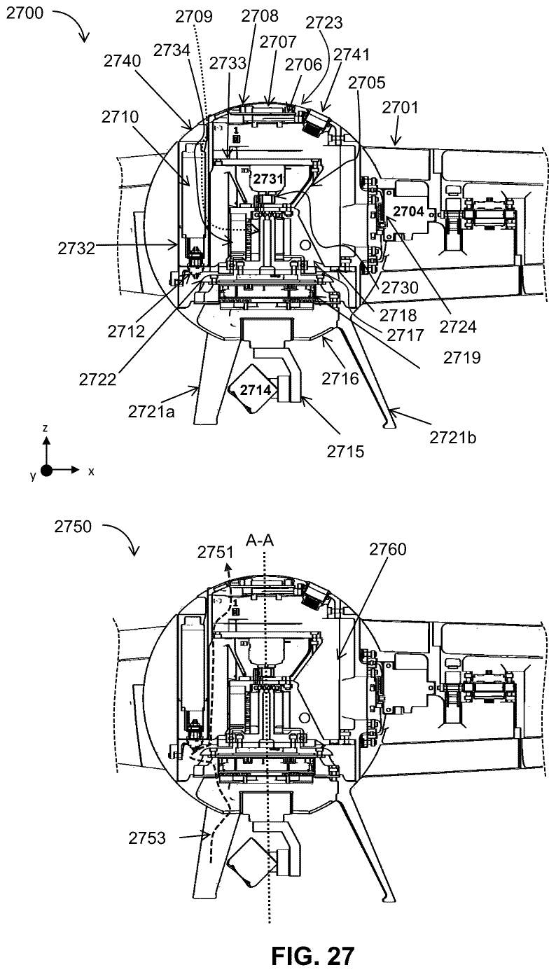

FIG. 27 shows in example 2700, portions of an AV having a first hub portion, a second hub portion, and a third hub portion. The second hub portion (e.g., turret) comprises casing 2716 having an aperture through which holder 2715 protrudes, the holder coupling camera at 2714 to platform 2722 of the second hub portion. The second hub portion is coupled with a PCB and a communication system component (e.g., hub) 2719, e.g., comprising a transceiver. The PCB may comprise an FMU or an IMU, e.g., as disclosed herein. Platform 2722 is coupled with a rotatable central shaft 2709 of a rotary connector that is a slip ring mechanism, which central shaft 2709 is coupled with platform 2722. Casing 2716 of the second hub portion is coupled with platform 2722, e.g., using fasteners such as connectors. The first hub portion comprises mounts, each of which respectively mount the wings of the AV to the first hub portion. First wing portion 2701 is mounted through mount 2724 to the first hub portion. First wing portion 2701 comprises actuator 2704 (e.g., servomotor). The first hub portion comprises a hub actuator (e.g., servomotor) 2731 configured to rotate a torque coupler comprising axial float 2730. Actuator 2731 and axial float 2730 are supported by a first set of supports comprising support 2705, the supports being coupled with the body of the first hub portion, the supports of the first support set connected at their distal ends relative to the first stage, and the connection of the supports at their opposing end comprises a ring having an aperture allowing axial float 2730 to connect with the central shaft 2709 of a rotary connector that is a slip ring mechanism 2734 comprising rings, coils, or brush. Each of the first set of supports (e.g., 2705) has an external face that can be part of a hypotenuse of a right triangle.

Each of external face of the first set of supports forms an acute angle with respect to first stage 2733, and each of the first set of supports' external face forms an acute angle with respect the central axis of the hub (not shown) and/or with shaft 2709, which is disposed along the central axis of the hub. The external face of the support is the face further away from the central axis.

Electrical power is provided to the actuators (e.g., motors) using batteries such as battery 2710 disposed adjacent to the casing of the first hub portion, and about the central axis of the hub. The batteries are disposed in battery packs inserted into respective battery housings of the first hub portion. The battery pack has a lid having a curved face 2740 flush with the spherical (e.g., ball) shape of the exterior (e.g., skin) of the hub. Flush with can be continuing a plane, or as part of a plane such as a curved plane. The battery pack is inserted into battery holder 2732 disposed in the first hub portion. The insertion of the battery pack can be from a (e.g., top) side of the hub opposing camera 2714. The electrical power is routed from the batteries to a carrier board disposed on first stage 2733 and distributed from the carrier bord to clients such as the actuators, e.g., using wiring. The carrier board is disposed on a face of the first stage opposing the camera and opposing the second stage. Actuator 2731 is coupled with first stage 2733 at a side facing the second stage and facing the camera. The third hub portion comprises third stage 2706 to which to which a navigation system (e.g., GPS) is coupled with, e.g., through circuitry (e.g., PCB). Third hub portion casing 2723 accommodates an on/off button 2741 of the AV. Casing 2723 may comprise an aeration hole, e.g., to facilitate gas circulation such as for temperature conditioning of the interior of the hub, e.g., during use. Third hub portion casing 2723 is coupled with the third stage by fasteners comprising leg 2708. The third hub portion can couple to the first hub portion via fastener(s) and/or couplers such as any of those disclosed herein. The hub comprises structural aids comprising legs 2721a-b. A portion of the slip ring mechanism excluding the central shaft of the rotatory coupler (e.g., slipring) is coupled with the first hub portion. A portion of the rotary connector 2734 comprising the central shaft is coupled with second stage 2718 having, or coupled with, a second set of supports such as support 2717, e.g., second set of supports disclosed herein. Second stage 2718 comprises half of (e.g., either male or female) an electrical connector pair 2712 for transmitting, e.g., electrical power.

Example 2750 of FIG. 27 shows the AV of example 2700 having central axis A-A. The first hub portion can rotate about central axis A-A relative to the second hub portion. The third hub portion can rotate with the first hub portion. During flight, the first hub portion can rotate and cause rotation of the wings, e.g., in S-MOD, while the camera of the section portion of the hub is directed to (e.g., fixed on) a target. The hub facilitates gas flow therethrough, e.g., during operation. The gas may condition the temperature of the hub's interior, e.g., that gas may be utilized for cooling. The gas can enter the aperture at the bottom side of the hub, e.g., where the camera is disposed. Gas can enter and travel in the hub such as schematically depicted along broken line 2753. The gas can schematically exit from the hub broken line 2751, e.g., through aeration hole(s). In FIG. 27, the rotating shaft of the second hub portion is pointing into the volume enclosed by the casing of the first hub portion, e., and by surrounding inner wall(s) 2760. In other embodiments, the rotary connector may be disposed in a reverse manner, where the rotating shaft points into the volume enclosed by the casing of the second hub portion.

FIG. 28 shows portions of an AV depicted in FIG. 27, in perspective view. The AV comprises a first hub portion, a second hub portion, and a third hub portion. The second hub portion (e.g., turret) comprises casing 2816 having an aperture through which holder 2815 protrudes, the holder coupling camera at 2814 to platform 2822 of the second hub portion. The second hub portion is coupled with a PCB and a communication system component 2819, e.g., comprising a transceiver. The PCB may comprise an FMU or an IMU, e.g., as disclosed herein. Platform 2822 is coupled with a rotatable central shaft 2809 of a rotary connector that is a slip ring mechanism, which central shaft 2809 is coupled with platform 2822. Casing 2816 of the second hub portion is coupled with platform 2822, e.g., using fasteners such as connectors. The first hub portion comprises mounts, each of which respectively mount the wings of the AV to the first hub portion.

First wing portion 2801 is mounted through mount 2824 to the first hub portion. First wing portion 2801 comprises actuator 2804, e.g., servomotor. The first hub portion comprises a hub actuator (e.g., servomotor) 2831 configured to rotate a torque coupler comprising axial float 2830. Actuator 2831 and axial float 2830 are supported by a first set of supports comprising support 2805, the supports being coupled with the body of the first hub portion, the supports of the first support set connected at their distal ends relative to the first stage, and the connection of the supports at their opposing end comprises a ring having an aperture allowing axial float 2830 to connect with the central shaft 2809 of a rotary connector that is a slip ring mechanism 2834 comprising rings, coils, or brush. Each of the first set of supports (e.g., 2805) has an external face that can be part of a hypotenuse of a right triangle. Each of external face of the first set of supports forms an acute angle with respect to first stage 2833, and each of the first set of supports' external face forms an acute angle with respect the central axis of the hub (not shown) and/or with shaft 2809, which is disposed along the central axis of the hub. The external face of the support is the face further away from the central axis. Electrical power is provided to the actuators (e.g., motors) using batteries such as battery 2810 disposed adjacent to the casing of the first hub portion, and about the central axis of the hub. The batteries are disposed in battery packs inserted into respective battery housings of the first hub portion. The battery pack has a lid having a curved face 2840 flush with the spherical (e.g., ball) shape of the exterior (e.g., skin) of the hub. The battery pack is inserted into battery holder 2832 disposed in the first hub portion. The insertion of the battery pack can be from a (e.g., top) side of the hub opposing camera 2814. The electrical power is routed from the batteries to a carrier board disposed on first stage 2833 and distributed from the carrier bord to clients such as the actuators, e.g., using wiring. The carrier board may comprise a PCB board. The carrier board is disposed on a face of the first stage opposing the camera and opposing the second stage. Actuator 2831 is coupled with first stage 2833 at a side facing the second stage and facing the camera. The third hub portion comprises third stage 2806 to which to which a navigation system (e.g., GPS) 2807 is coupled with e.g., through circuitry (e.g., PCB).

Third hub portion casing 2823 accommodates an on/off button 2841 of the AV. Casing 2823 comprises aeration holes such as hole 2808, e.g., to facilitate gas circulation such as for temperature conditioning of the interior of the hub, e.g., during use. Third hub portion casing 2823 is coupled with the third stage by fasteners comprising legs. The third hub portion can couple to the first hub portion via fastener(s) and/or couplers such as any of those disclosed herein. The hub comprises structural aids comprising legs 2821a-b. A portion of the slip ring mechanism excluding the central shaft of the rotatory coupler (e.g., slipring) is coupled with the first hub portion. A portion of the rotary connector (slipring) 2834 comprising the central shaft is coupled with second stage 2818 having, or coupled with, a second set of supports such as support 2817, e.g., second set of supports disclosed herein. Second stage 2818 comprises half of (e.g., either male or female) an electrical connector pair 2812 for transmitting, e.g., electrical power.

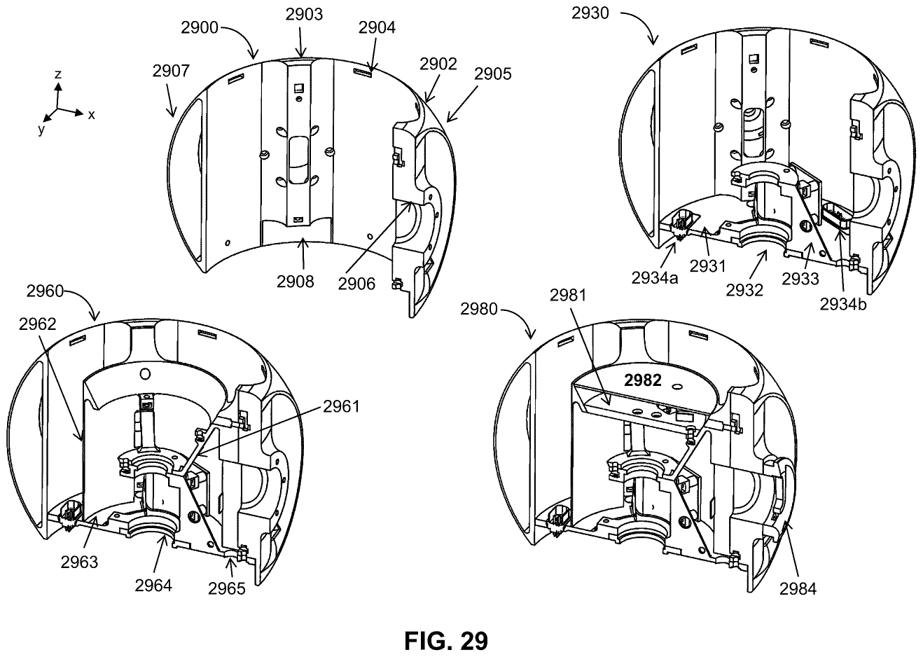

FIG. 29 shows various assembly stages and components of the hub of an AV. Example 2900 shows the body of the first hub portion having a truncated top face 2902 configured for disposition away from the camera, top face 2902 has beveled portions such as beveled portion 2903, e.g., configured to guide battery pack into the first portion of the hub from top face 2902 in a direction into the hub. The beveled portion 2903 continues vertically into the interior of the first hub portion up to its opposing (and symmetrical) beveled end 2908 with vertically being along the Z direction of the Cartesian coordinate system. The end 2908 of the beveled wall portion is configured to connect with a second stage, e.g., 2931 of example 2930 in FIG. 29. The body comprises depressions such as 2904 configured to secure fastener (e.g., tab) of the battery back, e.g., to secure the battery packs with the body of the first hub portion. The body comprises truncated side faces corresponding to each of the wings, e.g., three side faces for the three wings. The truncated face 2905 has a round opening 2906 for mounting a wing onto the side face 2905. Example 2900 shows a mount cover 2907 covering the mount and continuing the spherical shape of the hub. Example 2930 shows second planar stage 2931 disposed in the body of the hub, the second stage having aperture 2932 (e.g., opening such as a hole) including, or operatively coupled with, a second set of supports such as support 2933. The support may comprise one or more perforations, e.g., to lower the weight of the supports. Support 2933 comprises two perforations. The perforations may aid in circulation of the temperature conditioning gas, e.g., cooling gas. The support has an edge slanting towards the central axis of the hub. The support having a base larger than its opposing tip, the tips of the supports being connected by a second ring having an aperture configured to freely accommodate a rotating shaft of a rotary connector, e.g., a slip ring mechanism. Second stage 2931 is secured to the body of the first hub portion.

Electrical connector members 2934a and 2934b are disposed in the second stage 2931, e.g., to be operatively coupled with batteries having each of their respective mating member. Example 2960 shows the first set of slanted supports configured to hold a first stage (not shown), including support 2961. The first set of supports start at a plane and progress towards the side of the camera in a slanted configuration towards the central axis where they become connected by a first ring. The first ring is disposed above (e.g., and can connect with) the second ring. The first ring has an aperture configured to freely accommodate a rotating shaft of a rotary connector, e.g., a slip ring mechanism (not shown). The first ring resting on the second ring. In some embodiments, the first ring is substituted by a first hollow polygon, e.g., the edges of the polygon corresponding to the number of supports in the first set of supports. The first support tip may be disposed at the edge of the first polygon. In some embodiments, the second ring is substituted by a second hollow polygon, e.g., the edges of the polygon corresponding to the number of supports in the first set of supports. The second support tip may be disposed at the edge of the second polygon. The first support set is part of, or is operatively coupled with, a vertical interior wall 2962 configured to form a section of the battery holder, with vertical being along the Z direction of the Cartesian coordinate system. Another section of the battery holder is formed by the body of the first hub portion, e.g., comprising beveled portion 2903. Wall 2962 is configured to shield the interior mechanism of the hub from the power maintenance process, e.g., reversibly inserting and extracting the battery packs. Second stage 2963 is shown as connected to bearing 2964 (e.g., ball bearing) for connection to the platform of the second hub portion. Second stage 2963 has an opening 2965 (e.g., hole) to facilitate passing of gas, e.g., for temperature conditioning such as a cooling gas.

Example 2980 shows first stage 2981 supported by the first support set, above which cover 2982 is disposed, to shield the interior of the hub mechanics during use of the AV, e.g., during flight. A bearing such as 2984 is connected to the side opening of the body of the first hub portion, e.g., to allow rotation and mounting of a wing onto the hub, the rotation being about a long axis of the wing. FIG. 29 is shown relative to a Cartesian coordinate system.

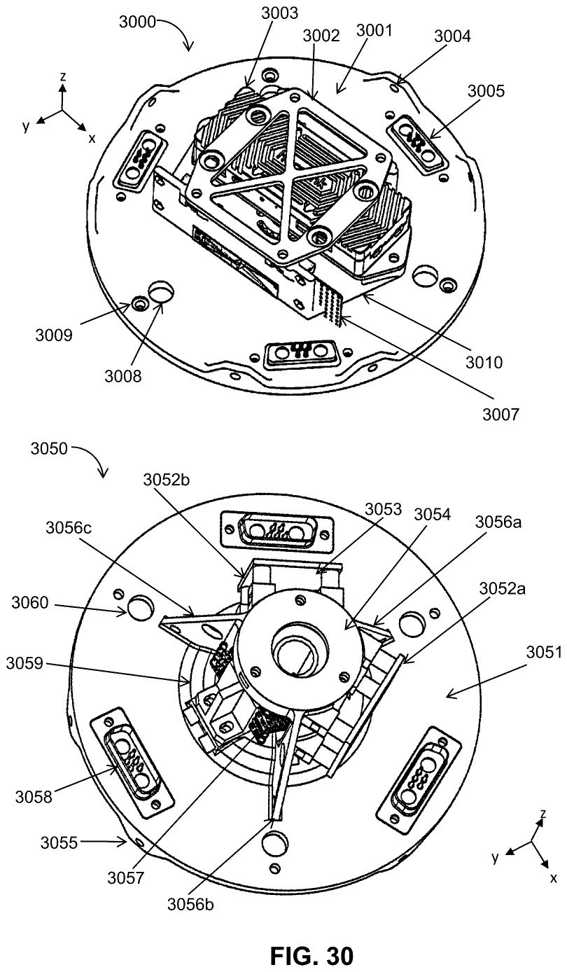

FIG. 30 shows in example 3000 a perspective view of the bottom part of the second stage 3001 facing the second hub portion, part of which is shown. The second hub portion comprises platform 3010 with which a circuitry 3007 (e.g., PCB) comprising an FMU, and a communication system component (e.g., port) 3003 comprising a transceiver are coupled, held by brace 3002. The FMU may comprise an IMU. The holder of the camera (not shown) may be coupled with brace 3002, e.g., held by fasteners secured to its holes such as screws. Second stage 3001 is held by fasteners (e.g., screws) to the body of the first hub portion's casing by fasteners engaged with vertical fastener holes such as 3004 disposed along the circumference of second stage 3001, with vertical being along the Z direction of the Cartesian coordinate system. Each of the vertical fastener holes is disposed in a tab extension of the second stage pointing downwards towards the end of the hub comprising the camera (not shown). Second stage 3001 comprises horizontal fastener holes such as 3009, each disposed immediately adjacent to the aeration holes (e.g., 3008) forming a pair, with horizontal being along the XY plane of the Cartesian coordinate system. The horizontal fastener hole is disposed closer to the circumference of the second stage relative to the aeration hole. The aeration hole has a radius greater than that of the horizontal fastener hole. The horizontal fastener hole may aid in coupling the vertical walls of the battery holder(s) to the second stage. The aeration holes may aid in relieving (A) over pressure formed on compressing the battery pack(s) into the battery holder(s) and/or (B) under pressure formed on extracting the battery pack(s) from the battery holder(s). The gas utilized in the equilibration process may be extracted from and/or released into, the second hub portion having an aperture facing the ambient environment. Second stage 3001 comprises aeration holes such as 3008, e.g., for fluid passage such as gas passage and/or for reducing the weight of the stage. The aeration holes of the second stage can facilitate pressure equilibration between the first hub portion and the second hub portion and/or temperature conditioning within the hub. The second stage may comprise three aeration holes arranged equidistant close to the periphery of second stage 3001 and following its circumference along a smaller radius than the radius of the second stage.

Second stage 3001 comprises (e.g., electrical) connector members such as 3005, arranged equidistant close to the periphery of second stage 3001 and following its circumference along a smaller radius than the radius of the second stage. The aeration holes may be arranged interchangeably (e.g., interlacing) with the (e.g., electrical) connector members disposed at the second stage and surround the central axis of the hub (not shown). Example 3050 shows a top view of the second stage 3051 shown as a bottom view in example 3000, as second sage 3001.

The second stage 3051 comprises (a) top portions of (e.g., electrical) connector members such as 3058, and (b) aeration holes such as 3060, arranged close to the periphery of stage 3051 interchangeably and equidistantly. The aeration holes and (e.g., electrical) connector members are arranged equidistantly, close to the periphery of second stage 3051, and following its circumference along a smaller radius than the radius of the second stage. The aeration holes and (e.g., electrical) connector members are disposed at the second stage and surround the central axis of the hub (not shown) and the rotary connector that is a slip ring mechanism. Each of the three members 3056a-c of the second support set comprise a bottom disposed on the second stage and terminate at second ring 3054 connecting terminals of the second support set members. Second ring 3054 comprises a central aperture (e.g., opening) through which a torque coupling axial float 3053 can protrude, which can be coupled with a central shaft of a slip ring mechanism. The slip ring mechanism is held by brackets 3052a and 3052b. The slip ring mechanism 3057 comprises rings/coils. Vertical fastener holes such as 3055 facilitate coupling the second stage with the body of the first hub portion, e.g., using fasteners such as screws. Each of the vertical fastener holes is disposed in a vertical tab extension of the second stage pointing downwards towards the end of the hub comprising the camera (not shown). The tab extensions can be arranged equidistantly along the circumference of the second stage. The tab extensions can be arranged in pairs (e.g., three pairs). The tab extension pair can be arranged equidistantly along the circumference of the second stage. The tab extension can form an angle with the plane of the (planar) second stage. The angle can be right angle, acute angel, or obtuse angle. FIG. 30 shows the tab forming a (e.g., substantially) right angle with the plane of the second stage. FIG. 30 is shown relative to respective Cartesian coordinate systems. Different feature types associated with the second stage, the features comprising the aeration holes, horizontal fastener holes, (e.g., electrical) connector members, members of the second support set, or the vertical fastener holes. Members of each type of the feature type can be arranged symmetrically about the central axis going through and perpendicular to the center of the second stage.

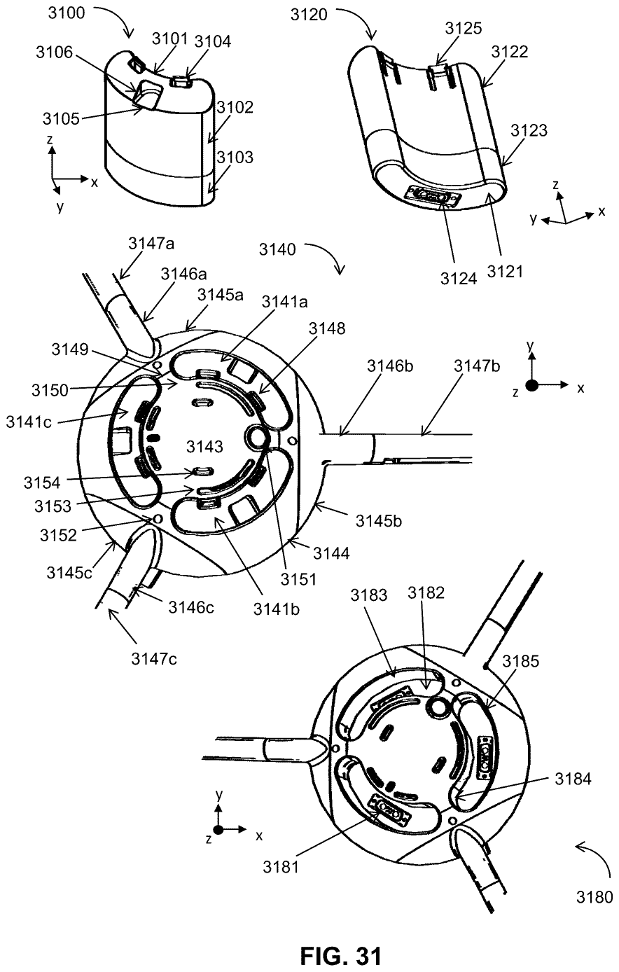

FIG. 31 shows in example 3100 a perspective view of battery pack having a (e.g., bent) top section that is cured. Battery pack 3100 extends vertically along the Z axis of the Cartesian coordinate system, having a height. The battery pack has a lower section 3103 that is stationary, and an upper section 3102 that can be removable or stationary. The battery pack has a top section 3101 that (A) can be openable when upper section 3102 is stationary or (B) adhere to (e.g., coupled with) or be part of upper section 3102 to form an openable upper section of the battery back when upper section 3102 is removable. Fasteners (e.g., two tabs) are arranged along the arch of section 3101 having the smaller radius, e.g., fastener 3104. Each of the fasteners is arranged in a respective depression in the skin of the upper section 3102 and of the top section 3101. The fastener can engage with the body of the first hub portion forming the battery holder or with a casing of a third portion of the hub. Battery pack 3100 comprises depression 3105 that can be used to pull the battery pack out of the battery holder of the AV and/or for opening the battery pack. Depression 3105 is located at the side of the battery pack having the longer arch, depression 3105 being disposed adjacent to the top of the battery pack, centered at the longer arch. The depression disposed at a side of the battery pack opposing the fasteners. In other embodiments, the fasteners are disposed at the side of the battery pack having the longer arch, and the depression is disposed at the side having the shorter arch. The top of the battery pack 3100 is not parallel to the horizontal cross section, but rather angled with respect to the horizontal cross section with an acute angle 3106. The top of the battery pack is configured to continue the spherical shape of the hub when inserted into the hum, e.g., as shown in FIGS. 27, 2740.

Example 3120 shows another perspective view of battery pack 3100 from its bottom side. Battery holder 3120 comprises upper portion 3122 and lower portion 3123, e.g., respective portions 3102 and 3103. The bottom end 3121 of battery portion 3120 comprises (e.g., electrical) connector members 3124. The connector member may be configured to couple with a mating connector member disposed at the top portion of the second stage facing the battery packs, e.g., 2858. Battery pack 3120 has a vertical cross section along XY plane that comprises long sides that are curved to form a shape of a bent capsule, bent stadium, or a cross section of a sausage along its long axis, as can be seen in bottom section 3121. The horizontal cross section of the battery pack may be devoid of corners, e.g., enhancing its ease of use, ergonomic shape, and/or durability. The circumference of the horizontal cross section of the battery pack (e.g., bottom 3121) comprises two arches of two concentric circles having two radii. Each of the sides connecting the two arches is curved, e.g., is part of a circle.

Example 3140 shows a top view of an AV in which the battery packs are inserted. Battery packs 3141a-c are engaged with the body of the first hub portion using fasteners such as 3148, each battery back having two fasteners at its inner arched circumference. In some embodiments, the fasteners are located in the outer circumference. The battery packs encircle the central axis of the hub (not shown). The battery packs have a cross section of a bent capsule or bent sausage.

The body of the first hub portion having smoothly (e.g., rounded) beveled edges (e.g., 3149) respective of the round edges of the horizontal cross section of the battery pack, along plane XY of the Cartesian coordinate system. The beveled edges of the first hub portion's body contact beveled edges of the internal wall(s) disposed in the first hub body (e.g., 3150), which together form at least in part of the battery holders. The third hub portion has a cover 3143 (e.g., cap). A casing of the first hub portion can be secured by three fasteners access holes at locations such as 3151, e.g., screws. The first hub portion comprises casing 3144. Three mount casings 3145a-c are each coupled with the first hub portion casing 3144 and form a circumference similar to a circle.

Three first wing portions 3146a-c are each coupled with its respective mount 3145a-c. Three second wing portions 3147a-c (section of which are shown) are each coupled with its respective first wing portions 3146a-c. Each of the first wing portion is coupled with the second wing portion using a coupling system. Third hub casing shows an on/off button of the AV 3151 and aeration holes such as 3153 to facilitate temperature conditioning within the hub. The casing of the third hub over comprises windows for lights such as window 3154.

Example 3180 shows a top view of the AV of example 3140, in which the battery packs are extracted. Battery holders such as 3185 are arranged corresponding to the battery packs, e.g., 3141a-c. The bottom of the battery holder is generated by the second stage 3182. At the bottom of each battery holder, an (e.g., electrical) connector member such as 3181 is disposed, e.g., to mate with a respective connector mating member of the battery pack, e.g., 3124. The battery holder sides are formed by contacting (e.g., and coupling) the body of the first hub 3183 with interior vertical wall(s) 3184 of the first hub portion. FIG. 31 is shown relative to respective Cartesian coordinate systems.

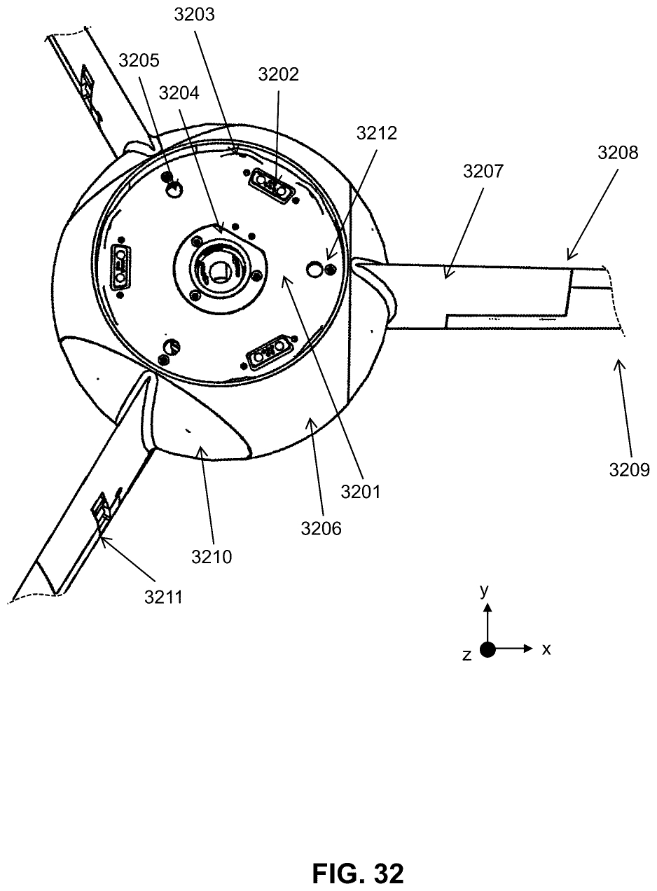

FIG. 32 shows an example of a bottom perspective view of the AV devoid of the second hub portion, in which a bottom side of the second stage 3201 is shown, the second stage comprising interlacing arrangement of (a) (e.g., electrical) connector members such as 3202 and with (b) aeration holes 3205 paired with horizontal fastener holes such as 3212 along plane XY of the Cartesian coordinate system, the arrangement being along a central axis of the hub and adjacent to the circumference of the second stage. Vertical holes arranged in tabs such as 3203 are disposed at the circumference of the second stage and point towards the bottom end of the first hub portion to face the camera (not shown), the vertical holes being vertical along the Z direction of the Cartesian coordinate system. Coupler 3204 (e.g., coupling plate) is disposed at the center of the second stage, to facilitate coupling of the second hub portion (e.g., the turret) to the first hub portion, and/or to facilitate securing the slipring mechanism portion coupled with the second stage. The first hub portion is coupled with wings, each having a first wing portion (e.g., 3207) coupled with a second wing portion (3209) by a coupling system along line 3208, the coupling system comprising a fastener such as 3211 (e.g., a latch). Each of the wings is coupled with the first hub portion by a respective mount, having a mount casing such as 3210. FIG. 32 is shown relative to a Cartesian coordinate system.

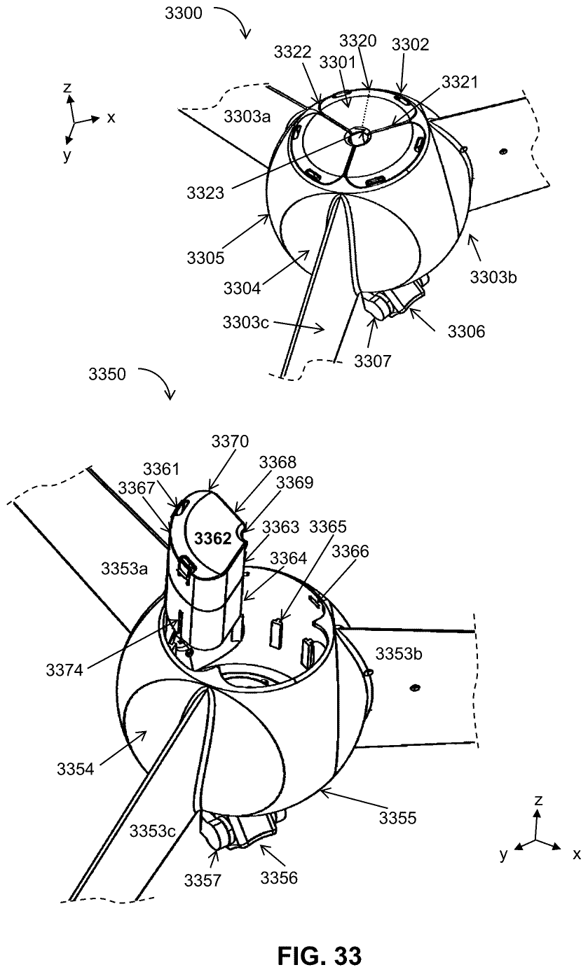

FIG. 33 shows in example 3300 an AV having battery packs inserted into the hub (e.g., first hub portion). The three battery packs (e.g., 3301) have a horizontal cross section similar to a flower petal, the horizontal cross section being along plane XY of the Cartesian coordinate system. The circumference of the horizontal cross section comprises an outer longer arch ending at two curved edges such as edge 3322. The horizontal cross section is symmetric with respect to a height 3320 perpendicular to the outer (and longer) arch at the middle point. A circumference of the horizontal cross section comprises two straight sides such as side 3321, each straight (e.g., non-curved) side ending at one of their ends at the curved edge (e.g., 3322). The circumference of the horizontal cross section comprises a smaller inner arch 3323 opposing the longer outer arch. Each of the straight sides ending at an end of the smaller arch. Stated otherwise, the straight sides are disposed in the sides connecting the larger arch with the smaller arch to form the circumference of the horizontal cross section of the battery pack. In the example of 3300, the horizontal cross section is depicted by the top cap of the battery cap disposed at the side of the hub opposing camera 3306. Each battery pack is secured with a fastener such as 3302, to the body of the hub. The fasteners are disposed along the longer arch of the circumference of the horizontal cross section of the battery pack, bordering its top side. The hub comprises casing 3305 and three side mounts each of which mounts a wing to the hub, the wings being 3303a-c. Each of the mounts are encased by a mount casing such as 3304. The wings, mount casings, battery caps, battery holders, fasteners, and tabs, are arranged symmetrically about the central axis of the hub (not shown). Camera 3306 is held by holder 3307 coupled with the hub.

Example 3350 shows the AV of example 3300 having battery packs extracted from the hub. The circumference of the horizontal cross section of the battery back is shown by the top section 3362, which comprises an outer longer arch 3367 ending at two curved edges such as edge 3370. A circumference of the horizontal cross section comprises two straight sides such as side 3368, each straight (e.g., non-curved) side ending at one of their ends at the curved edge, e.g., 3370. The circumference of the horizontal cross section comprises a smaller inner arch 3369 opposing the longer outer arch. Each battery pack can be secured with a fastener such as 3361, to the body of the hub, e.g., connecting at depression such as 3366. The battery pack comprises (e.g., two) elongated insert(s) (e.g., depression(s)) such as 3374. The depression(s) are configured to engage with guides such as guide 3365, that are part of, or operatively coupled with, the internal surface of the body of the hub. The battery packs have a vertical height (e.g., substantially) normal to the horizontal cross section, the vertical height being along the Z direction of the Cartesian coordinate system. The battery pack has a lower section 3364 that is stationary, and an upper section 3363 that can be removable or stationary. The battery pack has a top section 3362 that (A) can be openable when upper section 3363 is stationary or (B) adhere to (e.g., coupled with) or be part of upper section 3363 to form an openable upper section of the battery back when section 3363 is removable. The hub comprises casing 3355 and three side mounts each of which mounts a wing to the hub, the wings being 3353a-c. Each of the mounts are encased by a mount casing such as 3354. Camera 3356 is held by holder 3357 coupled with the hub. The battery holder may have an (e.g., electrical) connector mating member at its bottom end (not shown). The battery packs, when inserted into the hub, are configured to encircle the central axis of the hub.

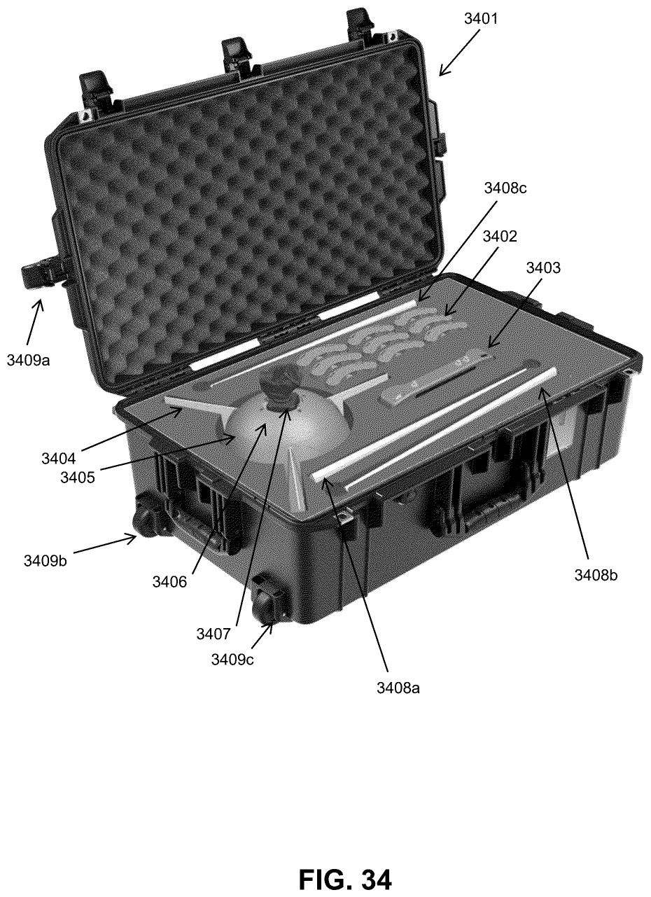

FIG. 34 shows suitcase 3401 comprising a disassembled AV. The suitcase comprises a hub of the AV comprising a first hub portion 3405 and a second hub portion 3406 from which camera holder 3407 extends, holding a camera. The hub is coupled with three first wing portions such as 3404. The suitcase comprises three second wing portions 3408a-c, and nine battery packs such as 3402, the battery packs having a horizontal cross section similar to that of a bent capsule or bent sausage. Suitcase 3401 comprises (e.g., handheld) controller 3403. The suitcase comprises internal cushioning and at least one set of external wheels 3409a-c.

FIG. 35 shows an example of power draw of the AV as it transitions from one mode to another, plotted as Watts as a function of time. In period 3501, the AV is flying in a V-MOD (tri-copter mode), during period 3502 the AV transitions from the V-MOD to the S-MOD, and in period 3503 the AV is flying in S-MOD (windmill mode). As can be seen in FIG. 35, the AV draws less power (e.g., from the power source such as batteries) when in S-MOD as compared to when it is flying in V-MOD, e.g., by a Wattage amount of 3545. FIG. 35 is shown relative to respective Cartesian coordinate systems. FIG. 35 shows a simulation based on aerodynamic analysis.

In some embodiments, the device, system, and/or apparatus disclosed herein (e.g., the AV and any of its controllable components) are controllable by at least one controller. The at least one controller may form a control system, e.g., having a hierarchy. The control system may control the rotation of the hub. When the hub comprises several portions, the control system may control relative rotation of at least two of the hub portions, e.g., rotation of a first hub portion relative to a second hub portion. The controller may control a counter rotating second portion with respect to the firs portion of the hub. The control system may control the AV at least in part by using angular position and/or angular velocity. The control system may control relative rotation of at least two hub portions using angular position and/or angular velocity of (e.g., each of) the hub portions. The control system may control relative rotation of the first hub portion relative to the second hub portion using angular position and/or angular velocity of (e.g., each of) the hub portions. In an example, the control system controls relative rotation of the first hub portion relative to the second hub portion using angular position and angular velocity of (e.g., each of) the hub portions. The IMU and encoder (e.g., rotary encoder) may provide inputs to the control system. The control system may control the position (e.g., the AoA) of each of the wings, e.g., during use of the AV.

Using AV may comprise during a rotation of the hub and/or of the wing. The control system may control the actuator, e.g., control speed of the motor(s). The actuator may be any actuator disclosed herein.

In some embodiments, the control system is configured to control the AoA of each wing.

The control may be when the AV flies in S-MOD. The control may be during a rotation of the wings. The control system may vary the AoA of the wing(s), e.g., while the control system holds the actuator speed (e.g., substantially) constant. The control system may vary the actuator speed, e.g., while the control system holds the AoA of the wing(s) (e.g., substantially) constant. The control system may vary the actuator speed, e.g., while the control system varies the AoA of the wing(s). In an example, the control system varies the AoA of the wing(s), maintaining the actuator speed (e.g., substantially) constant. In an example, the control system varies the actuator speed, while maintaining the AoA of the wing(s) (e.g., substantially) constant. In an example, the control system varies the actuator speed, and varies the AoA of the wing(s).

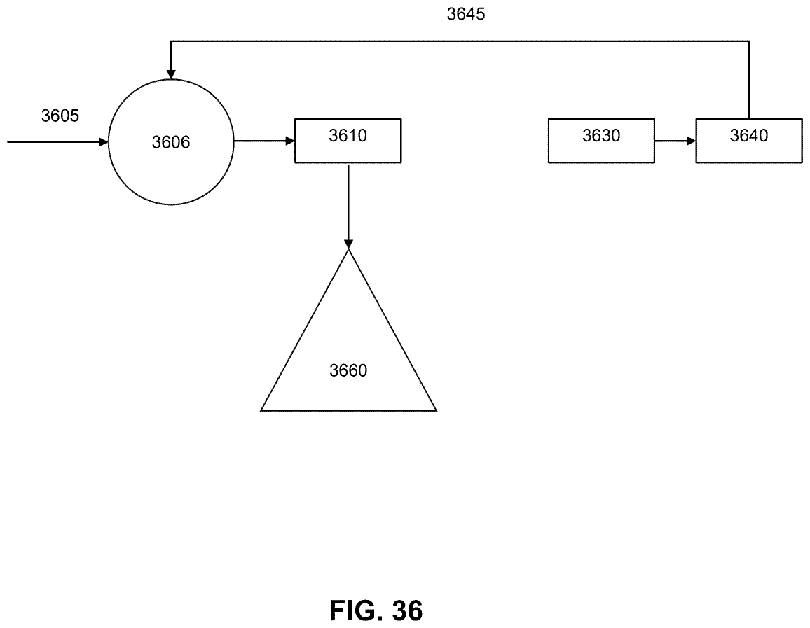

FIG. 36 shows a schematic example of a control system for adjusting an AV component 3660 using controller 3640. The AV component may be monitored using one or more sensors 3630 sensing respective variable(s) that are used to control the AV component, e.g., optical sensors, velocity sensor, angular sensor, and/or any other sensor disclosed herein. In some examples, the monitored variable is compared (e.g., by the controller) to a predetermined threshold variable value (or range) as a control parameter. The predetermined threshold value may be provided by a feed forward control element, e.g., 3605. As the monitored variable deviates from the predetermined threshold value (or range), the variable may be adjusted (e.g., using a feed-back control) to alter (e.g., reduce) the deviation. The variable may be any variable disclosed herein, e.g., comprising velocity, acceleration, AoA, angular rotation, angular velocity, power, rotation per minute, or torque.

In some examples, the control comprises a closed loop control. The closed loop control may comprise feedback, or feed-forward control. The control variable of the component (e.g., 3606) may be adjusted, e.g., by adjusting one or more parameters of a related component (e.g., 3610), such as by the controller. The control variable of the component may be pre-programmed. In some embodiments, feed forward and feedback control may be used in combination. The control variable may be controlled by a closed loop control, e.g., 3645. The control may rely on the sensor measurements, e.g., by the one or more sensors.

In some embodiments, the control system comprises various controllers and optional user input. The control system comprises an autonomous control, semi-autonomous control, or manual control. The control system can operate in an autonomous mode, semi-autonomous mode, or manual mode. The controller may enable one or more of the modes. The control system may comprise a position controller, a velocity controller, an attitude controller, or a rate controller. The attitude controller may control the orientation of the drone in space, e.g., may control the angles comprising pitch, roll, or yaw, angles. The rate controller may control the AV's body rate, e.g., as it transitions between various flight modes of the AV. The rate controller may be an angular rate controller, the angles comprising pitch, roll, or yaw, angles. The rate controller may be utilized to facilitate smooth flight of the AV, e.g., during flight of the AV in a flight mode and/or during transition from one flight mode to another. The controller may control and/or choose a flight mode for the AV, the flight mode comprising C-MOD, V-MOD, or S-MOD. A first controller of the control system can provide an output that is used as an input in the second control system. A controller of the control system can receive any inputs described herein, e.g., sensor data, third party data, actuator data, encoder data, computational scheme, a table, a schedule, historical data, user input, or any combination thereof. The controller may provide as an output a setpoint, a computational scheme, result of the computational scheme, a table, a schedule, a hierarchy, an instruction, or any combination thereof. The setpoints may comprise position, velocity, attitude, rates, or torque. The inputs may comprise motor speed, wing tilt, AoA, rudder tilt, altitude, or any other input relates to manner of flying the AV such as disclosed herein. The rotational speed may comprise rotational speed of the wings relative to the central axis or rotational speed of the propellers about each of their rotational axis. At one or more of the controllers (e.g., each of the controllers) may have their own identification (ID) code, e.g., alphanumeric code. The controller ID may be inscribed in the circuitry (e.g., PCB) of the controller. The controller can be uniquely identified by the control system, e.g., using the ID. The controller may be disposed, or operatively coupled with, the wing, the propeller system, the hub. A controller may be disposed in any hub portion. Any hub portion can comprise a first hub portion, second hub portion, or third hub portion. A controller may be disposed in any wing portion. Any wing portion can comprise a first wing portion, second wing portion, or third wing portion. A user may alter one or more of the setpoints, e.g., as disclosed herein. In some embodiments, a suer may not be permitted to alter setpoints automatically generated and/or provided, e.g., by a computational scheme. The control system may comprise control layers, e.g., control hierarchy. The control system may comprise a controller optimized for a specific task, e.g., attitude. The control system may adjust one or more parameters associated with the flight of the AV, e.g., and compare to a threshold such as a setpoint. The threshold may comprise a trend (e.g., function) or a value. The controller may have attributes comprising low noise sensitivity, integral wind-up, complex interaction, linear control scheme, or non-linear dynamic control scheme. The low noise sensitivity may utilize at least one noise smoothing technique such as a lowpass filter. The integral wind-up may comprise using ranges (e.g., thresholds), or reset of integral terms utilized in the computational scheme. The complex interaction may comprise using control loop schemes, e.g., that are interconnected. The manual control may comprise using a control column such as a joystick. The console may comprise a stick (e.g., shaft), a button, a scroller, a screen, circuitry (e.g., PCB), a handle, a switch, an actuator, a base, or a spring. The joystick may comprise an inductive, resistive, optical, Hall effect, or a potentiometer, joystick.

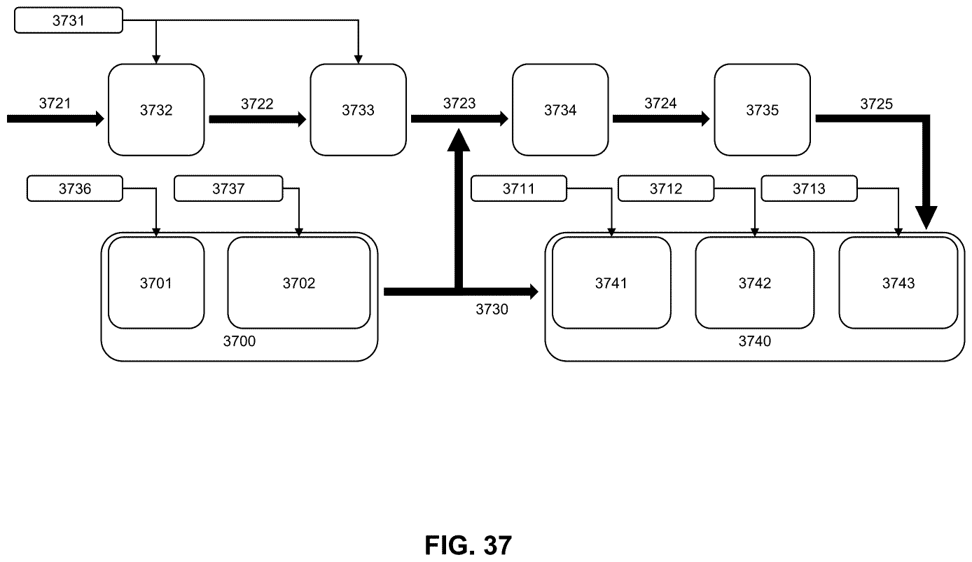

FIG. 37 shows a portion of a control system that can be used to control the AV. The control system can be operated at least in part using autonomic control, by enabling autonomous control at 3731, e.g., using a choice between assorted options or toggling on/off. Autonomous control 3731 can enable position controller 3732 and velocity controller 3733. Positional controller 3732 received position setpoint input 3721, and provides velocity setpoint 3722 to velocity controller 3733, which in turn provides attitude setpoint 3723 to attitude controller 3734. Manual control choice 3700 comprises manual control 3701 such as by stick, scroll, cursor, and/or button input. Manual control choice 3700 comprises semi-autonomous control, e.g., providing manual control input and altitude input. Enabling manual control choice is depicted in 3736, e.g., using a choice between assorted options or toggling on/off. Enabling semi-autonomous control is depicted in 3737, e.g., using a choice between assorted options or toggling on/off. Manual choice control 3700 provides thrust setpoint to the attitude setpoints and to trio control mixer 3740. The trio control mixer 3740 receives input corresponding to a flight mode of the AV, the flight mode comprising a V-MOD 3711, a S-MOD 3712, and a C-MOD 3713. The trio control mixer includes inputs associated with each of the flight modes, the inputs comprising (a) motor speed and wing tilt control input 3741, (b) motor speed and wing AoA control input 3742, and (c) motor speed wing AoA, and rudder tilt control input 3743. The V-MOD module is associated with motor speed and wing tilt control input 3741; the S-MOD module is associated with motor speed and wing AoA control input 3742, and the C-MOD module is associated with motor speed wing AoA, and rudder tilt control input 3743. Manual control choice 3700 provides input to attitude controller 3734, which provides rates setpoint output 3724 to rate controller 3735. Rate controller 3735 provides torque setpoint output to be used as an input for the trio control mixer. The control system comprises a feedback loop comprising attitude controller 3734, rate controller 3735, and trio control mixer 3740. The manual control may comprise using a control column, e.g., as disclosed herein.

The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. The control may comprise controlling a controlled variable, e.g., speed, power, and/or rotation. The control can comprise real time or off-line control. A calculation can be done in real time, and/or offline. The control system may comprise a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple (e.g., sub-) controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer.

At least two of the components can be controlled by the control system individually, e.g., comprising simultaneously or sequentially. At least two of the components can be controlled by the control system collectively, e.g., comprising simultaneously or sequentially. In an example, at least two of the wings are controlled by the control system. The control system may be configured for throttle control of the AV. The control system may adjust the power of the actuators, e.g., to affect altitude, location, flight mode and/or speed, of the AV. The control system may control the AV while it is flying in modes, e.g., in S-MOD, C-MOD, and/or in V-MOD. The control system may control the direction of wing rotate, e.g., spin. The control system may control the direction of the first hub portion's rotation, e.g., and thus may control the direction in which the wings rotate. The control system may control the direction in which the sensor and/or detector (e.g., the camera) is pointing to, e.g., the directions comprising up, down, right or left. The control system may control the field of view of the sensor and/or detector (e.g., the camera). Controlling the field of view may comprise direction and/or FLS, e.g., affecting its size such as area. The control system may control the direction in which the AV is directed, e.g., and its target. The direction can be an absolute direction or a relative direction. The direction may be relative to (a) the gravitational vector directed towards the environmental center of gravity (e.g., Earth), (b) the magnetic centers of Earth, (c) horizontal position on/off the ground, e.g., a geographical address, (d) vertical position on and/or off the ground, e.g., tip of a mountain or of a cellular tower. The controller may be a PID controller. The controller may comprise a control scheme comprising feedback, feed forward, closed loop, or open loop, control schemes. The control scheme may utilize AI, e.g., ML control scheme(s). The control system may be configured for image recognition, object tracking, and/or video compression, e.g., in real time during flight. The control system may be configured at least in part for remote control. The control system may comprise a distal controller(s), modular controller, and/or controller(s) situated in the AV. The control system may comprise a controller disposed in a facility and/or in the cloud. The control system may comprise a controller disposed at a distance from the AV, e.g., during its operation, e.g., flight. The control system may comprise Handheld controller or non-handheld controller. The control may comprise automatic control or manual control. The control system may comprise customized control schemes and/or hardware, e.g., programmable logic circuit. The control system may perform, or be operatively coupled with a processor performing, Big Data Analysis (BDA), e.g., in real time during flight. As the AV operates (e.g., spins), data points may be collected, e.g., to create a data point cloud. The data point cloud may be analyzed, e.g., in real time—as they are collected and/or during operation of the AV.

Analysis of the data point cloud may be by the control system, or by a processor that is not part of the control system. The data point cloud can be utilized to warn of nearby obstacles. The obstacles may comprise a structure, a tree, an object, or any other obstacle disclosed herein. The data point cloud may be utilized as a feed for detect-and-avoid computational schemes, e.g., in real time during flight of the AV. The control system may anticipate and/or consider, at least one event having a plausible effect on the AV such as disclosed herein. The control system may control the velocity and/or acceleration of the actuator(s), e.g., electronic motor. The control system may comprise an Electronic Speed Control (ESC). The ESC may be disposed in the AV.

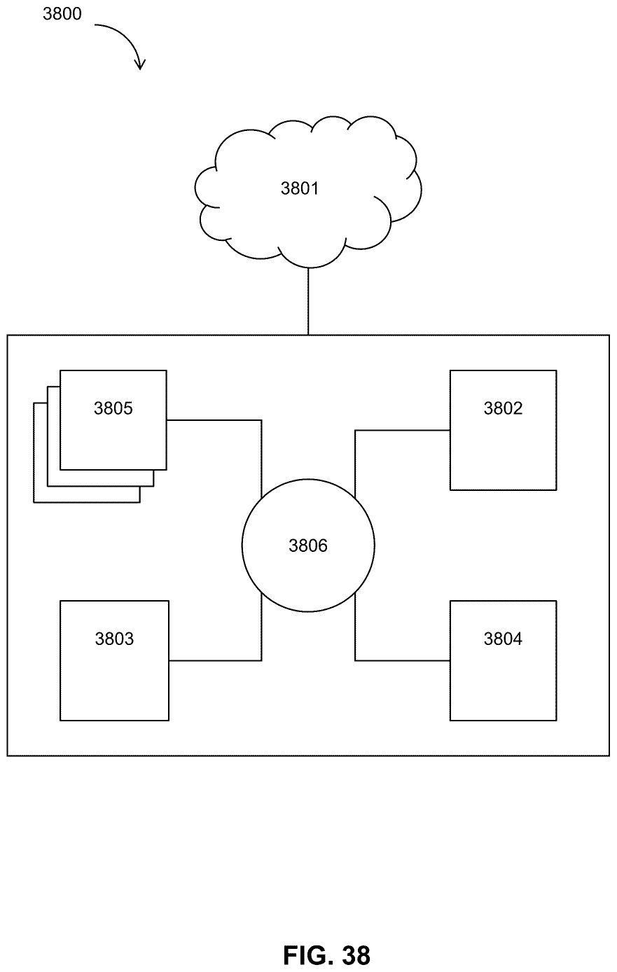

In some embodiments, the device, system, and/or apparatus disclosed herein comprises a processor. The processor may be a processing unit. The AV may comprise printed circuits, e.g., on a printed circuit board (PCB). The processor may be disposed on the PCB. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor may be programmed to implement methods of the disclosure. The controller may control at least one component of the systems and/or apparatuses disclosed herein. FIG. 38 is a schematic example of a computer system 3800 that is programmed or otherwise configured to facilitate execution any of the methods provided herein. The computer system 3800 can control (e.g., direct, monitor, and/or regulate) various features of the methods, apparatuses, devices and/or systems of the present disclosure. The computer system 3800 can be part of, or be in communication with, the device, system and/or apparatus disclosed herein. The computer may be coupled with one or more mechanisms disclosed herein, and/or any parts thereof. The computer system 3800 can include a processing unit 3806 (also “processor,” “computer” and “computer processor” used herein). The computer system may include memory or memory location 3802 (e.g., random-access memory, read-only memory, flash memory), electronic storage unit 3804 (e.g., hard disk), communication system component (e.g., comprising an interface) 3803 (e.g., network adapter) for communicating with one or more other systems, and peripheral devices 3805, such as cache, other memory, data storage and/or electronic display adapters. The memory 3802, storage unit 3804, interface 3803, and peripheral devices 3805 are in communication with the processing unit 3806 through a communication system component (e.g., bus such as a motherboard-solid lines. The storage unit can be a data storage unit (or data repository) for storing data. The computer system can be operatively coupled with a computer network (“network”) 3801, e.g., with the aid of the communication system such as comprising an interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server. The processing unit can execute a sequence of machine-readable instructions, which can be embodied in a program or software. The instructions may be stored in a memory location, e.g., memory 3802. The instructions can be directed to the processing unit, which can subsequently program or otherwise configure the processing unit to implement methods of the present disclosure. Examples of operations performed by the processing unit can include fetch, decode, execute, and write back.

The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit.

One or more other components of the system (e.g., 3800) can be included in the circuit. The processing unit may comprise programmable logic circuit such as a programmable processor, e.g., a microprocessor, e.g., a Complex Instruction Set Computer (CISC) processor or a Reduced Instruction Set Computer (RISC) processor. The processor may be configured to execute software, e.g., any kind of computer program, e.g., a computer program using a virtual machine code, e.g., comprising Java or C++.

In some embodiments, the storage unit (e.g., 3804) stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet. The processor may be configured to process control protocols, e.g., communicate with one or more components of the mechanism (e.g., device, apparatus, and/or system) disclosed herein using the control protocols. Control protocols can be one or more of the internet protocol suites, e.g., transmission control protocol (TCP) or transmission control protocol/internet protocol (TCP/IP). Control protocols can be one or more serial communication protocols. Control protocols can be one or more of controller area networks or another message-based protocol, e.g., for communication with microcontrollers and devices. Control protocols can interface with one or more serial bus interfaces for communication with the mechanism disclosed herein, e.g., with any of its components. The control protocol can be any control protocol disclosed herein. The AV may comprise a card reader, e.g., as part of a processor. The card reader may record sensor measurements and/or detector measurements, e.g., from the IMU. The card reader may (i) record onboard telemetry of the controller input, (ii) comprise onboard sensor(s), indicators for health of component(s) of the AV, (iii) receive camera (e.g., video) input, or (iv) any combination thereof.

In some embodiments, the system, device, and/or apparatus disclosed herein comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory 3802 or electronic storage unit 3804. The machine executable or machine-readable code can be provided in the form of software. During use, the processor (e.g., 3806) can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine that has a processer adapted to execute the code or can be compiled during runtime. The code can be supplied in a programming language that can be selected to enable the code to execute in a pre-compiled or as-compiled fashion. The AV may comprise at least one memory, e.g., disposed in the hub such as in the first portion of the hub and/or in the second portion of the hub. The memory may comprise DRAM (Dynamic Random Access Memory) or a non-volatile memory, for example a PROM (Programmable Read Only Memory), an EPROM (Erasable PROM), EEPROM (Electrically Erasable PROM), a flash memory, or any other memory disclosed herein. The memory may comprise a floating gate memory, a charge trapping memory, an MRAM (Magnetoresistive Random Access Memory) or a PCRAM (Phase Change Random Access Memory).

In some embodiments, the computer system utilizes a machine readable medium/media to execute, or direct execution of, operation(s). The program instructions can be inscribed in a machine executable code. A machine-readable medium/media, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as the main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

Control may comprise regulate, modulate, adjust, maintain, alter, change, govern, manage, restrain, restrict, direct, guide, oversee, manage, preserve, sustain, restrain, temper, or vary.

In some embodiments, the device, system, and/or apparatus disclosed herein comprises, or is operatively coupled with, a communication technology, e.g., in addition to the optical fiber disclosed herein. The communication may comprise wired or wireless communication. For example, the systems, apparatuses, and/or parts thereof may comprise Bluetooth, wi-fi, global positioning system (GPS), or radiofrequency (RF) technology. The RF technology may comprise ultrawideband (UWB) technology. Systems, apparatuses, devices, and/or parts thereof may comprise a communication port. The communication port may be a serial port or a parallel port.

The communication port may be a Universal Serial Bus port (i.e., USB). The communication system may comprise the communication port. The systems, apparatuses, and/or parts thereof may comprise USB ports. The USB can be micro or mini-USB. The systems, apparatuses, devices, and/or parts thereof may comprise a plug and/or a socket, e.g., electrical, AC power, DC power. The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 4, 8, 10, 15, 18, 20, 22, 24, 26, 28, 30, 40, 42, 45, 50, 55, 80, or 100 pins. The connector can transmit data and/or electricity therethrough. The connector may comprise a Molex type connector or any other connector disclosed herein, as applicable. The connector may comprise a socket side and an insert side that mate upon their connection. The connector may transmit electricity and/or data. The connector may be any applicable connector disclosed herein.

In some embodiments, the AV comprises a processor, e.g., as part of a computer system. The processor (e.g., and computer) may be disposed in the AV. Components of the computer may distribute about one or more various elements of the AV, the various elements comprising the hub, the wings, the propeller systems, or any portions thereof. The processor may utilize computational scheme(s), e.g., AI such as ML. The computational schemes may be utilized for recognition. The recognition may comprise image recognition. The recognition may comprise recognizing objects. The recognition may comprise recognizing various objects of the ground or coupled with the ground. In an example, the recognition comprises recognizing a license plate of a vehicle (e.g., land vehicle), or a trajectory of a plot of land. In an example, the recognition comprises detecting obstacles, e.g., for avoiding the obstacles. The detection may be based at least in part on sensor(s) of the AV, historical data, and third-party data, e.g., weather forecasts, topographical maps. The sensors may be external to the AV and/or may have a field of view external to the AV.

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples.

Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.
Example 1: An unmanned aerial vehicle comprising: a center hub having a central axis; a plurality of wings, wherein each wing of the plurality of wings is defined by a base securable to the center hub; one or more propeller systems located on each wing of the plurality of wings; one or more actuator systems, wherein each of the one or more propeller systems is independently associated with one actuator system of the one or more actuator systems; a power source located within the interior of the center hub; and a control system located within the interior of the center hub operatively configured to control the one or more actuator systems, the one or more actuator systems, and the power source; wherein the unmanned aerial vehicle has a first position wherein the base of each wing of the plurality of wings is positioned on the center hub at an angle offset from the central axis of the center hub; and a second position wherein the base of each wing of the plurality of wings is positioned on the center hub at an angle parallel with the central axis of the center hub; and wherein the unmanned aerial vehicle is operatively configured to transition from the first position to the second position.
Example 2: The unmanned aerial vehicle of Example 1, comprising three wings securable to the center hub and a single propeller system located on each of the three wings.
Example 3: The unmanned aerial vehicle of Example 1, wherein the power source comprises one or more battery packs.
Example 4: The unmanned aerial vehicle of Example 3, wherein the center hub further comprises one or more battery holders configured to house the one or more battery packs.
Example 5: The unmanned aerial vehicle of Example 1, wherein the one or more actuator systems are each independently located within a wing of the plurality of wings.
Example 6: The unmanned aerial vehicle of Example 5, wherein each actuator system of the one or more actuator systems comprises a servo motor and a servo gear.
Example 7: The unmanned aerial vehicle of Example 1, further comprising a gimble system secured to the center hub; a camera system secured to the gimble system; and a hub motor located within an interior of the center hub operatively configured to control the gimble system and the camera system.
Example 8: The unmanned aerial vehicle of Example 7, wherein the control system is further operatively configured to control the hub motor, the gimble system, and the camera system.
Example 9: The unmanned aerial vehicle of Example 7, wherein the center hub further comprises a main hub body and a platform operatively configured to fit into an aperture on the main hub body.
Example 10: The unmanned aerial vehicle of Example 9, wherein the gimble system is operatively configured to be secured to the platform.
Example 11: The unmanned aerial vehicle system of Example 9, wherein the main hub body further comprises one of a male or female coupling system, and wherein the platform includes the other of the male or female coupling system such that the main hub body and the platform are operatively connected by the male coupling system coupling with the female coupling system.
Example 12: The unmanned aerial vehicle system of Example 11, wherein the control system comprises a flight management system, a global position system, and a radio signal air control unit; and wherein the flight management system, the global position system, and the radio signal transmitter are located either within the main hub body or on the platform.
Example 13: The unmanned aerial vehicle system of Example 12, further comprising a rotary connector that is a multi-channel slip ring, wherein the multi-channel slip ring allows for (e.g., electrical and/or data) communication between the main hub body and the platform.
Example 14: The unmanned aerial vehicle system of Example 1, wherein each wing of the plurality of wings comprises a proximal portion and a distal portion, wherein the proximal portion includes the base fixedly secured to the center hub and wherein the distal portion is removably secured to the proximal portion.
Example 15: The unmanned aerial vehicle of Example 14, wherein each proximal portion of each wing of the plurality of wings includes a first male dovetail and a second female dovetail, wherein each removal portion of each wing of the plurality of wings includes a first female dovetail and a second male dovetail, and wherein the first male dovetail interacts with the first female dovetail and the second female dovetail interacts with the second male dovetail to removably secure the proximal portion to the distal portion.
Example 16: The unmanned aerial vehicle of Example 15, wherein each proximal portion of each wing of the plurality of wings includes one of a clip or a latch, wherein each distal portion of each wing of the plurality of wings includes the other of the clip or the latch, and wherein the clip is removably securable to the latch to removably secure the proximal portion to the distal portion.
Example 17: The unmanned aerial vehicle of Example 16, wherein each proximal portion of each wing of the plurality of wings includes one of a female electrical connector member or a male electrical connector member, wherein each distal portion of each wing of the plurality of wings includes the other of the female electrical connector member of the male electrical connector member, and wherein the female electrical connector member is removably securable to the male electrical connector member to provide an electrical connection between the proximal portion and the distal portion.
Example 18: The unmanned aerial vehicle of Example 1, further comprising a camera system secured to the center hub and a hub motor located within an interior of the center hub operatively configured to control the camera system.
Example 19: The unmanned aerial vehicle of claim 18, wherein the control system is further operatively configured to control the hub motor and the camera system.

Examples 20-21: are each an UAV that respectively comprised: a hub having a central axis and a hub actuator, the hub was configured to selectively rotate about the central axis during the flight; three wings, each of the wings comprised a wing having a long axis connecting (a) a base of the wing disposed at a first end of the wing, with (b) a tip of the wing disposed at a second end of the wing opposing the first end of the wing, the base and the tip being disposed along the long axis, the base coupled with the hub and the tip is disposed further away from the hub relative to the base; and a propeller system disposed at, or adjacent to, the tip of the wing, the propeller system being coupled with the wing. The opaque portions of the UAV excluding the battery packs, comprise composite carbon fiber in Nylon. The battery packs comprise ASA. Example 20 is similar to the AV depicted in FIG. 27 configured to fly in S-MOD, V-MOD, and C-MOD, Example 21 is similar to the AV depicted in FIGS. 26-27 configured to fly in S-MOD and V-MOD. Experiments are underway to configure it to fly in C-MOD.
Example 23-24: the UAVs of examples 20-21, respectively, were the hub comprised a first hub portion configured to rotate relative to a second hub portion during the flight, the first hub portion operatively coupled with the second hub portion during the flight,
Example 25-26: the UAVs of examples 20-21, respectively, were the UAV comprised an inertial measurement unit (IMU) configured to measure (e.g., accurately and reliably) a second angular velocity up to a threshold, and wherein the wing is configured to rotate about the central axis at a first angular velocity higher than the threshold, the IMU being disposed in the hub.
Example 27-28: the UAVs of examples 20-21, respectively, where the device comprised a rotary encoder configured to measure (e.g., accurately and reliably) an angular velocity of the wing as it rotates about the central axis.
Example 29-30: the UAVs of examples 20-21, respectively, where the UAV comprising a rotary connector configured to transmission of electrical power between its stationary portion and its rotating portion, the rotation portion of the rotary connector configured to continuously fully-rotate during operation,
Example 30-31: the UAVs of examples 20-21, respectively, where the UAV comprising a controller configured to control (I) relative rotation, (II) relative altered positions, or (III) relative rotation and relative altered positions, of portions of the hub during the flight,
Example 32-33: the UAVs of examples 20-21, respectively, where the wing comprises (i) a first wing portion comprising the base and a first side of a coupling system disposed on a side of the first wing portion opposing the base and (ii) a second wing portion comprising the tip and a second side of the coupling system disposed on a side of the second wing portion opposing the tip, the first side of the coupling system configured to mate (e.g., couple) with the second side of the coupling system as part of the wing,
Example 34-35: the UAVs of examples 20-21, respectively, where the hub comprising a battery holder having a cross section in a plane perpendicular to the central axis, the cross section having a first side comprising a first arch and a second side comprising a second arch, the first arch being concentric with the second arch, the first arch being longer than the second arch,
Example 36-37: the UAVs of examples 20-21, respectively, where the hub comprising a temperature conditioning system configured to condition a temperature within the hub during the flight,
Example 38-39: the UAVs of examples 20-21, respectively, where the hub comprising an internal support system, the internal support system comprising a first set of support and a second set of support, (i) the first set of supports extending from a first side of a first stage centered in at least one plane relative to the central axis, the central axis running through the first stage, each first support of the first set of supports having a first distal side with respect to the central axis, the first distal side forming a first acute angle with the first stage such that the distal side is slanted in a direction of the central axis, the first set of supports being coupled by a first geometric shape having a first central hole concentric with the central axis, (ii) the second set of supports extending from a second side of a second stage centered in at least one plane relative to the central axis, the central axis running through the second stage, each second support of the second set of supports having a second distal side with respect to the central axis, the second distal side forming a second acute angle with the second stage such that the second distal side is slanted in the direction of the central axis, the second set of supports being coupled by a second geometric shape having a second central hole concentric with the central axis, the second geometric shape contacting the first geometric shape, or It should be understood that any of the versions of the unmanned aerial vehicle described herein may include various other features in addition to or in lieu of those described above. By way of example only, any of the unmanned aerial vehicles described herein may also include one or more of the various features disclosed in any of the various references that are incorporated by reference herein. It should also be understood that the teachings herein may be readily applied to any of the unmanned aerial vehicles described in any of the other references cited herein, such that the teachings herein may be readily combined with the teachings of any of the references cited herein in numerous ways. Other types of unmanned aerial vehicles into which the teachings herein may be incorporated will be apparent to those of ordinary skill in the art.

Having shown and described various embodiments of the present disclosure, further adaptations of the methods and systems described herein may be accomplished by appropriate modifications by one of ordinary skill in the art without departing from the scope of the present disclosure. Several such potential modifications have been mentioned, and others will be apparent to those skilled in the art. For instance, the examples, embodiments, geometrics, materials, dimensions, ratios, steps, and the like discussed above are illustrative and are not required.

Accordingly, the scope of the present disclosure should be considered in terms of the following claims and is understood not to be limited to the details of structure and operation shown and described in the specification and drawings. While preferred embodiments of the present inventions have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

1.-20. (canceled)

21. A device for unmanned aerial flight, the device comprising
a hub;
wings operatively coupled with the hub, the wings being at most three wings, the wings comprising a wing, the wings being dynamic during the flight;
actuator systems disposed in the device; and
controllers, each of the wings being operatively coupled with a respective controller of the controllers, the controller controlling position of the wings and/or operation of components coupled with the wing, a respective actuator system of the actuator systems being disposed in the wing such that the center of mass of the device is in the hub; and
the device being configured for at most three flight modes, the at most three flight modes comprising horizontal flight, vertical flight, and hovering, and
(a) a wing of the wings having a long axis, the wing having a nonsymmetrical cross section along the long axis,
(b) the controllers comprising a controller disposed in the hub, the controller controlling, during the flight, angle of attack of the wing, the angle of attack being variable at least in part by the controller,
(c) the device comprising propeller systems, the wing comprising a respective propeller system of the propeller systems, the respective propeller system being disposed at a distal tip of the wing away from the hub, the respective actuator of the wing being configured to rotate a propeller of the respective propeller system of the wing, a number of the propeller systems being equal to the number of the wings;,
(d) the respective propeller system comprising an inertial measurement unit (IMU), a Light Detector and Ranging sensor (LiDAR), an antenna, a radiofrequency (RF) technology, or any combination thereof,
(e) the hub comprising a temperature conditioning system configured to, during the flight, condition the temperature in the hub, ; or
(f) Any combination of (a), (b), (c), (d), and (e).

22. The device of claim 1, wherein The device of the wing of the wings having the long axis, the wing having the nonsymmetrical cross section along the long axis.

23. The device of claim 1, wherein the controllers comprise the controller disposed in the hub, the controller controlling, during the flight, the angle of attack of the wing, the angle of attack being variable at least in part by the controller.

24. The device of claim 1, wherein the device comprises the respective actuator for the wing, the respective controller controlling during the flight a speed of the actuator to control the angle of attack.

25. The device of claim 24, wherein during the flight, the controllers continuously correct the speed of each propeller system.

26. The device of claim 1, wherein the propeller system comprises a lighting system, the light system being modular and/or replaceable.

27. The device of claim 1, wherein the propeller system comprises a lighting system comprising lights configured to indicate operation preparedness, battery life, directionality of flight, temperature range, police lighting, lighting for such as first responders, malfunction of the device, or any combination thereof.

28. The device of claim 1, wherein a rotational axis of the propeller of the propeller system, is disposed at an angle relative to the long axis of the wing.

29. The device of claim 1, wherein the device comprises the propeller systems, the wing comprising the respective propeller system of the propeller systems, the propeller system being disposed at the distal tip of the wing away from the hub, the respective actuator of the wing being configured to rotate the propeller of the respective propeller system of the wing, the number of the propeller systems being equal to the number of the wings.

30. The device of claim 21, wherein the device comprising propeller systems, the wing comprising a respective propeller system of the propeller systems, the propeller system being disposed at a distal tip of the wing away from the hub, the respective actuator of the wing being configured to rotate the respective propeller system of the wing; and wherein the propeller system comprises a sensor, a motor, and a controller.

31. The device of claim 21, wherein the respective propeller system comprises the IMU, the LiDAR, the antenna, the RF technology, or any combination thereof.

32. The device of claim 21, wherein the hub comprises the temperature conditioning system configured to, during the flight, condition the temperature in the hub.

33. The device of claim 21, wherein the temperature conditioning system being configured to condition the temperature of the hub during the light at least in part allowing gas flow through the hub.

34. The device of claim 21, wherein the hub comprises a battery holder configured to accommodate a battery system, the temperature conditioning system being configured to condition the temperature of the hub during the flight at least in part by conditioning heat exerted from the battery system.

35. The device of claim 21, wherein the temperature conditioning system comprising aeration holes in the hub, the aeration holes being configured to, during the flight, facilitate gas flow therethrough ;.

36. The device of claim 21, wherein the temperature conditioning system is passive such that the temperature conditions system does not require additional input of power for its operation except for the power required for the flight of the device.

37. The device of claims 1, wherein the wing is mounted with the hub at least in part by a wing mount operatively coupled with an actuator, the actuator being controlled by the respective controller, the motor being proximal to the wing mount contacting the hub.

38. An apparatus for unmanned aerial flight of the device of claim 21, the apparatus comprising at least one controller configured to direct at least one mechanism to execute one or more operations associated with the device, the one or more operations comprising manufacturing, assembling, testing, flying, and/or maintaining, the at least one controller being configured to connect with a power source.

39. Non-transitory computer readable program instructions, the program instructions, when read by one or more processors, are configured to execute, or direct execution of, the one or more operations associated with the device of claim 21, the one or more operations comprising manufacturing, assembling, testing, flying, and/or maintaining.

40. A method associated with the device of claim 21, the method comprising executing one or more operations to associated with the device comprising manufacturing, assembling, testing, flying, and/or maintaining.
